(19) United States
(12) Patent Application Publication
(10) Pub. No.: US 2026/0228306 A1
(43) Pub. Date: Aug. 6, 2026

(54) CLEANING A MACHINE LEARNING DATASET USING CORESETS

(71) Applicant: DATAHEROES, LTD., Ramat Hasharon (IL)

(72) Inventors: Eitan NETZER, Kiryat Tivon (IL); Oren NETZER, Wyckoff, NJ (US); Liran SIGALAT, Ramat Hasharon (IL)

(21) Appl. No.: 19/147,082

(22) PCT Filed: Jan. 11, 2024
(86) PCT No.: PCT/IL2024/050046

§ 371 Date: Jul. 10, 2025

Related U.S. Application Data
(60) Provisional application No. 63/438,632, filed on Jan. 12, 2023.
(60) Provisional application No. 63/470,359, filed on Jun. 1, 2023.
(60) Provisional application No. 63/521,171, filed on Jun. 15, 2023.

(51) Int. Cl. G06F 18/214; G06F 18/21; G06N 20/00

(52) U.S. Cl. CPC G06F 18/214; G06F 18/217; G06N 20/00

(57) ABSTRACT

A computerized method of cleaning a data set, configured for training of a machine learning model, includes data instances, each including a label. It comprises: computing coreset(s) from the data set, generating an importance measure for each coreset sample, indicative of an importance/weight value; selecting, from the coresets, a coreset(s) (a representative sub-set) that is representative of the data set; and selecting a number of samples, based on importance-related criteria, indicative of corresponding importance measures of the selected coreset(s) having high importance/low weight values. The set of selected samples has high probability of high importance/low weight values, compared to a probability associated with selecting data instances from the data set. The set facilitates determining whether each sample requires an action. The action gives an increased-quality representative sub-set. This facilitates quicker/higher-accuracy training of the model.

### TECHNICAL FIELD

The presently disclosed subject matter relates to the field of machine learning. It relates more specifically to the field of the quality of training data, and to the field of the validation of machine learning models.

### BACKGROUND

A key concern in the field of machine learning is the quality of the data used in the training of the model.

Some additional key concerns in the field of machine learning include validating trained models, e.g. using a cross-validation process, and evaluating the models' ability to predict edge cases.

Coresets are a methodology from the field of computational geometry.

Some publications relating to these fields include the following:

Agarwal et al, Geometric Approximation via Coresets—Survey, https://sarielhp.org/p/04/survey/, Last modified: Thu October 28 11:17:58 CDT 2004Dan Feldman, Introduction to Core-sets: an Updated Survey, Wiley Interdisciplinary Reviews, WIREs Data Mining Knowledge and Discovery, Vol. 10(1), _Jan. 2020, https://arxiv.org/pdf/2011.09384.pdf

Frank Nielsen, Partition-Based Clustering with k-Means, in “Introduction to HPC with MPI for Data Science”, Feb. 2016, https://www.researchgate.net/publication/313162957_Partition-Based_Clustering_with_k-Means

Feldman et al, “Turning Big Data Into Tiny Data: Constant-Size Coresets for k-Means, PCA, and Projective Clustering”, Society for Industrial and Applied Mathematics, SIAM Journal on Computing, Vol. 49, Iss. 3 (2020), https://epubs.siam.org/doi/abs/10.1137/18M1209854

Agarwal et al, “Mergeable Summaries”, ACM Transactions on Database Systems, Volume 38, Issue 4, November 2013, Article No. 26, pp 1-28, https://dl.acm.org/doi/10.1145/2500128

M. Stone, “Cross-validation: a review”, Series Statistics, Vol. 1 (1978), Issue 1, pp. 127-139, published online 27 Jun. 2007,

https://www.tandfonline.com/doi/abs/10.1080/02331887808801414?journalCode =gsta19.

Jianglong Zhou et al, “Evaluating the Quality of Machine Learning Explanations: A Survey on Methods and Metrics”, Electronics 2021, 10(5), 593, 4 Mar. 2021,

https://www.mdpi.com/2079-9292/10/5/593

Acknowledgement of the above references herein is not to be inferred as meaning that these are in any way relevant to the patentability of the presently disclosed subject matter.

### GENERAL DESCRIPTION

The following are example embodiments of the presently disclosed subject matter.
1. According to a first aspect of the presently disclosed subject matter there is presented a computerized method of cleaning a data set, the method performed by a processing circuitry of a data cleaning system, the method comprising:
   (a) provide the data set, the data set being configured for training of a machine learning model,
   the data set comprising a plurality of data instances, each data instance of
   the plurality of data instances comprising a label;
   (b) computing at least one coreset from the data set,
   for generating an importance measure for each coreset sample of the at least one coreset, the importance measure being indicative of at least one of an importance value and a weight value;
   (c) selecting, from the coresets, at least one selected coreset that is representative of the data set,
   the at least one selected coreset constituting a representative sub-set of the coresets; and
   (d) selecting, from the representative sub-set, a number of coreset samples, based on at least one importance-related criterion,
   the at least one importance-related criterion being indicative of corresponding importance measures of the at least one selected coreset having at least one of high importance values and low weight values,
   giving rise to a set of selected coreset samples having a high probability of at least one of high importance values and low weight values, as compared to a second probability associated with selecting a corresponding number of data instances from the data set,
the set of selected coreset samples facilitating determining, for each coreset sample of the set of selected coreset samples whether the each coreset sample requires an action,
thereby facilitating performing the action, which brings about an increased-quality representative sub-set of coresets, as compared to a quality of the representative sub-set,
the increased-quality representative sub-set of coresets facilitating at least one of a quicker training of the machine learning model and a higher-accuracy training of the machine learning model, as compared to a second training of the machine learning model performed utilizing the data set.

In addition to the above features, the method according to this aspect of the presently disclosed subject matter can include one or more of embodiments (2) to (20) listed below, in any desired combination or permutation which is technically possible:
2. The computerized method of embodiment 1,
   wherein the at least one coreset is comprised in a coreset data structure, the coreset data structure having at least the following properties:
      I. an ability to add a coreset sample to the at least one coreset;
      II. an ability to delete a coreset sample to the at least one coreset;
      III. an ability to modify a coreset sample; and
      IV. an ability to find a coreset sample within the coreset data structure.
3. The computerized method of any one of embodiments 1 to 2, wherein the selecting of the number of coreset samples, based on the at least one importance-related criterion, comprises one of the following:
   selecting coreset samples of highest importance;
   selecting coreset samples of importance above a defined importance value;
   selecting coreset samples of lowest weight;
   selecting coreset samples of weight below a defined weight value; and
   selecting the representative sub-set of the at least one coreset.
4. The computerized method of any one of embodiments 1 to 2, wherein the number of coreset samples is a defined number of coreset samples.
5. The computerized method of any one of embodiments 1 to 4, wherein the selection of the number of coreset samples is performed for a particular class comprised in the plurality of data instances.
6. The computerized method of any one of embodiments 1 to 5, wherein the selected representative sub-set comprises all coresets of the at least one coreset.
7. The computerized method of any one of embodiments 1 to 6, wherein the action comprises at least one of:
   a. correcting a sample label associated with the each coreset sample;
   b. deleting the each coreset sample;
   c. creating a new class, and assigning, to the each coreset sample, a new sample label, associated with the new class;
   d. adding additional coreset samples to the representative sub-set of the at least one coreset; and
   e. adding additional data instances to the data set.
8. The computerized method of any one of embodiments 1 to 7, wherein the performing the action in the each coreset sample comprises performing the action in the dataset.
9. The computerized method of any one of embodiments 1 to 8, wherein the performing the action in the each coreset sample comprises one of the following:
   performing the action in the representative sub-set; and
   performing the action in all coresets, of the at least one coreset, that comprise the each coreset sample.
10. The computerized method of any one of embodiments 1 to 9, wherein the performing the action comprises updating the importance measure.
11. The computerized method of any one of embodiments 2 to 10, wherein the coreset data structure further having at least the following property:
   V. an ability to update the data structure with Log-N time complexity, or with better than in Log-N time complexity.
12. The computerized method of embodiment 11, wherein the data structure comprises a coreset tree.
13. The computerized method of any one of embodiments 1 to 12, wherein the performing of the action comprises performing the action in the each coreset sample of the representative sub-set.
14. The computerized method of any one of embodiments 1 to 13, wherein the performing of the action comprises performing the action in a respective instance of the data set,
   the respective instance of the data set corresponding to the each coreset sample.
15. The computerized method of any one of embodiments 1 to 14, the method further comprising:
   (e) responsive to the determining whether the each coreset sample requires the action, and responsive to the performing of the action, performing the training of the machine learning model.
16. The computerized method of embodiment 15, wherein the performing of the training utilizes one of:
   I. the selected representative sub-set of the at least one coreset; and
   II. the data set.
17. The computerized method of any one of embodiments 15 to 16, the method further comprising:
   (f) evaluating a model quality associated with the trained machine learning model.
18. The computerized method of embodiment 17, the method further comprising:
   (g) repeating said steps (c) through (f) until meeting a process-termination criterion.
19. The computerized method of embodiment 18, wherein the process-termination criterion comprises at least one of the following:
   I. a defined number of repetitions have been performed; and
   II. an improvement of the quality level over at least one previous iteration is below a defined improvement level.
20. The computerized method of any one of embodiments 18 to 19, wherein, said step (g) comprises repeating said step (b).
21. According to a second aspect of the presently disclosed subject matter there is presented a computerized data cleaning system, comprising a processing circuitry, configured to perform a method of cleaning a data set, the method comprising:
   (a) provide the data set, the data set being configured for training of a machine learning model,
   the data set comprising a plurality of data instances, each data instance of
   the plurality of data instances comprising a label;
   (b) computing at least one coreset from the data set,
   for generating an importance measure for each coreset sample of the at least one coreset, the importance measure being indicative of at least one of an importance value and a weight value;
   (c) selecting, from the coresets, at least one selected coreset that is representative of the data set,
   the at least one coreset constituting a representative sub-set of the coresets; and
   (d) selecting, from the representative sub-set, a number of coreset samples, based on at least one importance-related criterion,
   the at least one importance-related criterion being indicative of corresponding importance measures of the at least one selected coreset having at least one of high importance values and low weight values,
   giving rise to a set of selected coreset samples having a high probability of at least one of high importance values and low weight values, as compared to a second probability associated with selecting a corresponding number of data instances from the data set,
the set of selected coreset samples facilitating determining, for each coreset sample of the set of selected coreset samples whether the each coreset sample requires an action,
thereby facilitating performing the action, which brings about an increased-quality representative sub-set of coresets, as compared to a quality of the representative sub-set,
the increased-quality representative sub-set of coresets facilitating at least one of a quicker training of the machine learning model and a higher-accuracy training of the machine learning model, as compared to a second training of the machine learning model performed utilizing the data set.
22. According to a third aspect of the presently disclosed subject matter there is presented a non-transitory computer readable storage medium tangibly embodying a program of instructions that, when executed by a processing circuitry of a data cleaning system, cause the processing circuitry to perform a method of cleaning a data set, the method comprising:
   (a) provide the data set, the data set being configured for training of a machine learning model,
   the data set comprising a plurality of data instances, each data instance of
   the plurality of data instances comprising a label;
   (b) computing at least one coreset from the data set,
   for generating an importance measure for each coreset sample of the at least one coreset, the importance measure being indicative of at least one of an importance value and a weight value;
   (c) selecting, from the coresets, at least one selected coreset that is representative of the data set,
   the at least one selected coreset constituting a representative sub-set of the coresets; and
   (d) selecting, from the representative sub-set, a number of coreset samples, based on at least one importance-related criterion,
   the at least one importance-related criterion being indicative of corresponding importance measures of the at least one selected coreset having at least one of high importance values and low weight values,
   giving rise to a set of selected coreset samples having a high probability of at least one of high importance values and low weight values, as compared to a second probability associated with selecting a corresponding number of data instances from the data set,
the set of selected coreset samples facilitating determining, for each coreset sample of the set of selected coreset samples whether the each coreset sample requires an action,
thereby facilitating performing the action, which brings about an increased-quality representative sub-set of coresets, as compared to a quality of the representative sub-set,
the increased-quality representative sub-set of coresets facilitating at least one of quicker training of the machine learning model and a higher-accuracy training of the machine learning model, as compared to a second training of the machine learning model performed utilizing the data set.

The computerized systems and the non-transitory computer readable storage media, disclosed herein according to various aspects, can optionally further comprise one more of the embodiments (2) to (20) listed above, mutatis mutandis, in any technically possible combination or permutation.
23. According to a fourth aspect of the presently disclosed subject matter there is presented computerized method of cleaning a data set, the method performed by a processing circuitry of a data cleaning system, the method comprising:
   (a) providing the data set, the data set being configured for training of a machine learning model,
   the data set comprising a plurality of data instances, each data instance of
   the plurality of data instances comprising a label;
   (b) selecting a number of data instances from the data set based on at least one importance-related criterion,
   thereby generating at least one high importance set, the at least one importance-related criterion being indicative of corresponding high importance values associated with the plurality of data instances,
   giving rise to a set of selected data instances having a high probability of high importance values, as compared to a second probability associated with selecting a corresponding number of data instances from the data set,
the set of selected data instances facilitating determining, for each data instance of the set of selected data instances, whether the each data instance requires an action,
thereby facilitating performing the action, which brings about at least one increased quality data set, as compared to a quality of the data set,
the increased-quality data set facilitating at least one of a quicker training of the machine learning model and a higher-accuracy training of the machine learning model, as compared to a second training of the machine learning model performed utilizing the data set.

In addition to the above features, the method according to the fourth aspect of the presently disclosed subject matter can include one or more of embodiments (24) to (41) listed below, in any desired combination or permutation which is technically possible:
24. The computerized method of embodiment 23, where the at least one non-coreset set is comprised in a high importance set tree.
25. The computerized method of embodiment 24, the method further comprising:
   (c) selecting, from the at least one non-coreset set and at least one other high importance set, a second number of data instances based on at least one other importance-related criterion,
      the at least one other high importance set being associated with a same tree level as the at least one high importance set,
thereby generating at least one parent high importance set; and
   (d) setting the at least one parent high importance set to constitute the at least one high importance set.
26. The computerized method of embodiment 25, further comprising repeating said steps (c) and (d) at least once.
27. The computerized method of any one of embodiments 25 to 26, where the at least one importance-related criterion and the at least one other importance-related criterion are the same.
28. The computerized method of any one of embodiments 25 to 27, where the number of data instances and second number of data instances are the same.
29. The computerized method of any one of embodiments 23 to 28, where the selecting of the number of data instances, based on the at least one importance-related criterion, comprises one of the following:
   i. selecting data instances of highest importance values;
   ii. selecting data instances of importance values above a defined importance value; and
   iii. selecting data instances based on a class associated with the plurality of data instances.
30. The computerized method of embodiment 29, where the selecting the data instances, based on a class associated with the plurality of data instances, comprises selecting, from a particular class, in proportion to a prevalence of the particular class within the plurality of data instances.
31. The computerized method of any one of embodiments 23 to 30, further comprising calculating the corresponding importance values associated with the plurality of data instances.
32. The computerized method of any one of embodiments 23 to 31, where the number of data instances is a defined number of data instances.
33. The computerized method of any one of embodiments 23 to 32, where the action comprises at least one of:
   A. correcting a sample label associated with the each data instance;
   B. deleting the each data instance;
   C. creating a new class, and assigning, to the each data instance, a new data instance label, associated with the new class; and
   D. adding additional data instances to the data set.
34. The computerized method of any one of embodiments 23 to 33, the method further comprising:
   (e) responsive to the determining whether the each coreset sample requires the action, and responsive to the performing of the action, performing the training of the machine learning model, utilizing one of:
      i. the data set; and
      ii. a representative sub-set of coresets,
      where the representative sub-set of the coresets is derived by:
         i) computing at least one coreset from the increased quality data set, for generating an importance measure for each coreset sample of the at least one coreset, the importance measure being indicative of at least one of the importance value and a weight value; and
         (ii) selecting, from the coresets, at least one selected coreset that is representative of the data set,
         the at least one selected coreset constituting the representative sub-set of the coresets.
35. The computerized method embodiment 34, where the at least one coreset is comprised in a coreset data structure,
   the coreset data structure having at least the following properties:
      I. an ability to add a coreset sample to the at least one coreset;
      II. an ability to delete a coreset sample to the at least one coreset;
      III. an ability to modify a coreset sample; and
      IV. an ability to find a coreset sample within the coreset data structure.
36. The computerized method of embodiment 35, where the coreset data structure further having at least the following property:
   V. an ability to update the data structure with Log-N time complexity, or with better than in Log-N time complexity.
37. The computerized method of any one of embodiments 34 to 36, where the at least one coreset comprises a coreset tree.
38. The computerized method of one of embodiments 34 to 37, the method further comprising:
   (f) evaluating a model quality associated with the trained machine learning model.
39. The computerized method of embodiment 38, the method further comprising:
   (g) repeating said steps (c) through (f) until meeting a process-termination criterion.
40. The computerized method of embodiment 39, where the process-termination criterion comprises at least one of the following:
   I. a defined number of repetitions have been performed; and
   II. an improvement of the quality level over at least one previous iteration is below a defined improvement level.
41. The computerized method of any one of embodiments 23 to 40, where the at least one high importance set comprises a plurality of high importance sets, where each high importance set is generated from a distinct sub-set of the data set.

In addition to the above features, the method according to the fourth aspect of the presently disclosed subject matter can include one or more of embodiments (1) to (20) listed above, in any desired combination or permutation which is technically possible:

According to a fifth aspect of the presently disclosed subject matter there is presented a computerized data cleaning system, comprising a processing circuitry, configured to perform the method of cleaning a data set of the fourth aspect of the presently disclosed subject matter.

According to a sixth aspect of the presently disclosed subject matter there is presented non-transitory computer readable storage medium tangibly embodying a program of instructions that, when executed by a processing circuitry of a data cleaning system, cause the processing circuitry to perform a method of cleaning a data set of the fourth aspect the presently disclosed subject matter.

In addition to the above features, the method according to the fifth through sixth aspects of the presently disclosed subject matter can include one or more of embodiments (2) to (41) listed above, mutatis mutandis, in any desired combination or permutation which is technically possible.

According to a seventh aspect of the presently disclosed subject matter there is presented a computerized method of machine learning model training, the method performed by a processing circuitry of a machine learning system, the method comprising:
(a) providing a data set, the data set being configured for training of a machine learning model,
the data set comprising a plurality of data instances;
(b) providing a coreset tree, the coreset tree being computed from the data set, the coreset tree comprising a plurality of coresets;
(c) detaching, from the coreset tree, at least one branch of the coreset tree, wherein each branch comprises at least one coreset of the plurality of coresets, the at least one coreset being representative of a portion of the data set,
the detaching thereby giving rise to a reduced coreset tree that is exclusive of the at least one branch and which comprises remaining coresets of the plurality of coresets;
(d) selecting, from the reduced coreset tree, at least one selected coreset that is representative of the remaining portion of the data set;
(e) training the machine learning model, utilizing the at least one selected coreset, thereby giving rise to a trained machine learning model; and
(f) evaluating a model quality, associated with an ability of the trained machine learning model to perform prediction, utilizing the detached at least one branch,
   thereby facilitating validation of the trained machine learning model.

In addition to the above features, the method according to this aspect of the presently disclosed subject matter can include one or more of features (i) to (xxvi) listed below, in any desired combination or permutation which is technically possible:
(i) the method further comprising:
   (g) repeating the steps (c) through (f) in respect of at least one other branch, the at least one other branch constituting the at least one branch.
(ii) the repetition in said step (g) is performed until the evaluation in said step (f) has been performed with respect to data that is representative of all data instances of the plurality of data instances, thereby facilitating a cross-validation of the machine learning model.
(iii) the method further comprising:
   (h) restoring the coreset tree, wherein the restoring comprises:
      i. reattaching the detached at least one branch; and
   (i) repeating said steps (c) through (f) and (h), in respect of at least one other branch, the at least one other branch constituting the at least one branch.
(iv) the method further comprising, performing after said step (d) and before said step (e):
   (j) in a case in which a second tree level, associated with at least one selected coreset, is higher than a tree level associated with the at least one branch, perform the following step:
      i. recomputing at least all ancestor coresets of the each branch which
         are at the second tree level or
         are lower than is the second tree level,
      wherein, for at least one ancestor coreset, the recomputing comprises recalculating an importance measure for at least one coreset sample, the importance measure being indicative of at least one of an importance value and a weight value,
      thereby giving rise to a modified reduced coreset tree comprising a modified at least one selected coreset;
      ii. setting the modified at least one selected coreset to constitute the at least one selected coreset.
(v) the providing the coreset tree in said step (b) comprises computing the coreset tree.
(vi) the evaluating of the model quality, utilizing the detached at least one branch, comprises evaluation of the model quality utilizing the portion of the data set of the each branch.
(vii) the training of the machine learning model, utilizing the representative sub-set of the remaining coresets, comprises training utilizing a modified root coreset of the modified reduced coreset tree.
(viii) all detached branches are associated with a same coreset tree level.
(ix) the evaluating of the model quality comprises evaluating of hyperparameters associated with the machine learning model.
(x) the evaluating of the model quality comprises generating one or more quality metrics associated with the evaluation.
(xi) the method further comprising:
   (k) repeating said steps (c) through (f) in respect of at least one other branch, the at least one other branch constituting the at least one branch; and
   (l) generating a total quality metric indicative of the one or more quality metrics.
(xii) the method further includes performing after step (d) and before step (e):
in a case in which a second tree level, associated with at least one selected coreset, is higher than a tree level associated with the at least one branch, perform the following steps:
   (i) recomputing at least all ancestor coresets of each branch which are at the second tree level or are lower than is the second tree level. For at least one ancestor coreset, the recomputing comprises recalculating an importance measure for at least one coreset sample. The importance measure is indicative of at least one of an importance value and a weight value. This gives rise to a modified reduced coreset tree comprising a modified selected coreset(s); and
   (ii) setting the modified selected coreset(s) to constitute the at least one selected coreset.
(xiii) the method further includes performing after step (d) and before step (e), the following steps:
   (iii) recomputing at least all ancestor coresets of each detached branch which are part of the selected coresets which will be used in training the model, as well as recomputing those ancestor coresets located between this selected ancestor coreset and the detached branch. The recomputing comprises recalculating an importance measure for at least one coreset sample. The importance measure is indicative of at least one of an importance value and a weight value. This gives rise to a modified reduced coreset tree comprising a modified selected coreset(s); and
   (iv) setting the modified selected coreset(s) to constitute the at least one selected coreset.
(xiv) the repetition in said step (g) is performed nine (9) times.
(xv) the detached at least one branch is associated with a tree level of the coreset tree.
(xvi) a second tree level, associated with the at least one selected coreset, is identical to the tree level.
(xvii) the method further comprising:
   (m) restoring the coreset tree, wherein the restoring comprises:
      i. reattaching the detached at least one branch; and
      ii. restoring the importance measure of the at least one coreset sample; and
   (n) repeating said steps (c) through (f) and (h), in respect of at least one other branch, the at least one other branch constituting the at least one branch.
(xviii) the method further comprises performing, prior to said step (h)(i):
   (o) storing a coreset tree configuration associated with the coreset tree,
   wherein the restoring of the coreset tree comprises restoring the stored coreset tree configuration.
(xix) the evaluating of the model quality, utilizing the detached at least one branch, comprises evaluation of the model quality utilizing representative branch coresets of the each branch.
(xx) each branch is a leaf coreset.
(xxi) each branch comprises internal nodes of the coreset tree.
(xxii) the training of the machine learning model, utilizing the representative sub-set of the remaining coresets, comprises training utilizing leaf coresets of the remaining coresets.
(xxiii) the recomputing the at least all ancestor coresets comprises recomputing one ancestor coreset.
(xxiv) the at least one branch comprises a plurality of distinct branches.
(xxv) the coreset tree comprises a binary coreset tree.
(xxvi) the evaluating the model quality, in said step (f), comprises identifying one or more problematic data instances,
the method further comprising at least one of the following steps:
   (p) deleting, from the data set, the identified one or more problematic data instances; and
   (q) marking, for cleaning, the identified one or more problematic data instances.

According to an eighth aspect of the presently disclosed subject matter there is presented a computerized method of machine learning model training, the method performed by a processing circuitry of a machine learning system, the method comprising:
(a) providing a data set, the data set being configured for training of a machine learning model,
the data set comprising a plurality of data sub-sets, each data sub-set comprising a plurality of data instances;
(b) providing a coreset tree, the coreset tree being computed from the data set, the coreset tree comprising a plurality of coresets,
wherein each leaf coreset of the coreset tree being based on a corresponding data sub-set;
(c) removing at least one data instance from at least one data sub-set, thereby generating, from the at least one data sub-set, at least one reduced data sub-set;
(d) recomputing at least one coreset that is an ancestor of the at least one reduced data sub-set, to reflect the removal of the at least one data instance, thereby giving rise to a modified coreset tree;
(e) selecting, from the modified coreset tree, coresets that are representative of the data set exclusive of the removed at least one data instance;
(f) training the machine learning model utilizing the selected coresets, giving rise to a trained machine learning model;
(g) performing at least one prediction for the removed at least one data instance, utilizing the trained machine learning model; and
(h) evaluating at least one model predictability metric, associated with the at least one prediction, being indicative of an ability of the trained learning model to correctly predict the at least one removed data instance.

According to a ninth aspect of the presently disclosed subject matter there is presented a computerized method of computerized method of machine learning model training, the method performed by a processing circuitry of a machine learning system, the method comprising:
(a) providing a data set, the data set being configured for training of a machine learning model,
the data set comprising a plurality of data sub-sets, each data sub-set comprising a plurality of data instances;
(b) providing a coreset tree, the coreset tree being computed from the data set, the coreset tree comprising a plurality of coresets,
wherein each leaf coreset of the coreset tree being based on a corresponding data sub-set;
(c) removing at least one data instance from at least one data sub-set, thereby generating, from the at least one data sub-set, at least one reduced data sub-set;
(d) setting at least one leaf coreset of the plurality of coresets, corresponding to the at least one reduced data sub-set, to constitute at least one invalid leaf coreset;
(e) selecting a defined tree level, associated with the training of the machine learning model;
(f) for each invalid leaf coreset, performing the following:
   i. recomputing the each invalid leaf coreset, thereby giving rise to each corrected leaf coreset; and
   ii. recomputing at least all ancestor coresets of the each corrected leaf coreset which
      are at the defined tree level or
         are lower than is the defined tree level,
   wherein, for at least one ancestor coreset, the recomputing comprises recalculating an importance measure for at least one coreset sample of all ancestor coresets, the importance measure being indicative of at least one of an importance value and a weight value,
   thereby giving rise to a modified coreset tree; and
(g) selecting, from the modified coreset tree, coresets that are representative of the data set exclusive of the removed at least one data instance, wherein at least one selected coreset being located at the defined tree level;
(h) training the machine learning model utilizing the selected coresets, giving rise to a trained machine learning model;
(i) performing at least one prediction for the removed at least one data instance, utilizing the trained machine learning model; and
(j) evaluating at least one model predictability metric, associated with the at least one prediction, being indicative of an ability of the trained learning model to correctly predict the at least one removed data instance.

In addition to the above features, the method according to the eighth through ninth aspects of the presently disclosed subject matter can include one or more of features (i) to (xxvi) listed above, mutatis mutandis, in any desired combination or permutation which is technically possible.

In addition to the above features, the method according to the eighth through ninth aspects of the presently disclosed subject matter can include one or more of features (xxvii) to (xxxvii) listed below, in any desired combination or permutation which is technically possible:
(xxvii) the providing the coreset tree in said step (b) comprises computing the coreset tree.
(xxviii) the at least one removed data instance is indicative of an edge case of the machine learning model,
wherein the model predictability metric is indicative of an ability of the trained learning model to correctly predict the edge case.
(xxix) the method further comprising:
   (i) repeating said steps (c) through (g) in respect of at least one other data instance, the at least one other data instance constituting the at least one data instance.
(xxx) the at least one data instance is a single data instance, and the at least one other data instance is a single other data instance,
thereby facilitating a cross-validation of the machine learning model utilizing a “leave one out” methodology.
(xxxi) the repetition of said step (i) comprises performing, prior to the repetition of said step (i):
   I. restoring the at least one removed data instance to the at least one data sub-set; and
   II. restoring the coreset tree,
(xxxii) the method further comprising performing, prior to said step (c):
   (j) grouping the at least one data instance into at least one additional sub-set, the at least one additional sub-set constituting the at least one data sub-set,
thereby facilitating minimizing a computational effort of the recomputing of the each invalid leaf coreset and of the recomputing of the at least all ancestor coresets.
(xxxiii) the training of the machine learning model utilizes the method of the first aspect of the presently disclosed subject matter.
(xxxiv) at least some data instances of the at least one data instance are associated with a group that shares at least one feature of interest.
(xxxv) the selected coresets are comprised in different tree levels of the coreset tree.
(xxxvi) first data instances of the at least one data instance are associated with a first group that shares at least one feature of interest,
wherein second data instances of the at least one other data instance are associated with a second group that shares at least one other feature of interest.
(xxxvii) the prediction comprises predicting a class associated with the removed at least one data instance.

According to a tenth aspect of the presently disclosed subject matter there is presented a computerized data cleaning system, comprising a processing circuitry, configured to perform the method of cleaning a data set of the eighth through ninth aspects of the presently disclosed subject matter.

According to an eleventh tenth aspect of the presently disclosed subject matter there is presented a non-transitory computer readable storage medium tangibly embodying a program of instructions that, when executed by a processing circuitry of a data cleaning system, cause the processing circuitry to perform a method of cleaning a data set of the eighth through ninth aspects of the presently disclosed subject matter.

In addition to the above features, the method according to the tenth and eleventh aspects of the presently disclosed subject matter can include one or more of features (i) to (xxxvii) listed above, in any desired combination or permutation which is technically possible:
42. According to a twelfth aspect of the presently disclosed subject matter there is presented a computerized method of machine learning model training, the method performed by a processing circuitry of a machine learning system, the method comprising:
   (a) providing a data set, the data set being configured for training of a machine learning model,
   the data set comprising a plurality of data sub-sets, each data sub-set comprising a plurality of data instances;
   (b) providing a coreset tree, the coreset tree being computed from the data set, the coreset tree comprising a plurality of coresets,
   wherein each leaf coreset of the coreset tree being based on a corresponding data sub-set;
   (c) removing at least one data instance from at least one data sub-set, thereby generating, from the at least one data sub-set, at least one reduced data sub-set;
   (d) recomputing at least one coreset that is an ancestor of the at least one reduced data sub-set, to reflect the removal of the at least one data instance, thereby giving rise to a modified coreset tree;
   (e) selecting, from the modified coreset tree, coresets that are representative of the data set exclusive of the removed at least one data instance;
   (f) training the machine learning model utilizing the selected coresets, giving rise to a trained machine learning model;
   (g) performing at least one prediction for the removed at least one data instance, utilizing the trained machine learning model; and
   (h) evaluating at least one model predictability metric, associated with the at least one prediction, being indicative of an ability of the trained learning model to correctly predict the at least one removed data instance.
43. The method of embodiment 42, wherein the providing the coreset tree in said step (b) comprises computing the coreset tree.
44. The method of any one of embodiments 42 to 43, wherein the at least one removed data instance is indicative of an edge case of the machine learning model,
where the model predictability metric is indicative of an ability of the trained learning model to correctly predict the edge case.
45. The method of any one of embodiments 42 to 44, the method further comprising:
   (i) repeating said steps (c) through (g) in respect of at least one other data instance, the at least one other data instance constituting the at least one data instance.
46. The method of embodiment 45, wherein the at least one data instance is a single data instance, and the at least one other data instance is a single other data instance,
   thereby facilitating a cross-validation of the machine learning model utilizing a “leave one out” methodology.
47. The method of any one of embodiments 45 to 46, wherein the repetition of said step (i) comprises performing, prior to the repetition of said step (i):
   I. restoring the at least one removed data instance to the at least one data sub-set; and
   II. restoring the coreset tree,
48. The method of any one of embodiments 45 to 47, the method further comprising performing, prior to said step (c):
   (j) grouping the at least one data instance into at least one additional sub-set,
   the at least one additional sub-set constituting the at least one data sub-set, thereby facilitating minimizing a computational effort of the recomputing of the each invalid leaf coreset and of the recomputing of the at least all ancestor coresets.
49. The method of any one of embodiments 42 to 48, wherein the training of the machine learning model utilizes a corset-tree based cross-validation method.
50. According to a thirteenth aspect of the presently disclosed subject matter there is presented a computerized method of cleaning a data set, the method performed by a processing circuitry of a data cleaning system, the method comprising:
   (a) providing the data set, the data set being configured for training of a machine learning model,
   the data set comprising a plurality of data sub-sets, each data sub-set comprising a plurality of data instances;
   (b) providing a coreset tree, the coreset tree being computed from the data set, the coreset tree comprising a plurality of coresets,
   wherein each leaf coreset of the coreset tree being based on a corresponding data sub-set;
   (c) selecting a number of data items from the data set having a relatively high likelihood of abnormal data, as compared to a second likelihood of abnormal data associated with at least some other data items of the data set,
   thereby generating at least one cleaning-candidate identification set;
   (d) removing at least one corresponding data instance, corresponding to at least once data item of the selected number of data items, from at least one data sub-set,
   thereby generating, from the at least one data sub-set, at least one reduced data sub-set;
   (e) recomputing at least one coreset that is an ancestor of the at least one reduced data sub-set, to reflect the removal of the at least one corresponding data instance, thereby giving rise to a modified coreset tree;
   (f) selecting, from the modified coreset tree, coresets that are representative of the data set exclusive of the at least one removed corresponding data instance;
   (g) training the machine learning model, giving rise to a trained machine learning model;
   (h) performing at least one prediction for the removed at least one corresponding data instance, utilizing the trained machine learning model;
   (i) evaluating one or more model predictability metrics, associated with the at least one prediction, being indicative of an ability of the trained learning model to correctly predict the at least one removed corresponding data instance; and
   (j) based on at least the one or more model predictability metrics, perform an action which is configured to bring about an increased-quality data set, as compared to a quality of the data set,
the increased-quality data set facilitating at least one of a quicker training of the machine learning model and a higher-accuracy training of the machine learning model, as compared to a second training of the machine learning model performed utilizing the data set.
51. The computerized method of embodiment 50, wherein the abnormal data is one of mislabelled data, out of distribution data or strange data.
52. The computerized method of any one of embodiments 50 to 51, wherein the selecting the number of data items from the data set having a relatively high likelihood of abnormal data comprises selecting a number of data items from the data set based on at least one importance-related criterion,
the at least one importance-related criterion being indicative of at least one of corresponding high importance values and low weight values associated with the plurality of data instances.
53. According to a fourteenth aspect of the presently disclosed subject matter there is presented a computerized method of cleaning a data set, the method performed by a processing circuitry of a data cleaning system, the method comprising:
   (a) providing the data set, the data set being configured for training of a machine learning model,
   the data set comprising a plurality of data sub-sets, each data sub-set comprising a plurality of data instances;
   (b) providing a coreset tree, the coreset tree being computed from the data set, the coreset tree comprising a plurality of coresets,
   wherein each leaf coreset of the coreset tree being based on a corresponding data sub-set;
   (c) selecting a number of data items from the data set based on at least one importance-related criterion,
   thereby generating at least one cleaning-candidate identification set,
   the at least one importance-related criterion being indicative of at least one of corresponding high importance values and low weight associated with the plurality of data instances,
   the at least one cleaning-candidate identification set comprising selected data items having a high probability of at least one of high importance values and low weight values, as compared to a second probability associated with selecting a corresponding number of data instances from the data set;
   (d) removing at least one corresponding data instance, corresponding to at least once data item of the selected number of data items, from at least one data sub-set,
   thereby generating, from the at least one data sub-set, at least one reduced data sub-set;
   (e) recomputing at least one coreset that is an ancestor of the at least one reduced data sub-set, to reflect the removal of the at least one corresponding data instance, thereby giving rise to a modified coreset tree;
   (f) selecting, from the modified coreset tree, coresets that are representative of the data set exclusive of the at least one removed corresponding data instance;
   (g) training the machine learning model, giving rise to a trained machine learning model;
   (h) performing at least one prediction for the removed at least one corresponding data instance, utilizing the trained machine learning model;
   (i) evaluating one or more model predictability metrics, associated with the at least one prediction, being indicative of an ability of the trained learning model to correctly predict the at least one removed corresponding data instance; and
   (j) based on at least the one or more model predictability metrics, perform an action which is configured to bring about an increased-quality data set, as compared to a quality of the data set,
the increased-quality data set facilitating at least one of a quicker training of the machine learning model and a higher-accuracy training of the machine learning model, as compared to a second training of the machine learning model performed utilizing the data set.
54. The computerized method of any one of embodiments 50 to 53, wherein the selecting the number of data items from the data set having a relatively high likelihood of abnormal data comprises at least one of:
   a. utilizing an anomaly detection method;
   b. utilizing a kernel-based method; and
   c. utilizing confidence learning.
55. The computerized method of any one of embodiments 50 to 54, wherein the removing of the at least one corresponding data instance from the at least one data sub-set comprises removing all of the selected data items from the data set.
56. The computerized method of any one of embodiments 50 to 55, wherein the performed action comprises at least one of:
   a. correcting, in an automated fashion, a label associated with the removed at least one corresponding data instance;
   b. marking the at least one corresponding data instance as requiring review by a data-analysis user;
   c. marking the at least one corresponding data instance as being unprioritized for review by the data-analysis user;
   d. marking the at least one corresponding data instance as not requiring review by the data-analysis user; and
   e. determining that the at least one corresponding data instance is out of distribution.
57. The computerized method of any one of embodiments 50 to 56, wherein a decision to perform an action, based on at least the one or more model predictability metrics, comprises deciding based on a probability associated with a classification of the data instance by the trained machine learning model.
58. The computerized method of embodiment 57, wherein the data set is associated with a plurality of classes,
wherein, for the at least one corresponding data instance, a plurality of predictions are performed for a corresponding plurality of classes,
wherein each prediction of the plurality of predictions is associated with a corresponding probability,
wherein the deciding based on the probability associated with a classification of the data comprises deciding based on a highest-probability prediction of the plurality probability associated with a highest corresponding probability associate with the plurality of predictions.
59. The computerized method of embodiment 58,
wherein a selection of the performed action is based at least on a label associated with the at least one corresponding data instance.
60. The computerized method of any one of embodiments 50 to 59, the method further comprising:
   (k) evaluating a model quality associated with the trained machine learning model.
61. The computerized method of any one of embodiments 50 to 60, the method further comprising:
   (l) repeating said steps (c) through (k) until meeting a process-termination criterion.
62. The computerized method of embodiment 61, wherein the process-termination criterion comprises at least one of the following:
   I. a defined number of repetitions have been performed; and
   II. an improvement of the quality level over at least one previous iteration is below a defined improvement level.
63. The computerized method of any one of embodiments 50 to 62, wherein the selecting of the number of data items from the data set, based on the at least one importance-related criterion, comprises performing the following:
   i. computing the coreset tree from the data set,
   for generating an importance measure for each coreset sample of the at least one coreset, the importance measure being indicative of at least one of an importance value and a weight value;
   ii. selecting, from the coreset tree, at least one selected coreset that is representative of the data set,
   the at least one selected coreset constituting a representative sub-set of the coresets; and
      iii. selecting, from the representative sub-set, a number of coreset samples, based on the at least one importance-related criterion,
giving rise to a set of selected coreset samples, the set of selected coreset samples constituting the at least one cleaning-candidate identification set, the selected coreset samples constituting the selected number of data items.
64. The computerized method of any one of embodiments 50 to 63, wherein the selecting the number of data items from the data set, based on the at least one importance-related criterion, comprises selecting the number of data items directly from the data set, based on the at least one importance-related criterion,
   where the at least one importance-related criterion is indicative of corresponding high importance values associated with the plurality of data instances,
      the selection thereby generating at least one high importance non-coreset set,
the at least one high importance non-coreset set comprising selected data instances, the at least one high importance non-coreset set constituting the at least one cleaning-candidate identification set, the selected data instances constituting the number selected data items.
65. The computerized method of any one of embodiments 50 to 64, wherein the selecting of the number of data items from the data set, based on the at least one importance-related criterion, comprises performing the following:
   i. computing the coreset tree from the data set,
   for generating an importance measure for each coreset sample of the at least one coreset, the importance measure being indicative of at least one of an importance value and a weight value;
   ii. selecting, from the coreset tree, at least one selected coreset that is representative of the data set,
   the at least one selected coreset constituting a representative sub-set of the coresets; and
      iii. selecting, from the representative sub-set, a number of coreset
      samples, based on the at least one importance-related criterion, giving rise to a set of selected coreset samples, the set of selected coreset samples constituting the at least one cleaning-candidate identification set, the selected coreset samples constituting the selected number of data items.
66. The computerized method of any one of embodiments 50 to 65, wherein the selecting of the number of coreset samples, based on the at least one importance-related criterion, comprises one of the following:
   selecting coreset samples of highest importance;
   selecting coreset samples of importance above a defined importance value;
   selecting coreset samples of lowest weight;
   selecting coreset samples of weight below a defined weight value; and
   selecting the representative sub-set of the at least one coreset.
67. The computerized method of any one of embodiments 50 to 66, wherein the number of coreset samples is a defined number of coreset samples.
68. The computerized method of any one of embodiments 50 to 67, wherein the selection of the number of coreset samples is performed for a particular class comprised in the plurality of data instances.
69. The computerized method of any one of embodiments 50 to 68, wherein the selected representative sub-set comprises all coresets of the at least one coreset.
70. The computerized method of any one of embodiments 50 to 69, wherein the performing the action in the at least one data item comprises one of the following:
   performing the action in the representative sub-set; and
   performing the action in all coresets, of the at least one coreset, that comprise the each coreset sample.
71. The computerized method of any one of embodiments 50 to 70, wherein the performing of the action comprises performing the action in a respective instance of the data set,
the respective instance of the data set corresponding to the each coreset sample.
72. The computerized method of any one of embodiments 50 to 71, wherein the selecting the number of data items from the data set, based on the at least one importance-related criterion, comprises selecting the number of data items directly from the data set, based on the at least one importance-related criterion,
wherein the at least one importance-related criterion is indicative of corresponding high importance values associated with the plurality of data instances,
   the selection thereby generating at least one high importance non-coreset set,
   the at least one high importance non-coreset set comprising selected data instances, the at least one high importance non-coreset set constituting the at least one cleaning-candidate identification set, the selected data instances constituting the number of selected data items.
73. The computerized method of any one of embodiments 50 to 72, wherein the selecting the number of data items from the data set, based on the at least one importance-related criterion, comprises selecting the number of data items directly from the data set, based on the at least one importance-related criterion,
wherein the at least one importance-related criterion is indicative of corresponding high importance values associated with the plurality of data instances,
   the selection thereby generating at least one high importance non-coreset set,
   the at least one high importance non-coreset set comprising selected data instances, the at least one high importance non-coreset set constituting the at least one cleaning-candidate identification set, the selected data instances constituting the number of selected data items.
74. The computerized method of any one of embodiments 50 to 73, the method further comprising:
   (m) selecting, from the at least one high importance non-coreset set and at least one other high importance non-coreset set, a second number of data instances based on at least one other importance-related criterion,
      the at least one other high importance non-coreset set being associated with a same tree level as the at least one high importance non-coreset set,
      thereby generating at least one parent high importance non-coreset set; and
   (n) setting the at least one parent high importance non-coreset set to constitute the at least one high importance non-coreset set.
75. The computerized method of embodiment 74, further comprising repeating said steps (m) and (n) at least once.
76. The computerized method any one of embodiments 50 to 75, wherein the at least one importance-related criterion and the at least one other importance-related criterion are the same.
77. The computerized method of any one of embodiments 50 to 76, wherein the number of data instances and second number of data instances are the same.
78. The computerized method of any one of embodiments 50 to 77, wherein the selecting of the number of data instances, based on the at least one importance-related criterion, comprises one of the following:
   i. selecting data instances of highest importance values;
   ii. selecting data instances of importance values above a defined importance value; and
   iii. selecting data instances based on a class associated with the plurality of data instances.
79. The computerized method of embodiment 78, wherein the selecting the data instances, based on a class associated with the plurality of data instances, comprises selecting, from a particular class, in proportion to a prevalence of the particular class within the plurality of data instances.
80. The computerized method of any one of embodiments 50 to 79, further comprising calculating the corresponding importance values associated with the plurality of data instances.
81. The computerized method of any one of embodiments 50 to 80, wherein the number of data instances is a defined number of data instances.
82. The computerized method of any one of embodiments 50 to 81, further comprising:
   (o) setting at least one leaf coreset of the plurality of coresets, corresponding to the at least one reduced data sub-set, to constitute at least one invalid leaf coreset;
83. The computerized method of any one of embodiments 50 to 82, further comprising:
   (p) selecting a defined tree level, associated with the training of the machine learning model;
84. The computerized method of any one of embodiments 50 to 83, further comprising:
   (q) for each invalid leaf coreset, performing the following:
   recomputing the each invalid leaf coreset, thereby giving rise to each corrected leaf coreset; and
   recomputing at least all ancestor coresets of the each corrected leaf coreset which are at the defined tree level or are lower than is the defined tree level,
      wherein, for at least one ancestor coreset, the recomputing comprises recalculating an importance measure for at least one coreset sample of all ancestor coresets, the importance measure being indicative of at least one of an importance value and a weight value,
      thereby giving rise to the modified coreset tree; and
selecting, from the modified coreset tree, coresets that are representative of the data set exclusive of the removed at least one data instance,
   wherein at least one selected coreset being located at the defined tree level.
85. The computerized method of embodiment 16, where the step (1) comprises repeating said step (b).
86. The computerized method of any one of embodiments 50 to 85, wherein the training of the machine learning model utilizes at least one of:
   i. the data set; and
   ii. a representative sub-set of the coresets,

According to a fifteenth aspect of the presently disclosed subject matter there is presented a computerized training system, comprising a processing circuitry, configured perform the method of the twelfth through fourteenth aspects of the presently disclosed subject matter.

According to a sixteenth aspect of the presently disclosed subject matter there is presented a computerized non-transitory computer readable storage medium tangibly embodying a program of instructions that, when executed by a processing circuitry of a training system, cause the processing circuitry to perform to perform the method of the twelfth through fourteenth aspects of the presently disclosed subject matter.

The fifteenth through sixteenth aspects of the disclosed subject matter can optionally include one or more of embodiments (42) to (86) listed above, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 schematically illustrates an example generalized view of a dataset, in accordance with some embodiments of the presently disclosed subject matter;

FIG. 2 schematically illustrates an example generalized view of a coreset, in accordance with some embodiments of the presently disclosed subject matter;

FIG. 3 schematically illustrates an example generalized view of a coreset data structure, in accordance with some embodiments of the presently disclosed subject matter;

FIG. 4 schematically illustrates an example generalized view of building a coreset data structure, in accordance with some embodiments of the presently disclosed subject matter;

FIG. 5A schematically illustrates an example generalized view of view importance probability densities, in accordance with some embodiments of the presently disclosed subject matter;

FIGS. 5B-5C schematically illustrate an example generalized view of a data set, in accordance with some embodiments of the presently disclosed subject matter;

FIG. 6 schematically illustrates an example generalized view of cleaning a data set, in accordance with some embodiments of the presently disclosed subject matter;

FIG. 7 schematically illustrates an example generalized schematic diagram of a computerized data cleaning system, in accordance with some embodiments of the presently disclosed subject matter;

FIGS. 8A-8B schematically illustrate a generalized flow chart diagram, of a flow of a process or method, for data cleaning, in accordance with some embodiments of the presently disclosed subject matter;

FIG. 9 schematically illustrates an example generalized graph of performance of data cleaning, in accordance with some embodiments of the presently disclosed subject matter; and

FIG. 10 schematically illustrates an example generalized graph of performance of data cleaning, in accordance with some embodiments of the presently disclosed subject matter.

FIG. 11 schematically illustrates an example generalized view of a cleaning set data structure, in accordance with some embodiments of the presently disclosed subject matter; and

FIGS. 12A-12B schematically illustrate a generalized flow chart diagram, of a flow of a process or method, for data cleaning, in accordance with some embodiments of the presently disclosed subject matter.

FIG. 13 schematically illustrates an example generalized view of cross validation, in accordance with some embodiments of the presently disclosed subject matter;

FIG. 14 schematically illustrates an example generalized view of prediction for data instances, in accordance with some embodiments of the presently disclosed subject matter;

FIG. 15 schematically illustrates an example generalized view of prediction for data instances, in accordance with some embodiments of the presently disclosed subject matter;

FIG. 16 schematically illustrate a generalized schematic diagram, of a computerized machine learning system, in accordance with some embodiments of the presently disclosed subject matter;

FIG. 17A-17C schematically illustrate a generalized flow chart diagram, of a flow of a process or method, for machine learning model training, in accordance with some embodiments of the presently disclosed subject matter;

FIGS. 18A-18C schematically illustrate a generalized flow chart diagram of a flow of a process or method, for prediction for data instances,, in accordance with some embodiments of the presently disclosed subject matter;

FIG. 19, schematically illustrates an example generalized view of a dataset, in accordance with some embodiments of the presently disclosed subject matter;

FIGS. 20A-20B schematically illustrate an example generalized schematic diagram of a computerized machine learning system, in accordance with some embodiments of the presently disclosed subject matter;

FIGS. 21A-21E schematically illustrate a generalized flow chart diagram, of a flow of a process or method, for data cleaning, in accordance with some embodiments of the presently disclosed subject matter; and

FIG. 22 schematically illustrates a generalized flow chart diagram, of a flow of a process or method, for data cleaning, in accordance with some embodiments of the presently disclosed subject matter.

### DETAILED DESCRIPTION

In the drawings and descriptions set forth, identical reference numerals indicate those components that are common to different embodiments or configurations.

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

Unless specifically stated otherwise, as apparent from the following discussions, it is appreciated that throughout the specification discussions utilizing terms such as “providing”, “detaching”, “cleaning” “computing”, “re-computing”, “performing”, “selecting”, “determining”, “generating”, “training”, “evaluating”, “validating” or the like, refer to the action(s) and/or process(es) of a computer that manipulate and/or transform data into other data, said data represented as physical, e.g. such as electronic or mechanical quantities, and/or said data representing the physical objects. The term “computer” should be expansively construed to cover any kind of hardware-based electronic device with data processing capabilities including a personal computer, a server, a computing system, a communication device, a processor or processing unit (e.g. digital signal processor (DSP), a microcontroller, a microprocessor, a field programmable gate array (FPGA), an application specific integrated circuit (ASIC), etc.), and any other electronic computing device, including, by way of non-limiting example, computerized systems or devices 700, 1800, 2200 and processing circuitries such as e.g. 423, 1820, 2220 disclosed in the present application.

The operations in accordance with the teachings herein may be performed by a computer specially constructed for the desired purposes, or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

The terms “non-transitory memory” and “non-transitory storage medium” used herein should be expansively construed to cover any volatile or non-volatile computer memory suitable to the presently disclosed subject matter.

As used herein, the phrase “for example,” “such as”, “for instance” and variants thereof describe non-limiting embodiments of the presently disclosed subject matter. Reference in the specification to “one case”, “some cases”, “other cases”, “one example”, “some examples”, “other examples”, or variants thereof, means that a particular described method, procedure, component, structure, feature or characteristic described in connection with the embodiment(s) is included in at least one embodiment of the presently disclosed subject matter, but not necessarily in all embodiments. The appearance of the same term does not necessarily refer to the same embodiment(s) or example(s).

Usage of conditional language, such as “may”, “might”, or variants thereof, should be construed as conveying that one or more examples of the subject matter may include, while one or more other examples of the subject matter may not necessarily include, certain methods, procedures, components and features. Thus such conditional language is not generally intended to imply that a particular described method, procedure, component or circuit is necessarily included in all examples of the subject matter. Moreover, the usage of non-conditional language does not necessarily imply that a particular described method, procedure, component or circuit is necessarily included in all examples of the subject matter.

It is appreciated that certain embodiments, methods, procedures, components or features of the presently disclosed subject matter, which are, for clarity, described in the context of separate embodiments or examples, may also be provided in combination in a single embodiment or examples. Conversely, various embodiments, methods, procedures, components or features of the presently disclosed subject matter, which are, for brevity, described in the context of a single embodiment, may also be provided separately or in any suitable sub-combination.

It should also be noted that each of the figures herein, and the text discussion of each figure, describe one aspect of the presently disclosed subject matter in an informative manner only, by way of non-limiting example, for clarity of explanation only. It will be understood that the teachings of the presently disclosed subject matter are not bound by what is described with reference to any of the figures or described in other documents referenced in this application.

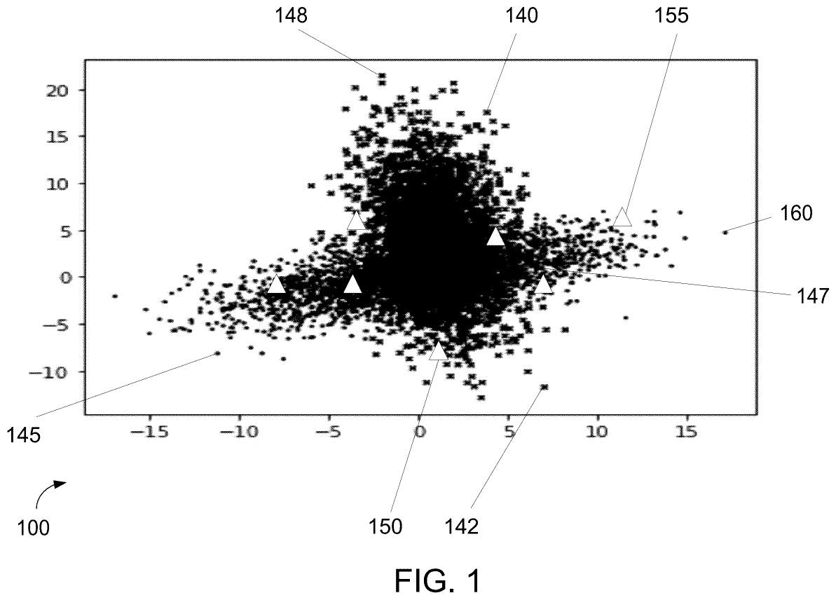

Bearing this in mind, attention is drawn to FIG. 1, schematically illustrating an example generalized view of a dataset, in accordance with some embodiments of the presently disclosed subject matter. View 100 depicts a conceptual view of an example data set comprising a plurality of data instances 140, 142, 145, 147, 148, 150, 155, 160. The view is presented to illustrate several concepts related to data sets used in the training machine learning (ML) models. These data instances are referred to herein also as samples or data points. Note that the presently disclosed subject matter is relevant for neural networks, as well as for other machine learning models/architectures.

In the non-limiting example of the figure, the data instances are associated with two classes, e.g. images of dogs and images of cats. The circles represent data instances with classification “dog”, they are thus labelled “dog”. Crosses/X's represent data instances with classification “cat”, and they are thus labelled “cat”. Point 145, 160 are example data instances of “dog”. Points 140, 142, 148 are example data instances of “cat”, and they are thus labelled “cat”. In other examples, there are more classes. The figure presents a simplified case for ease of exposition.

Example points 150, 155 (indicated with triangles) are relatively ambiguous, or problematic, data instances. One example of a problematic data instance is a data instance is a mislabeled one, for example the image of a cat which is mislabeled as “dog”. Several such problematic instances are shown, but typically there may be more.

In the depiction of the figure, the data instances shown roughly along the left-right axis tend to be circles/dogs, while those roughly along the up-down axis tend to be X's/cats. Note that near the middle of the graph there are a large number of data points, of both classes, grouped near each other, with points of different classes overlapping each other. Note that in this center region there is statistically a higher chance of e.g. ambiguity of the class, of similarity and confusion between classes, and thus of mislabeling etc.

Data instance 160 is one example of an outlier data instance, located in the graph relatively far from the center.

Statistical values can be calculated for the data instances of each class. For example, a center of mass of each class can be calculated, as well as a covariance matrix per class. These values are not depicted in the figure, for ease of exposition.

The quality of the machine learning models are highly dependent on the quality of the data used to train it—“garbage in, garbage out”. Datasets typically are not clean out of the box, but rather are full of errors and other problems and issues. Data scientists are said to sometimes spend more than half their time cleaning the data. Incorrectly labeled data has a very large effect on model quality, but they are very hard to find. A major challenge in this field is that there is not a good, efficient, methodology to find bugs, errors and other problems in the dataset.

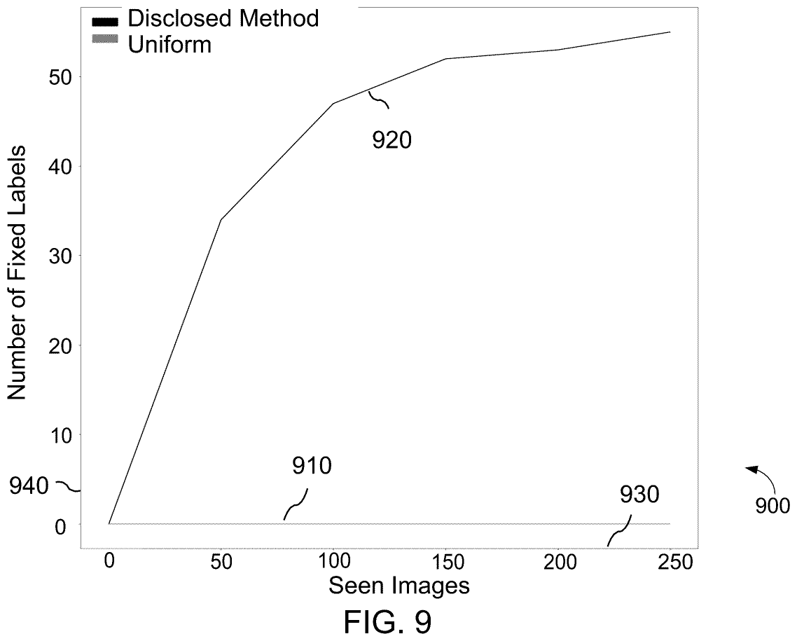

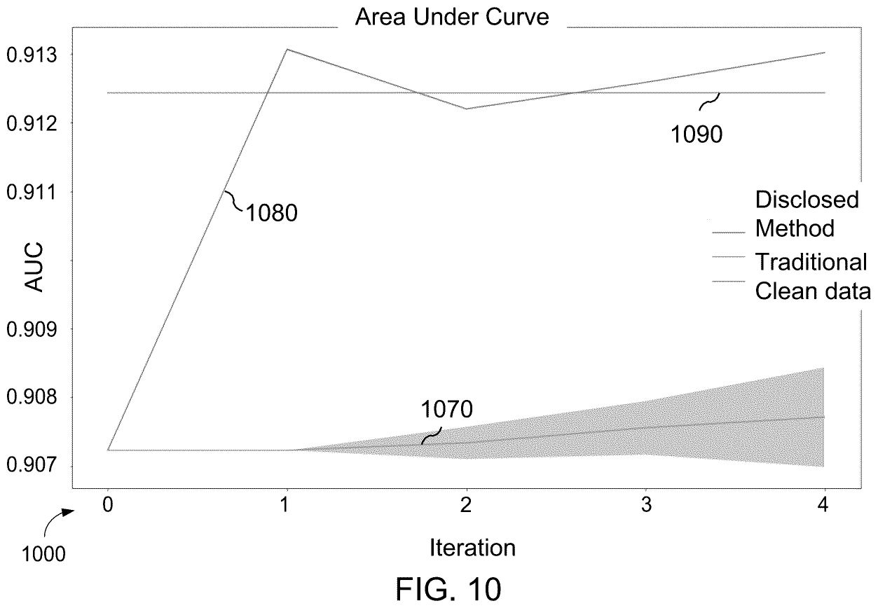

Currently, data scientists use various statistical tests, as well as random sampling of their datasets, to try and find errors. But using random sampling can be, in many cases, like “looking for a needle in a haystack”, because the chances of finding a large number of errors, with a reasonable investment of time and effort, are typically slim. Mathematical examples of this issue are disclosed further herein with reference to FIGS. 9-10.

At least to address such technical problems and disadvantages, there is disclosed here in computerized method of cleaning a data set, as well as a data cleaning system and software products to perform such a method. The method comprises, in some examples, the following:
(a) provide the data set, the data set being configured for training of a machine learning model, the data set comprising a plurality of data instances, each data instance of the plurality of data instances comprising a label;
(b) computing one or more coresets from the data set, for generating an importance measure for each coreset sample of the coreset(s). The importance measure is indicative of at least one of an importance value and a weight value;
(c) selecting, from the coresets, at least one selected coreset that is representative of the data set. The selected coreset(s) constitutes a representative sub-set of the coresets; and
(d) selecting, from the representative sub-set, a number of coreset samples, based on at least one importance-related criterion. The importance-related criterion(s) is indicative of corresponding importance measures of the at least one selected coreset having at least one of high importance values and low weight values. This gives rise to a set of selected coreset samples having a high probability of at least one of high importance values and low weight values, as compared to a second probability associated with selecting a corresponding number of data instances from the data set.

This set of selected coreset samples facilitates the determining, for each coreset sample of the set of selected coreset samples whether the each coreset sample requires an action. This thereby facilitates performing the action, which brings about an increased-quality representative sub-set of coresets, as compared to a quality of the representative sub-set.

The increased-quality representative sub-set of coresets can facilitate a quicker training of the machine learning model, and/or a higher-accuracy training of the machine learning model, as compared to a second training of the machine learning model performed utilizing the data set 100 itself.

The method comprises, in some non-limiting examples, the following:
(a) computing one or more coresets from the data set. The data set comprising a plurality of data instances. Each data instance comprises a label. The data set is configured for training of a machine learning model. The computing thereby generates an importance value, and/or a weight value, for each coreset sample of coreset(s).
(b) performing one of the following:
   I. select, from a representative sub-set of the coreset(s), a number of high importance coreset samples. The number of high importance coreset instances are referred to as a number of coreset instances; and
   II. select, from the representative sub-set, a number of low weight coreset samples. The number of low weight coreset instances are referred to as number of coreset instances.
   Each coreset sample of the number of coreset samples corresponds to a corresponding data instance of the plurality of data instances; and
(c) for each selected coreset sample of the number of coreset samples, performing the following:
   I. determining whether the each coreset sample requires an action; and
   II. in response to a determination that the each coreset sample requires the action, performing the action.

Thus, the method disclosed herein can, in at least some cases, reduce the time required for data scientists to develop machine learning models and improve their quality. The coreset methodology is used to significantly reduce the size of the dataset, while maintaining the statistical properties and outliers of the full dataset 100.

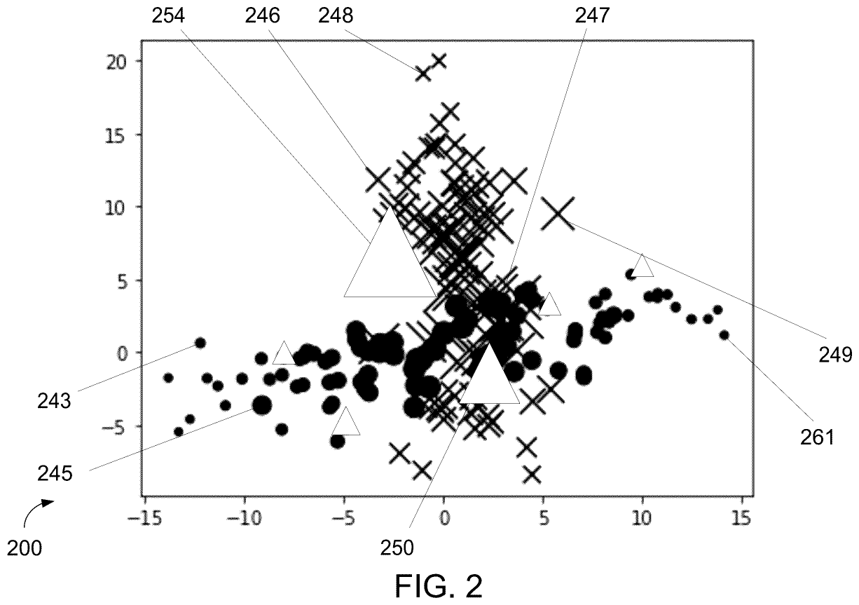

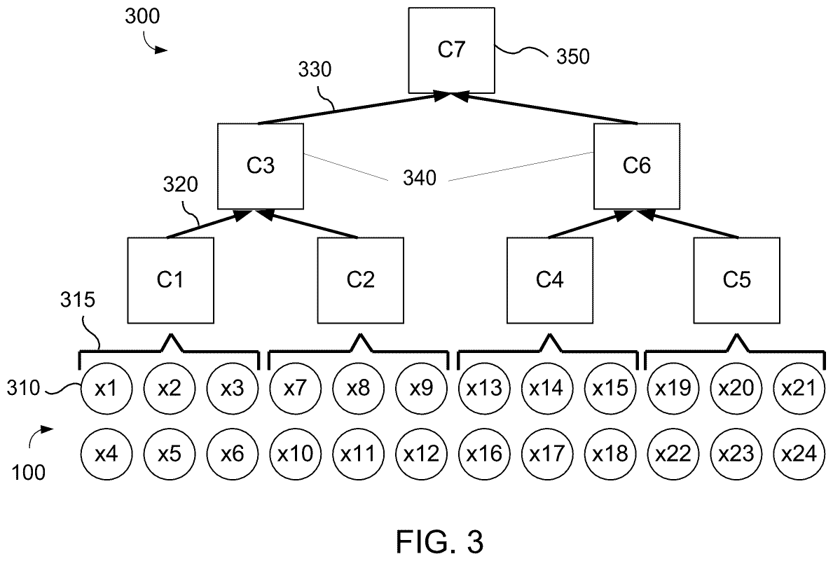

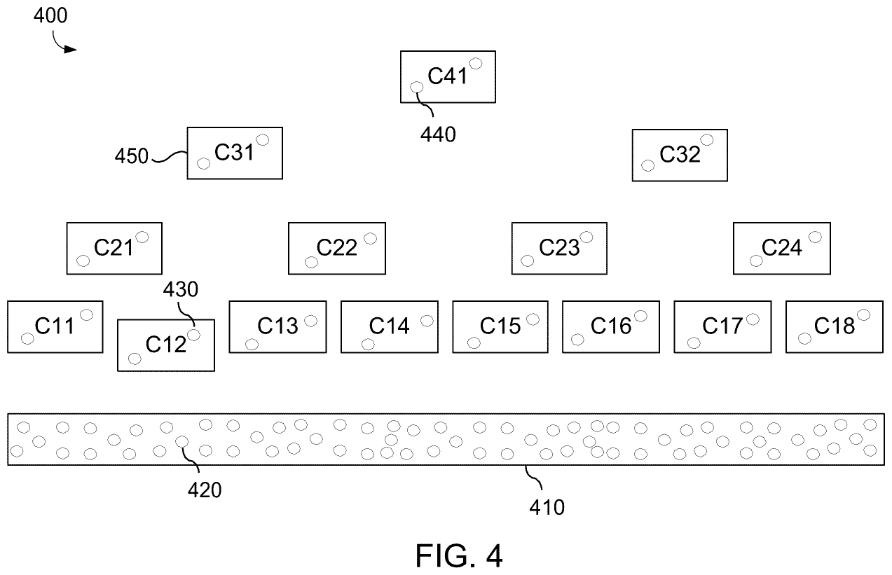

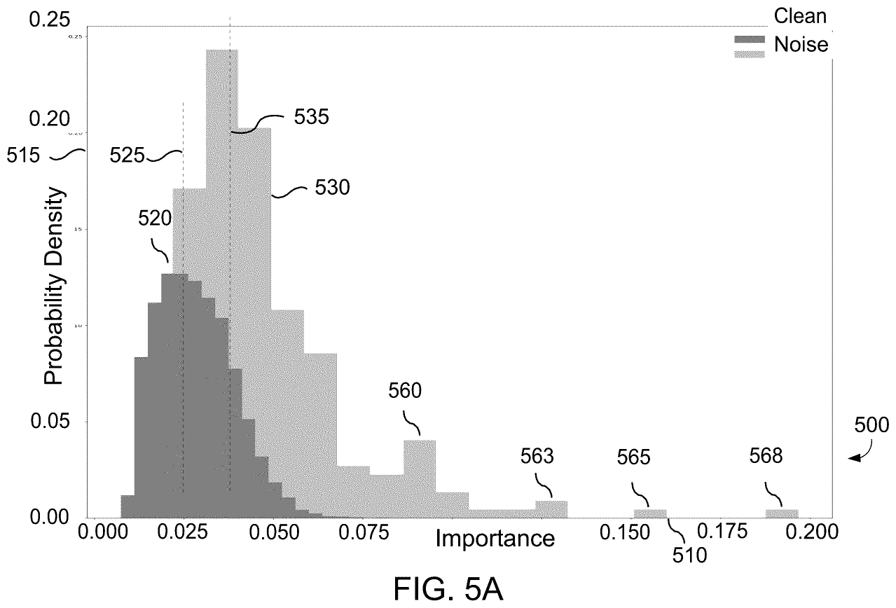

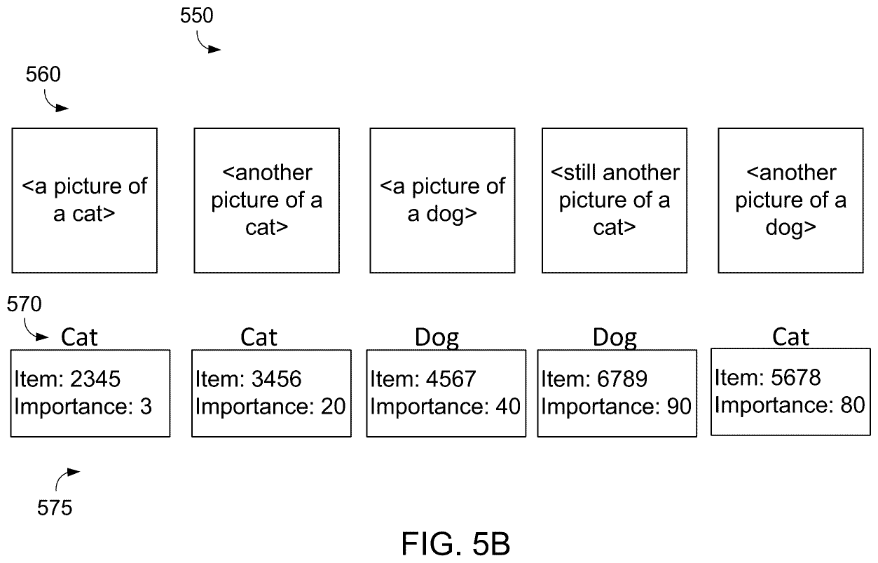

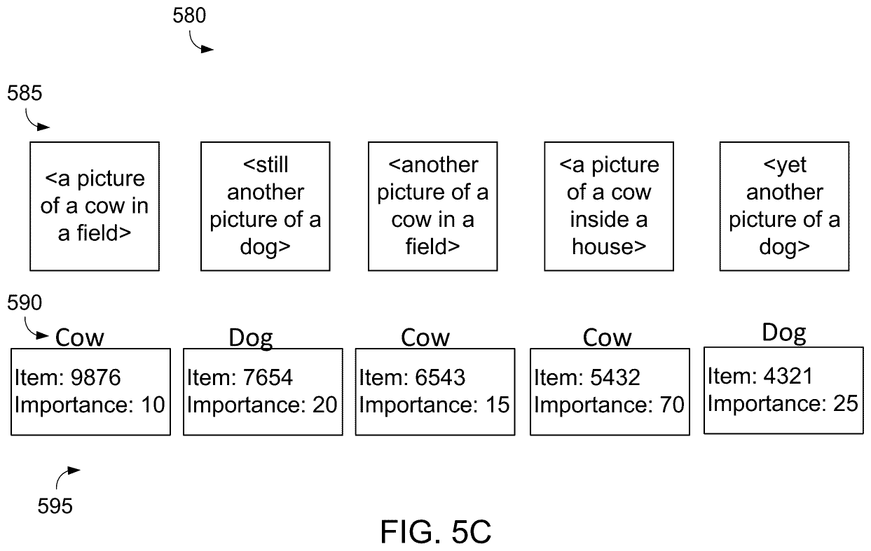

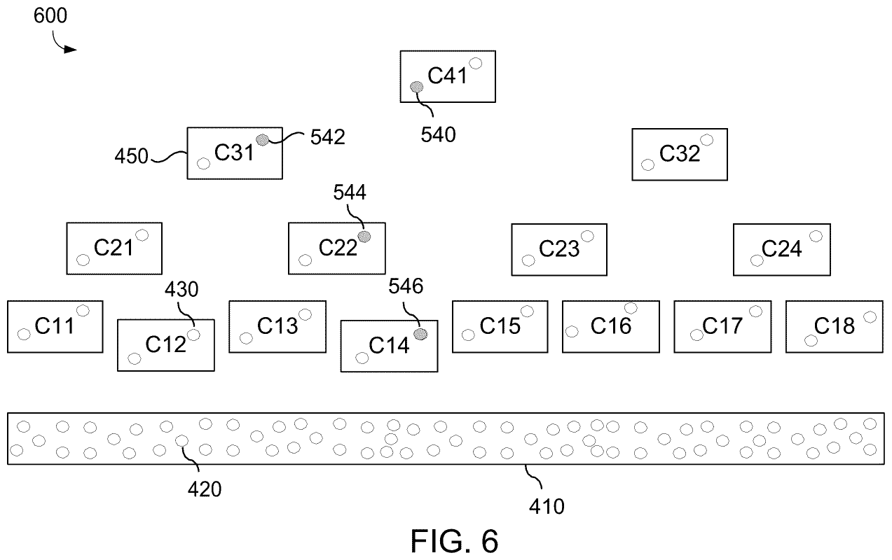

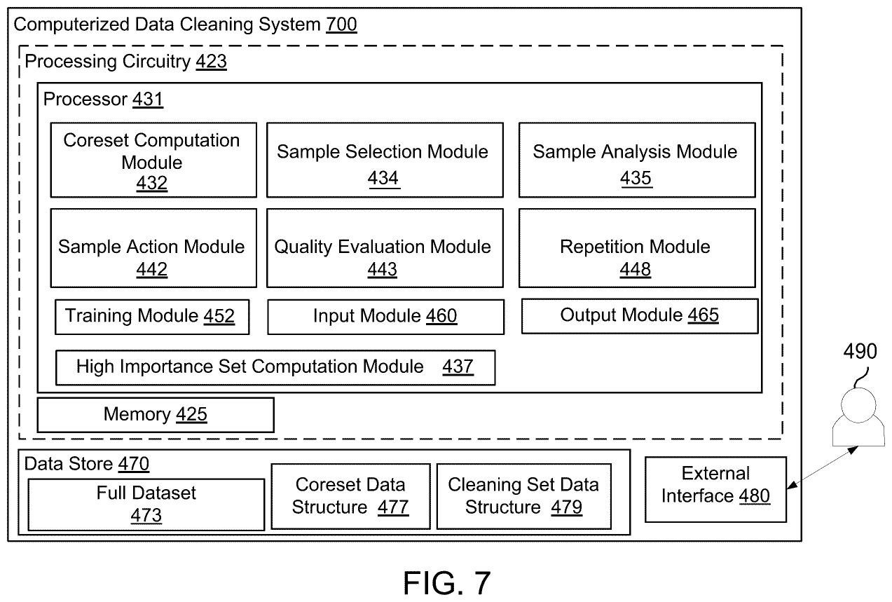

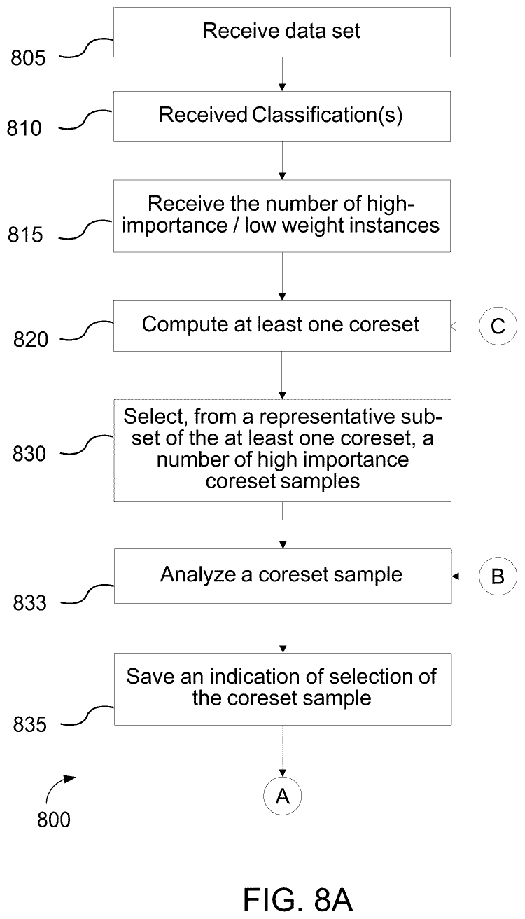

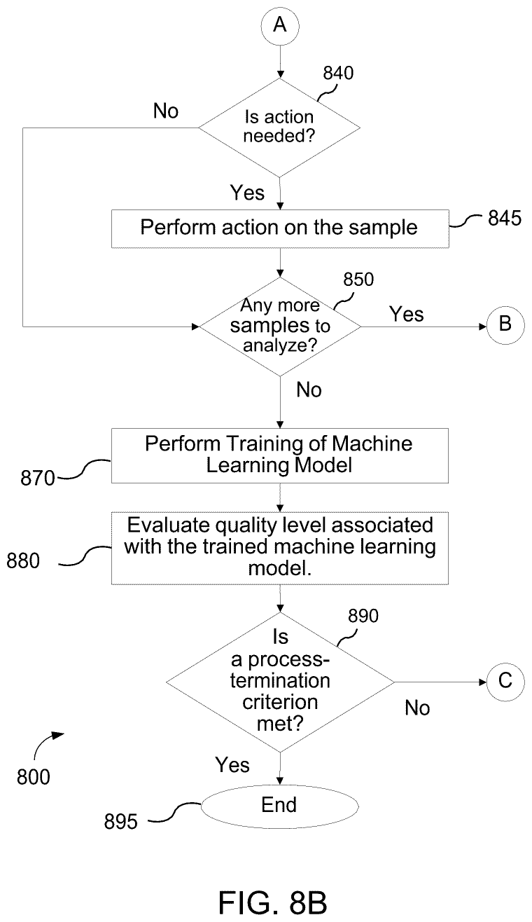

Various figures illustrate the concepts of this method. FIG. 2 illustrates the concept of a coreset. FIGS. 3-4 illustrate example data structures, and how they are created. FIG. 5A illustrates the concept of importance. FIGS. 5B-5C provide illustrative examples of labeled data instances. The concept of cleaning datasets using coresets is detailed with reference to FIG. 6. FIG. 7 provides a schematic diagram of systems configured for performing the method of the presently disclosed subject matter. FIGS. 8A-8B disclose an example flow chart of the method. FIGS. 9-10 illustrate example advantages of the presently disclosed subject matter over the prior art. Disclosure with reference to these figures is presented further herein.

In addition, it can be important to verify or check the quality of the trained machine learning model, for example by testing its ability to predict correctly specific data instances. However, if all of the data points 100 are used for the training, to the construct the model, there are no remaining points with which to perform the validation. Note that data instances which were used to build the model should not be used to verify the model, since the model has already accounted for them during the training process. There is thus, in machine learning, a “generalization problem”—that is, verifying the ability to predict correctly data that has NOT already been seen during the model training/construction process.

One way to achieve this is to set aside a portion of the data for verification purposes. For example, 80% of the data instances are allocated to a training set, and are used to train the machine learning model, and the remaining 20% are allocated to a testing set, to be used for testing/verification of the trained model. However, this has at least the disadvantage of missing e.g. certain end cases when verifying the model. Consider that a certain point, representing an important or otherwise interesting case (e.g. a bear that looks like a dog, in a model for image classification) was used in the training process, but no such case appears in the testing set. The model will not be able to be tested to see if it correctly predicts the “bear that looks like a dog” case, since no such data instance is available for testing. Conversely, if “bear that looks like a dog” appears ONLY in the testing data set, then the model will be expected to predict such a case, although the training did not consider such a data instance.

At least to address such concerns, a cross-validation technique is often used. For example, the data set 100 is divided into ten (10) groups or sub-sets of data instances, e.g. of similar size. Training is initially done on e.g. groups 1-9, and testing is done on group 10. The testing verifies that the chosen features and hyperparameters of the model training give good results. Then the training is performed on e.g. groups 1-8 and 10, and testing is done on group 9. And so on, in ten permutations.

In the above example of ten groups, after 10 tests are performed, the metrics are checked. If they are sufficiently good, per known per set methods, it can be said that the trained model and its hyper parameters are acceptable.

What should be done next, ideally and to provide a rigorous training, is to then retrain the model, with the now validated hyperparameters, and to do the retraining on all of the data set 100. Example parameters of the algorithm include a regularization terms and number of iterations). However, there can be hundreds, thousands, or more, possibilities for types of models and parameters to use when training. The data scientist might not know which combination(s) is the best, unless they are all tested empirically. Note that this may require a large number of resources, and time allocated, for training and testing.

Even if cross-validation is performed without then repeating the training on the entire data set 100, there can in some cases be high cost and resource use. In one real example, the training of the model using 90% of the data took 5 days. Thus, to cross-validate such a model across all 10 groups, 50 days of training would be required. (Note that in many examples, the inference test for validation is quicker than the training process itself.)

Similarly, there is an extreme case of cross-validation technique—“leave one out”. In such a case, for n data instance in the data set, training is performed n times, each using n−1 data instances. The resource and time requirements of such a method are evident.

At least to address such technical problems and disadvantages, there is disclosed herein a computerized method of training a machine learning model, as well as a machine learning system 1800 and software products to perform such a method. The method comprises, in some examples, the following:
(a) providing a data set 100, which is configured for training of a machine learning model 1875. The data set comprising a plurality of data instances 140, 148, 420;
(b) providing a coreset tree 1300, which is computed from the data set. The coreset tree comprises a plurality of coresets C11, C12, C21;
(c) detaching, from the coreset tree, at least one branch C24, C17, C18 of the coreset tree. Each branch comprises at least one coreset C24, which is representative of a portion 1515 of the data set. This detaching gives rise to a reduced coreset tree that is exclusive of the branch(es), and that comprises remaining coresets of the plurality of coresets;
(d) selecting, from the reduced coreset tree, at least one selected coreset that is representative of the remaining portion of the data set;
(e) training the machine learning model, utilizing the selected coreset(s). This gives rise to a trained machine learning model; and
(f) evaluating a model quality, associated with an ability of the trained machine learning model to perform prediction. The evaluation utilizes the detached branch(es).

In some examples, such a process can facilitate validation of the trained machine learning model.

In addition, as will be disclosed further herein, when training machine learning models, it is also often important to evaluate their ability to correctly predict specific data instances, especially edge cases. Consider, as an illustrative example, an algorithm controlling an autonomous vehicle which has been trained on street driving scenarios, which includes a machine learning model that was trained using pictures of cats, inter alia. This algorithm has been determined to work well, overall, in city driving conditions, and yields good quality metrics. However, when driven in the jungle, the vehicle sensor sees a lion, and the model classifies it as a cat, based on the training which included no images of lions. The algorithm instructs the vehicle to drive right past it, as a cat is no threat, but this may cause problems when driving right next to the lion instead of trying to steer clear of it. The image of a lion is thus an example edge case, and a full verification of the model requires that it also correctly predict such edge cases, and not only the “typical/common”, “average” cases. If, for example, the “lion” picture is part of the training data set, but it is withheld from the training process and not used in it, it can be possible to afterwards evaluate the trained model's ability to predict this “lion” case given the picture of the lion.

To remove data instance(s) such as an edge case(s), to re-train the model on all data exclusive of the edge case, to perform a prediction and to perform an evaluation of the prediction, and to repeat this process for each edge case, in some cases requires a large expenditure of resources, as will be detailed further herein.

At least to address such technical problems and disadvantages, there is also disclosed herein a computerized method of training a machine learning model, as well as a machine learning system 1800 and software products to perform such a method. The method comprises, in some examples, the following:
(a) providing a data set 100, configured for training of a machine learning model 1875. The data set comprises a plurality of data sub-sets 1515, 315, and each data sub-set comprises a plurality of data instances 140, 420, 310;
(b) providing a coreset tree 1400, which is computed from the data set 100, and comprises a plurality of coresets C1, C2, C3. Each leaf coreset C1, C5 of the coreset tree is based on a corresponding data sub-set 315, 619;
(c) removing at least one data instance x19 from at least one data sub-set 619. This thereby generates, from the data sub-set(s), one or more reduced data sub-sets 619′;
(d) recomputing at least one coreset C5, C6, C7, which is an ancestor of the reduced data sub-set 619′, to reflect the removal of the data instance(s) x19. This gives rise to a modified coreset tree;
(e) selecting, from the modified coreset tree, coreset(s) C3, C6′ that are representative of the data set exclusive of the removed data instance(s);
(f) training the machine learning model utilizing the selected coreset(s) C3, C6′, giving rise to a trained machine learning model;
(g) performing at least one prediction for the removed data instance(s) x19, utilizing the trained machine learning model; and
(h) evaluating one or more model predictability metrics, associated with the prediction(s). The metric is indicative of an ability of the trained learning model to correctly predict the removed data instance(s) x19.

The method disclosed herein can, in at least some cases, reduce the time required for data scientists to train and evaluate machine learning models 1875. The coreset methodology is used to significantly reduce the size of the dataset, while maintaining the statistical properties and outliers of the full dataset 100.

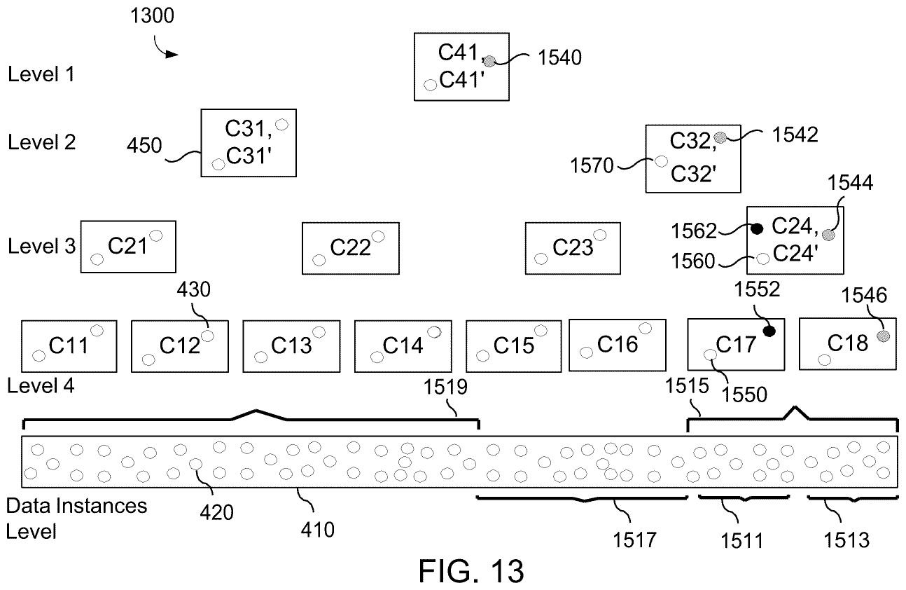

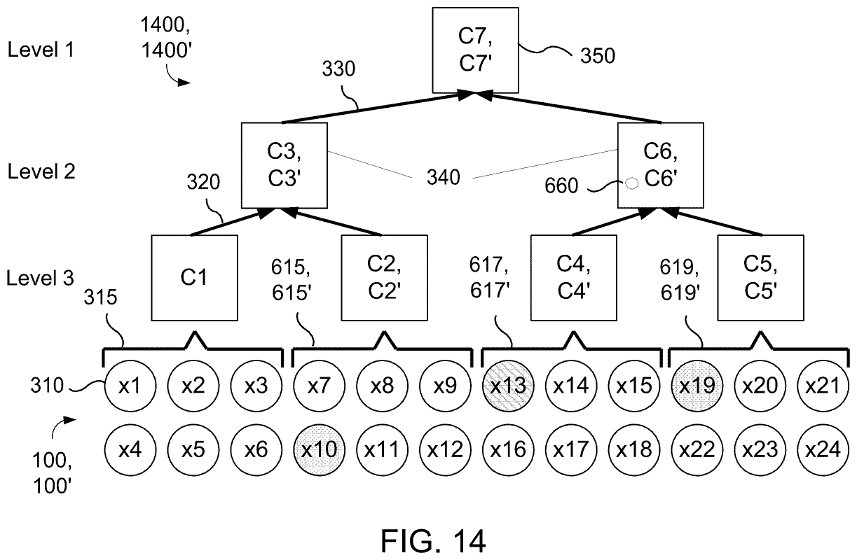

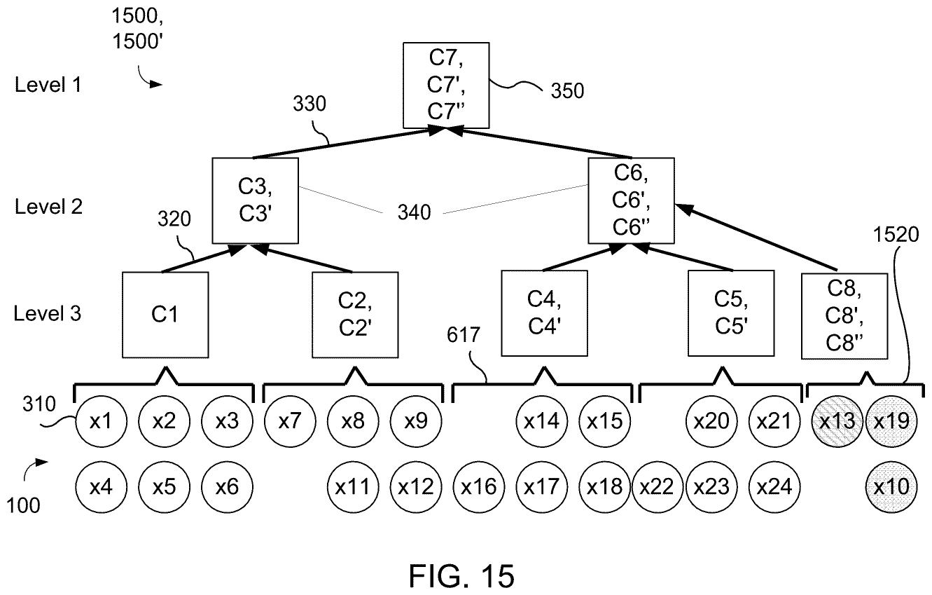

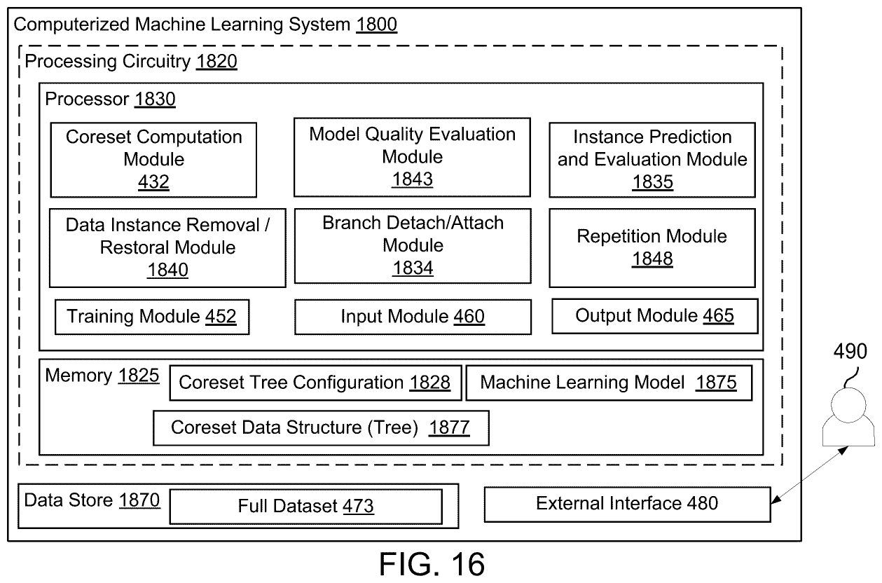

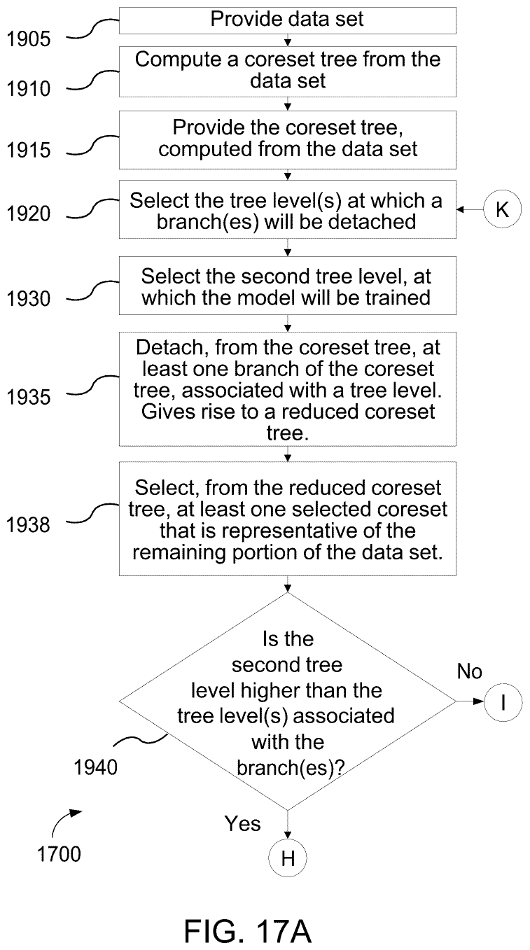

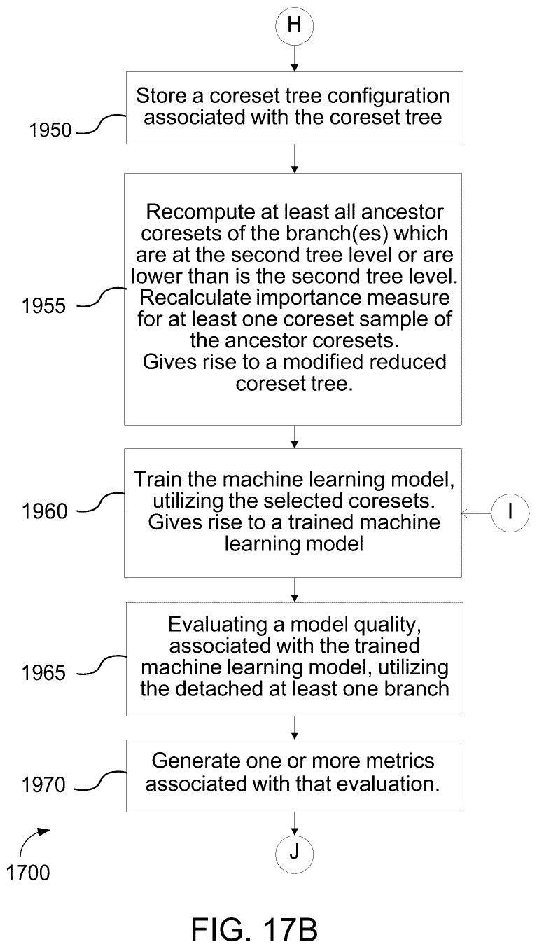

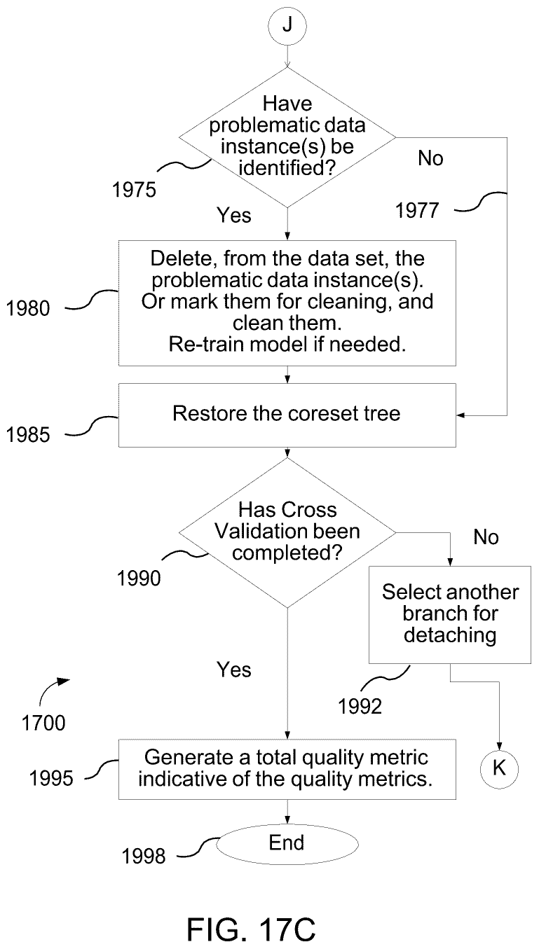

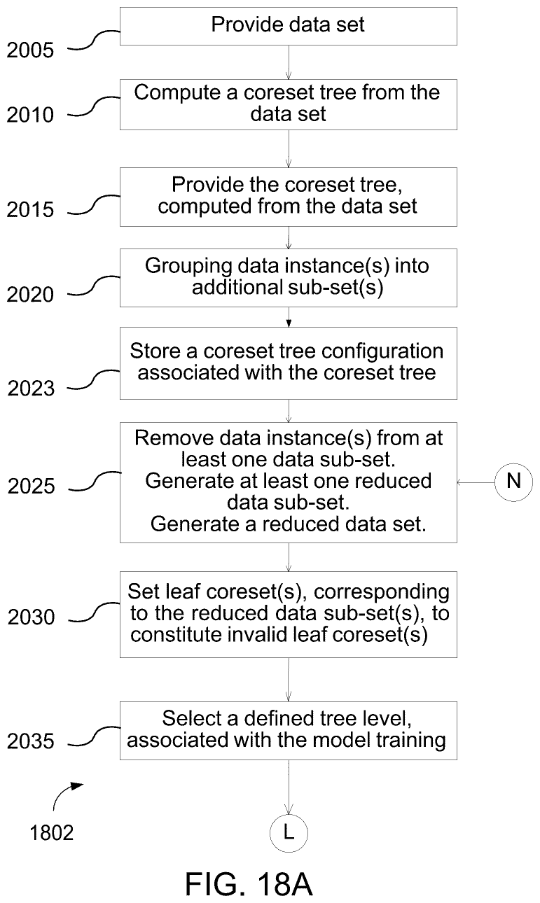

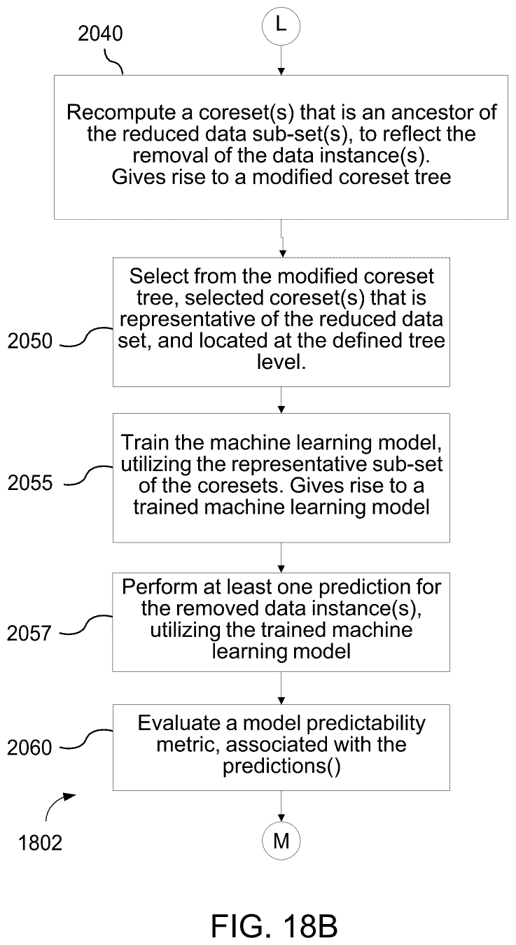

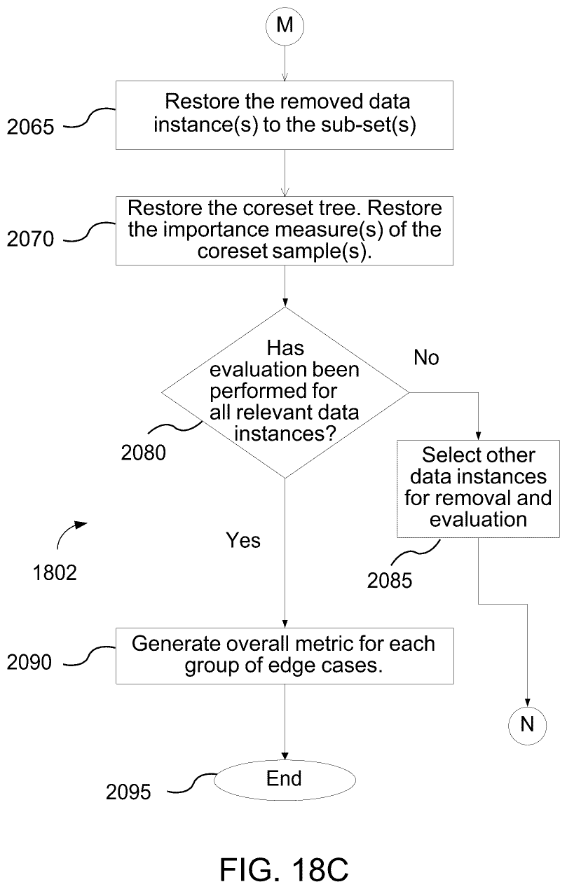

Various figures illustrate the concepts of the above-disclosed methods. Again, FIG. 2 illustrates the concept of a coreset, and FIGS. 3-4 illustrate the example data structure of a coreset tree, and how they are created. FIG. 13 illustrates cross-validation using a coreset tree. FIG. 14 illustrates data instance validation, e.g. edge case validation, using a coreset tree. FIG. 15 illustrate a special case of data instance validation using a coreset tree. FIG. 16 provides a schematic diagram of systems configured for performing the method of the presently disclosed subject matter. FIGS. 17A-17C disclose an example flow chart of a method for cross-validation using a coreset tree. FIGS. 18A-18C disclose an example flow chart of a method for data instance validation, e.g. edge case validation, using a coreset tree.

Attention is now drawn to FIG. 2, schematically illustrating an example generalized view of a coreset, in accordance with some embodiments of the presently disclosed subject matter. View 200 depicts a conceptual view of an example coreset 200 based on data set 100.

Coresets are an optimization algorithm, originating in the field of computational geometry, used to approximate optimization problems. They are based on selecting a relatively small subset 200 of the larger original dataset 100. The subset 200 selected maintains the statistical properties and corner cases of the full dataset, such that an algorithm running on the coreset 200 will yield the same results as same algorithm running on the full dataset. Thus, for example, training a machine learning model on the coreset 200 will yield the same result as training it on the full dataset 100.

The coreset comprises a plurality of coreset samples 243, 245, 247, 246, 248, 250, 254. The view is presented to illustrate several concepts related to coresets. Each coreset sample is one of the data instances in the full dataset 100. For example, coreset sample 248 is data instance 148 of FIG. 1. The coreset samples are referred to herein also as coreset instances.

It can be seen in the figure that coreset 200, being a subset, has many fewer data instances/points than does the full dataset 100. The coreset 200 is thus a reduced dataset 100. However, the collection of data instances in coreset 200 has the same statistical properties as does dataset 100. For example, the center of mass of each class, and the covariance matrix of each class, are the same for the coreset 200 as for the dataset 100. These values are not depicted in the figure, for ease of exposition. As indicated above, the coreset maintains the outliers/corner cases 261 of the full dataset, as well as the same statistical properties. Therefore, training a machine learning model using the coresets 200 will yield the same result as training it on the full dataset 100, while doing so typically using a smaller training set 200 than the full training set 100.

When computing a coreset, an importance value is calculated for, and is assigned to, each coreset sample 248 in the coreset. The importance values provides an indication how important that sample is to the final machine learning model, that is it is a measure of how much the sample is impacting the model.

After the calculations, the data instances of dataset 100 are selected, e.g. randomly, to be included in the coreset 200, that is in the subset 200 of dataset 100. In some non-limiting examples, the selection is performed randomly, e.g. based on weight—that is samples with higher weight are more likely to be selected.

Statistically, the high-importance data instances have relatively higher probability or likelihood to be included in the coreset, as compared to low-importance data instances. Every sample is weighted at least based on its occurrence in the full dataset.

This phenomenon is shown in the figure in the relative size of the points representing the coreset samples. For example, consider points labeled as “dog”, points 243, 245 and 247 are of different sizes, representing different importance values. Similarly, looking at “cat” coreset samples, sample 249 has higher importance than sample 248, for example, illustrated by the larger-size X.

In some literature, the term “importance” is referred to as “sensitivity”. There is another parameter, weight, which is a function of importance/sensitivity, and which thus can be used in place of importance. For simplicity of exposition, the importance/sensitivity, and the weight, are referred to herein collectively also by the more general term “importance measure”. Note that, as indicated above, weight is also based on the frequency of the occurrence of the sample in the full dataset.

Data instances with higher importance will have a relatively higher probability of being in the coreset 200, as compared to data instance with relatively lower importance.

Similar to that disclosed with reference to FIG. 1, the triangles in FIG. 2 illustrate some of the coreset samples which are ambiguous and/or are problematic, e.g. incorrectly labeled. Statistically, coreset samples which are problematic, i.e. problematic instances, tend to have larger importance values, e.g. as illustrated by points 250 and 254. In many cases, a relatively high importance value can be correlated with an incorrect label, or with another data issue that may require attention of the data scientist. Thus, outlier points 160 have a relatively high chance of being selected to be coreset samples 261 in the coreset 200, but with low weight. By contrast, individual data instances 147 that are not outliers have lower probability of being selected. However, since there are a comparatively large number of data instances similar to it, in aggregate such an instance is likely to be selected, with a comparatively high importance.

Statistically, there will be larger values of importance near the center of the graph, where there is greater ambiguity as to the correct class/label.

As will be disclosed further herein, in some of the methods of the currently disclosed subject matter, the importance/sensitivity parameter, or the weight parameter, that is the importance measure, will be used to decide which data instances should be cleaned. Since, as disclosed further herein, high importance data instances tend to more highly interfere with the machine learning models, it is advantageous to give more cleaning and correction attention to those data instances.

Attention is now drawn to FIG. 3, schematically illustrating an example generalized view of a coreset data structure, in accordance with some embodiments of the presently disclosed subject matter. View 300 depicts a conceptual view of an example coreset data structure 300. In some examples, a plurality of coresets are comprised in a coreset data structure. In some examples, the coreset data structure comprises a coreset tree 300, as shown in the figure. The figure illustrates the more specific non-limiting example of a binary coreset tree 300.

In some examples of the presently disclosed subject matter, the coreset data structure having at least the following properties:
I. an ability to add a coreset instance 248 (of FIG. 2), i.e. a coreset sample, to each coreset C2;
II. an ability to delete a coreset instance 248 from each coreset C2, and thus from the coreset data structure;
III. an ability to modify a coreset instance/sample, for example to the change the label/classification of a coreset sample 248; and
IV. an ability to find a coreset instance 248 within the coreset data structure 300.

The coreset tree 300, for example, has these properties. Other data structures are also possible.

In some examples, the coreset data structure 300 further has at least the following property:
V. an ability to update the data structure with Log-N time complexity, or with better than in Log-N time complexity, where N is the number of data instances 420 in the coreset tree.

As will be disclosed further herein, such a structure has the example technical advantage of being able to make the process faster. Note also that the example structure of a coreset tree 300 possesses this property. For a binary tree, the complexity is Log N in base 2.

When building a coreset tree 300, the dataset 100 is split into batches 315 of data instances 310, and a coreset C1, C2, C4, C5 is computed separately for each batch. Then a new coreset is computed from every group of coresets, e.g. from every pair of coresets. In the example of the figure, C3 is computed 320 from C1 and C2, and C6 is computed from C4 and C5. This process continues, until computing 330 the root 350 of the tree, that is coreset C7. Thus, the tree is built in an iterative fashion.

The root C7 can be considered a minimal subset of the data set 100. Each coreset C1, C2, C6 etc. is a node of the coreset tree. C3 and C6 are examples of coresets which are on the same level 340 of the coreset tree 300.

Recall that coresets have a feature, that when computing a coreset C3 of a coreset C1, the resulting coreset is also a coreset of the underlying data. Thus, in the figure, C3 is a figure of C1 and C2, but C3 is also a corset of the underlying data x1-x12. Similarly, C7 is a coreset of the full dataset 100.

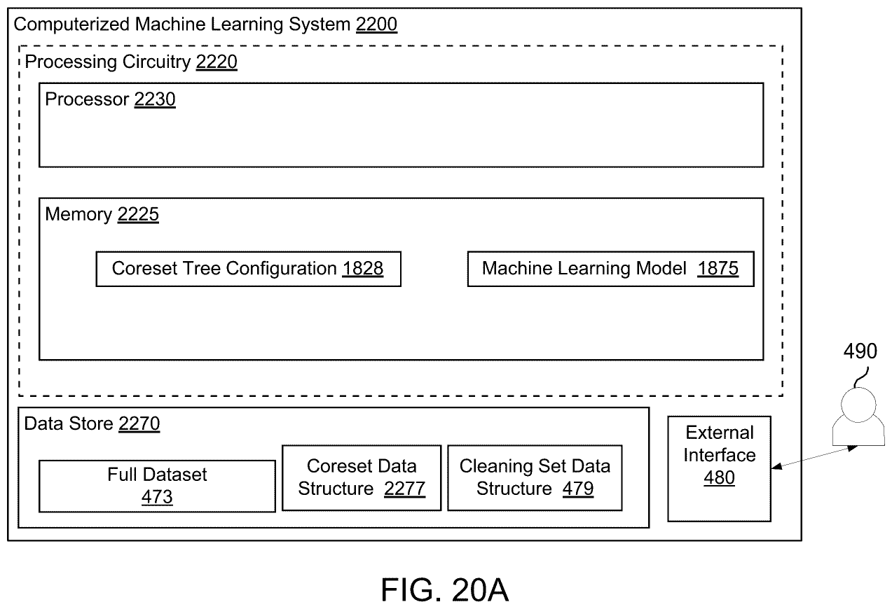

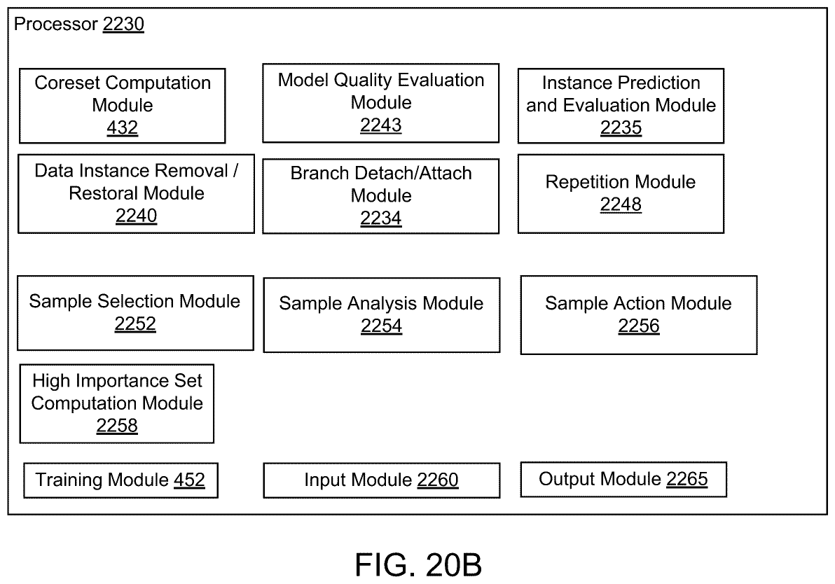

Thus, in the example, instead of using the full dataset, it is possible to train a machine learning (ML) model 1875 using the combination of the coresets C1, C2, C4, C5, or using the combination of the coresets C3, C6, or using the single root coreset C7. (Note that, purely for ease of exposition, ML model 1875 is not shown in the corresponding architecture FIG. 7, although it is shown explicitly in architecture FIGS. 16 and 20.) Thus, certain coresets within the data structure 300 are insufficient to enable training a model which corresponds to the entire data set 100. For example, C3 cannot be used to train a ML model which is based on the full data set x1-x24, as it does not represent statistically the entire data set. However, C3 can be used to train a ML model which is based on the data sub-set x1-x12. For example, consider a case in which the data instances 310 are time series, e.g. data gathered over multiple days. Instances x1-x6 and x7-x12 in this example represent data gathered over each of the first twelve days. Coreset C3 thus represents these first twelve days, and it can be used to train a model corresponding to those first twelve days.

In the example of the figure, C1 is a coreset of data instances x1-x6 of the full dataset 100, and thus has fewer than the six points of that batch x1-x6. C2 is a coreset of data instances x7-x12, and so on. In this non-limiting example, the 24 data instances in dataset 100 are grouped into 4 batches 315 of six data instances 310 each. In other examples, the number of data instances in each such batch is not identical across all batches 315.

In the example, there are three levels 340 in the coreset tree 300. In other examples, there is a different number of levels in a coreset tree 300.

Note that in other examples, the data structure can be a single coreset. The presently disclosed subject matter is relevant also for a single coreset 200.

Attention is now drawn to FIG. 4, schematically illustrating an example generalized view of building a coreset data structure 300, 400, in accordance with some embodiments of the presently disclosed subject matter. View 400 illustrates conceptually the construction of an example coreset data structure 300. In the example of this figure, there are four levels to the coreset tree 400, 300.

In the example of the figure, the full dataset 100, 410 comprises 160,000 data instances 420, 310, 148. Eight lowest-level (“leaf”) coresets C11-C18 are computed, each comprising 2,000 coreset samples/instances, where each such coreset C1x is computed from a separate batch of 20,000, data instances 420. Thus, in each such coreset, 2,000 samples 430, 440 represent 20,000 data instances of the full set 410.

Note that this example quantity of 2,000 is non-limiting. In other examples, the number is not identical in the resulting computed coresets. For example, certain data instances can be sampled more than once. Such a multiply sampled point 420 will appear in the coreset only once, but it will have a higher weight due to the multiple samples of that point. In such an example, it might be that C11 has 2000 points, C12 has 1803 points, C13 has 1890 points etc.

In the example, each coreset C2x, of the second lowest level of the tree, is computed from two lower level coresets. For example, C23 is computed from C15 and C16. Each coreset C2x has 2,000 coreset samples 440, in the example. At the next highest level, C31 and C32 also have 2,000 coreset samples each, as does root note C41. These numbers are for illustrative purposes only, and they are non-limiting.

Attention is now drawn to FIG. 5A, schematically illustrating an example generalized view of importance probability densities 500, in accordance with some embodiments of the presently disclosed subject matter. Graph 500 illustrates conceptually the relationship between the importance/sensitivity value and the quality of data instances 147, 150 of a dataset 100.

The figure depicts example histograms for two types of data—“clean” data (correctly labeled, and without problems) which represents data instances 148 that are not mislabeled and do not have other problems, and “noisy” data, which represents data instances 155 that are mislabeled or have other problems or issues. More generally, a point with issues is one that the trained model cannot “explain” in a straightforward fashion, e.g. outliers. The x-axis 510 represents the importance or sensitivity value. The y-axis 515 represents the probability density of that importance or sensitivity value appearing in data instances of the particular type of data. As the figure illustrates, at a statistical level, data without problems will tend to have lower importance (or conversely, higher weights) than data that has problems/errors or is “noisy”. In histogram 520 for clean data, the average importance value 525 is roughly 0.025. In histogram 530 for problem or noisy data, the average probability value 535 is higher, roughly 0.037. Also, the example histogram 530 has a higher skew 560 of data, showing substantial “tails” 563, 565, 568 of high outlier values of importance.

Recall that there is a technical challenge to efficiently identify the most problematic data instances 160, 410, which will benefit most from analysis by a data scientist, and by cleaning if relevant. Based on this example histogram, it can be seen that the noisy data items will, on a statistical basis, tend to be those with high importance/sensitivity (or low weight), that is (in the example of the figure) to have importance values of e.g. 10 or more. Thus, the importance value (or, conversely, the weight value) can be used to separate clean and noisy data, and to identify data instances 155, 160 with relatively high probability to be problematic and in need of cleaning. Reviewing the data instances 160 with the highest importance, or with relatively high importance, will tend to uncover many errors. Thus, cleaning/correction of high importance data instances will tend to contribute in a disproportionate manner to improving the quality of the ML training data.

Note that the numerical values of importance shown in the figure are merely exemplary.

As will be disclosed further herein with reference to FIGS. 6 and 8, the use of coresets will increase the efficiency in the search for problematic data instances 155, 160 that are in need of cleaning. This is because coresets tend, statistically, to contain data instances of relatively high importance/sensitivity, and because of the correlation (illustrated in FIG. 5A) between high importance and noisy/problematic data. As will be shown, the importance property of coresets can be utilized to “find the needle in the haystack”, to efficiently find problematic data instances. (The same is true, mutatis mutandis, of the other importance measure, that is “weight”.) Due to the coresets attributes, the anomalies, mislabels etc. will tend to occur more frequently in the coreset than their original distribution in dataset 110. This can facilitate detection of the problem/anomalous data in a relatively easier manner. Once those instances/samples are investigated and addressed, it can be possible to achieve a high-quality model, with only a small number of iterations, e.g. as disclosed further herein with reference to FIGS. 9-10.

Attention is now drawn to FIG. 5B, schematically illustrating an example generalized view 550 of a data set 100, in accordance with some embodiments of the presently disclosed subject matter. View 550 depicts a simplified example data set 100. The example data set comprises a number of data instances. Each data instance comprises an image 560, along with associated metadata 575. The example metadata are item IDs, importance values and labels 570.

Note that in other examples, weight values are used instead of importance values.

For ease of exposition, the actual images are not shown. The images 560 are represented schematically, in the figure, by text such as “<another picture of a dog>”. This true also in FIG. 5C.

In the example, there is a desire to address the issue of incorrectly labeled data, by detecting incorrectly labeled images. Note that items 6789 and 5678 are incorrectly labeled—a picture of a cat is classified as “dog”, while a picture of a dog is classified as “cat”. As indicated with reference to FIG. 5A, such problematic data instances have a relatively high probability of having a relatively high importance. This is reflected in the figure by data item 6789 having an importance value of 90, and data instance 5678 having an importance value of 80—which in the figure are relatively high values. By being mislabeled, the data instance 6789 is very different from other samples in the same class “dog”, and the data instance 5678 is very different from other samples in the same class “cat”.

Attention is now drawn to FIG. 5C, schematically illustrating an example generalized view 580 of a data set 100, in accordance with some embodiments of the presently disclosed subject matter. View 580 depicts a different simplified example data set 100. The example data set comprises a number of data instances. Each data instance comprises an image 585, along with associated metadata 595. The example metadata are item IDs, importance values and labels 590.

This figure provides another example of high importance data, one associated with data quality. Data item 5432 has a relatively high importance value of 70. This is because the corresponding image is very different from all the other images of class “cow”. Most pictures 9876, 6543 of cows are taken outdoors. It is unusual to have an indoor picture of a cow, such as appears in image 5432. Such an image is thus unexpected, and it is thus harder for the machine learning model to identify and to correctly classify. The image of the cow indoors is thus relatively important input data, providing training information which typically cannot be obtained from other images of a cow. Thus, this image has high importance, and is high quality data, of high value for constructing the model.

Note that the numerical values of importance shown in FIGS. 5B and 5C are merely exemplary.

Attention is now drawn to FIG. 6, schematically illustrating an example generalized view 600 of cleaning a data set 100, in accordance with some embodiments presently disclosed subject matter. View 600 depicts a different simplified example of how a data set 100 can be cleaned. The example utilizes the example implementation of coresets comprised in a coreset data structure, specifically in the coreset tree of FIG. 4.

The method disclosed herein attempts to find instances containing errors, or other problematic data instances 155, using coresets—specifically using the sensitivity/importance a property of coresets, or alternately using the weights property.

In some examples, the method involves at least the steps of:
A. selecting, from the coreset(s), at least one selected coreset that is representative of the data set. The selected coreset(s) constitute a representative sub-set of the coresets; and
B. selecting/retrieving a number of coreset samples, based on at least one importance-related criterion. The importance-related criteria are indicative of corresponding importance measures of the at least one selected coreset having at least one of high importance values and low weight values. For example, retrieving a number “n” of coreset samples of high importance (or of low weight).
This gives rise to a set of selected coreset samples having a high probability of at least one of high importance values and low weight values, as compared to a second probability associated with selecting a corresponding number of data instances from the data set. This was disclosed, for example, with reference to FIG. 5A;
C. updating or otherwise cleaning relevant selected samples, and recalculating coresets in the path; and
D. training the machine learning model using cleaned data.

In some examples, utilizing a coreset tree 600, 400, the following process is used:
i. create a coreset tree 600 from the original dataset 410, 100;
ii. select e.g. the particular level 340 (see e.g. FIG. 3) of the coreset tree;
iii. select the n samples from e.g. that particular level 340 of the coreset tree. In some examples, the selection is from the top level 350 (see e.g. FIG. 3), that is the root C41;
iv. have a domain expert, e.g. a data scientist, review, and analyze, the selected samples, validate or clean, or otherwise perform an action, as needed, e.g. fix the labels 570, 590 as needed;
v. optionally, update the coreset tree based on the cleaning, e.g. based on the corrected labels;
vi. train and compute a model using either the coreset tree, a relevant part of it or the entire dataset 410 itself.

In some examples, the process further comprises:
vii. optionally, evaluating the model quality associated with the computed model, e.g. using a k-fold or a simple train/test method.

In some examples, the process further comprises:
viii. repeat steps (i)-(vi), each time selecting new samples, until one or more process-termination criteria are met.

Non-limiting examples of a process-termination criterion include one or more the following:
(a) a defined number of repetitions have been performed; and
(b) an improvement of the quality level of the trained model, over at least one previous iteration, is below a defined improvement level. That is, the model quality has reached a plateau;
(c) the difference in the number, or percentage, of errors or problems found in the current iteration, as compared to in at least one previous iteration, is below a defined error level. Again, the model quality has reached a plateau.

One example of the quality level is Area Under the Curve (AUC). More disclosure of such an example is presented further herein with reference to FIGS. 9-10.

The discussion herein will address selection of high importance coreset samples 249, 254. However, the same process can be performed while selecting low weight coreset samples.

Considering the figure, a number of high importance coreset samples 249, 254 are selected from the coreset tree 300, 400, 600. In some examples, a defined number n of such coreset samples are chosen, e.g. 500 or 1000 samples. In other implementations, the number selected is not strictly defined. Thus, the query could instead be to select a random number, between e.g. 480 and 520, of coreset samples 430.

The selection of the number of samples is made from a representative sub-set of the coresets, that is the selected coreset(s). For example, the process can select from all coresets at a same tree level 340 of the coreset tree, e.g. from C31 and C32, or from C11 through C18.

In one example, the representative sub-set comprises one coreset. In the example of the figure, such a coreset is the root coreset C41 of the tree 600. Since the coreset C41 is in fact a coreset of the full dataset 410, and represents the full dataset, the root node is a representative coreset of the full coreset tree 600.

Thus, not all of the levels of the tree need to be searched, in order to find high importance coreset samples for analysis. In some examples, only the top “m” levels of the tree need to be accessed, where m is determined based on the particular requirements of the application for accuracy vs use of time and resources. The case of m=1, that is search of the root C41 only, is common.

In some examples, it does not matter in which coreset a particular data instance is selected, that is whether instance 410 is selected as sample 544 in C22, as sample 546 in C14 etc.

In still another example, the selected representative sub-set comprises all of the coresets of the coreset data structure 600. In such a case, it can be that the same data instance 420, appearing at all levels of the tree, as coreset samples 546, 544, 542 and 540, is selected for analysis and cleaning. Thus, the process can look for the highest importance coreset sample in the entire coreset tree, wherever in the tree it may appear, without limiting the search to a particular level of the tree.

The importance-related criteria, used for the selection of the samples, can vary. Recall that the importance-related criteria are indicative of corresponding importance measures of the selected coreset(s) having at least one of high importance values and low weight values.

In some examples, the selecting of the number of high importance coreset samples comprises one of the following:
selecting coreset samples of highest importance, e.g. the 500 samples with highest importance values;
selecting coreset samples of importance above a defined importance value, e.g. select 500 samples with importance value above 60; and
selecting the entire representative sub-set.

In this last implementation, the entire representative sub-set is chosen, e.g. the entire root coreset C41, or the entire coresets C31 and C32 of a particular core tree level 340. The entire coreset(s) will be analyzed for possible cleaning. By virtue of coresets containing relatively high importance samples, on a statistical basis, the very selection of all samples of a coreset, rather than randomly searching for data instances in full dataset 110, 410, will tend to uncover at least a relatively high percentage of the problematic instances which warrant the attention of the data scientist.

Similar to the above, in a case where the process selects a number of low weight coreset samples, the selection can comprise one of the following:
selecting coreset samples of lowest weight;
selecting coreset samples of weight below a defined weight value; and
selecting the entire representative sub-set.

In another example, the query is “do NOT select the top 10 coreset samples, that is the 10 samples with highest importance. Instead, select the 90 samples with next highest importance, just below the top 10 samples”. This query will miss the samples of highest importance, but it will still retrieve samples having levels of importance that are relatively high, as compared to those of the remaining samples of the coreset(s).

The above are non-limiting examples. There are multiple ways to search for high importance/low weight coreset samples.

An example technical advantage of the method of this figure is as follows. Due to the attributes of coresets, the anomalies, mislabels etc. will occur much more frequently in the coreset than their original distribution in the full dataset 100, 410. The coresets have a relatively higher concentration of high importance (low weight) data instances than does the data set 100, as disclosed herein e.g. with reference to FIG. 2. In turn, the high importance (low weight) instances have a relatively higher probability of being outlier, mislabeled, erroneous, problematic or otherwise anomalous instances, as compared to lower importance (higher weight) data instances—as disclosed herein e.g. with reference to FIG. 5A.

This thus highlights data instances 544, 430 that are possibly anomalous, or more generally have data-related issues, and are worth investigation by the data scientist/domain expert—in a more efficient manner, as compared to performing a random search of instances in the dataset 100. That is, reviewing the instances with the highest importance will uncover relatively many errors and other issues, with a relatively smaller effort. The high importance data instances will statistically tend to be the most critically anomalous, e.g. the most critical labeling errors, with greatest impact on the accurate training of the ML model. The use of the coresets will more efficiently surface these high importance instances.

Once the data is cleaned, e.g. the labels are fixed, training can be performed using the cleaner data. Thus, this method can facilitate achieving a high-quality model with a relatively small number of iterations, e.g. as disclosed herein with reference to FIGS. 9-10. In some cases, a more accurate model is achieved, compared to a method in which data instances are searched within the full dataset 410.

In some examples, the selection of the number of high-importance coreset samples, and the selection of the number of low-weight coreset samples, as well as the investigation and the action/cleaning, are performed for all classes comprised in the plurality 410 of data instances 420. For example, the selection query can be “retrieve the 500 highest-importance coreset samples with label ‘dog’, and also retrieve the 500 highest-importance samples labeled ‘cat’. Similarly, the query can be, in some implementations, “retrieve the 500 highest-importance coreset samples, irrespective of label value,”, that is irrespective of class, irrespective of whether the samples are labeled “dog” or “cat”.

In still other example implementations, the selection of the number of high-importance coreset samples, and the selection of the number of low-weight coreset samples, are performed for a particular class of interest comprised in the plurality of data instances, that is for a particular label value. Thus, for instance, the query can be “retrieve the 500 highest-importance coreset samples, only with label ‘dog’”.

Turning now to the analysis of the selected coreset samples 544, for each such selected coreset, the method comprises performing the following:
(a) determining whether the each coreset sample requires an action; and
(b) in response to a determination that the each coreset sample requires the action, performing the action.

The method thus generates an increased-quality representative sub-set of coresets, as compared to the original quality of the representative sub-set, that is the quality before performance of the method. That is, the searched coreset C41, and/or coresets C31 and C32 etc., are of higher quality than they were prior to the action. For example, it has fewer mislabeled coreset samples 254, and/or some problematic data has been deleted.

An example of an action is a cleaning action, cleaning the relevant data item (i.e. coreset sample 544 and/or data instance 420 of the full data set 410).

In some non-limiting examples, the action performed comprises at least one of the following:
a. correcting or otherwise updating the sample label 570, 590 associated with the relevant coreset sample, that is correcting or fixing the classification label;
b. deleting the relevant coreset sample;
c. creating of a new class, and assigning a new label, associated with the new class to the relevant coreset sample. For example, an image of a tiger is found to be incorrectly labelled as “cat”. In some examples, instead of deleting the sample with the tiger, a new class “tiger” is created, and the image is assigned the label “tiger”, in place of the incorrect “cat”;
d. adding additional coreset samples to the representative sub-set; and
e. adding additional data instances to the data set 110.

The action can be performed in various portions of the data, based on the specific implementation. In some examples, the action is performed in the relevant coreset sample 542 within the representative sub-set in which the search was performed. Thus, if the search query was performed in the second highest level 340 of the core tree, i.e. in coresets C31 and C32, and the found high-importance coreset sample is 542, coreset sample 542 is cleaned (or the other action is performed on it).

In some examples, the action is performed in all coresets, that comprise the relevant coreset sample. Considering the above illustrative example, the action is performed also in one or more corresponding coreset samples 540, 544, 546 comprised in other coresets C41, C22, C14. In some such examples, the action is performed in all of coreset samples 540, 542, 544, 546, which are the same data instance appearing in all levels of the tree. Thus, it can be that the label “cat” is corrected to “dog” in each of the relevant coreset samples 540, 542, 544, 546. For example, the entire coreset tree is updated based on the corrected labels, after analysis of the selected coreset samples.

In some examples, the cleaning or other action is performed in a respective data instance 410 of the full dataset 110. Considering the above illustrative example, the action is performed in data instance 420, which was selected to be coreset samples 540, 542, 544, 546. In some such implementations, the action is performed in coreset samples 540, 542, 544, 546, as well as in data instance 420.

In some cases, the determination that correction of a coreset sample 542 is needed, and the cleaning/correction/other action for that data item, is performed manually by an expert in the domain.

It should be noted that the importance value of a particular instance, which is the result of a calculation, may be different, depending on particular coreset in which the particular sample appears. As one example, it could be that coreset sample 546 in low-level coreset C14, has an importance value of 60, while in C22, the coreset of the coreset C41, the corresponding coreset sample 544 has importance value 73.

In some examples, the performance of the action comprises also updating the relevant importance measure, e.g. updating the importance/sensitivity value, and/or the weight value if relevant, for the relevant coreset samples. In some examples, such an update maintains the statistical validity of the coreset(s), since the action (e.g. correction of a label) can possibly impact the importance of the sample to the model. As one example, once the label is corrected in a coreset sample, it no longer has the same impact on the model, and thus its importance may change.

In some examples, in which multiple iterations of the process are performed, the next iteration will involve recomputing the coreset from the underlying data, that is from dataset 110. In such examples, new data instances 410 are selected, and importance/weight are recalculated. The recomputed coresets may more accurately maintain the statistical properties and corner cases of the full dataset 110, since the actions may change properties of data instances 420 and of coreset samples 542, 544.

In other examples, new coresets are computed for only a sub-set of the coresets, that is for some coresets but not for all of them. This sub-set which receives a new computation is referred to herein also as a second sub-set, to distinguish it from the selected representative sub-set (which can be referred to herein as the first sub-set.)

In still other examples, there may not be an updating of the importance value etc., and/or coreset(s) will not be recomputed, whether once or for each iteration of the process. Such an approach, while losing some of the theoretical statistical rigor of the coresets, may save considerable computation/calculation resources/effort and time, while in practice not seriously affecting the value of the data cleaning performed in the method of FIGS. 6 and 8. That is, the cleaning will be “good enough” for training the model accurately and efficiently, without needing these additional computations. In other such examples, only some new data instances will be re-sampled for the coreset, but a full re-sample will not be performed.

One example criterion for whether or not a particular core set in the data structure should be re-computed, is that the total importance, i.e. the sum of the samples' importance, has changed by e.g. a certain amount.

As indicated above, in some examples the training of the machine learning model is performed, based on the cleaned data. In some examples, the training is performed utilizing the cleaned data set 110, comprising the cleaned data instances 420. In other examples, the training is performed using the selected representative sub-set. For example, the training can be performed utilizing all coresets at a same tree level 340 of the coreset tree, which have been cleaned, e.g. representative sub-set C31 and C32, which have been cleaned.

In still other examples, the cleaning action is performed in other level(s) of the coreset tree, e.g. coreset C41, and the training is performed on the coresets of these other level(s).

Note that training the model using one or more coresets is in some cases quicker than training using the entire dataset 110, since the coresets have a smaller amount of data.

In some examples, the model is trained using the root coreset C41. Note that in some examples, the fact that a particular data instance 420 appears in coresets at multiple levels of the tree, as coreset samples 546, 544, 542, 540—and in the example of the figure even in the root C41, can be statistically indicative of its comparatively high importance, as it was sampled time after time when building coresets from other coresets. Therefore, a sample such as 540, appearing in the root coreset C41, can be globally important, relatively speaking, compared to some other instances in full dataset 410. For at least this reason, there can be at least this technical advantage, of efficiently choosing samples of likely a relatively high impact on the model, particularly in selecting coreset samples from higher level coresets such as root coreset C41, and in analyzing those.

In some non-limiting examples, the training comprises supervised learning. This may be relevant, for example, in cases where the anomalies in the data are associated with incorrect labels. In other examples, the training comprises unsupervised learning.

More details on the method, including optional steps, are disclosed further herein with reference to FIG. 8.

Attention is now drawn to FIG. 7, schematically illustrating an example generalized schematic diagram 700 of a computerized data cleaning system 700, in accordance with some embodiments of the presently disclosed subject matter. In some non-limiting examples, computerized system 700 includes a computer. Attention is now drawn to FIG. 7, schematically illustrating an example generalized schematic diagram 700 of a computerized data cleaning system 700, in accordance with some embodiments of the presently disclosed subject matter. In some non-limiting examples, computerized system 700 includes a computer. It may, by way of non-limiting example, comprise a processing circuitry 423. This processing circuitry may comprise a processor 431 and a memory 425.

This processing circuitry 423 may be, in non-limiting examples, general-purpose computer(s) specially configured for the desired purpose by a computer program stored in a non-transitory computer-readable storage medium. They may be configured to execute several functional modules in accordance with computer-readable instructions. In other non-limiting examples, this processing circuitry 423 may be a computer(s) specially constructed for the desired purposes.

Example uses of these modules are disclosed further herein, with reference to the flowchart FIG. 8.

In some examples, computerized data cleaning system 700 comprises an external interface 480, enabling communications with external devices/systems 490, and or providing a user interface to a human user 490, e.g. a data scientist or other domain expert. An example, it can interface to data cleaning system 700, to receive selected coreset samples 544 or data instances 1140 for analysis. In some examples, this interface is used by user 490 or external system 490 to perform actions on analyzed coreset samples or data instances which need action, e.g. updating labels, deleting samples etc.

Note that, although the figure shows reference 490 as a human, it can in fact represent a human user or an external device/system of various types.

Turning now to processor 431 of processing circuitry 423, in some examples it comprises input module 460. In some examples, module 460 is configured to receive input from e.g. human user 490, e.g. using external interface 480.

In some examples processor 431 comprises output module 465. In some examples, module 460 is configured to provide output to e.g. human user 490, e.g. using external interface 480.

In some examples processor 431 comprises coreset computation module 432. In some examples, module 432 is configured to compute one or more coresets 200, e.g. comprised in a coreset data structure 300, 400, 600.

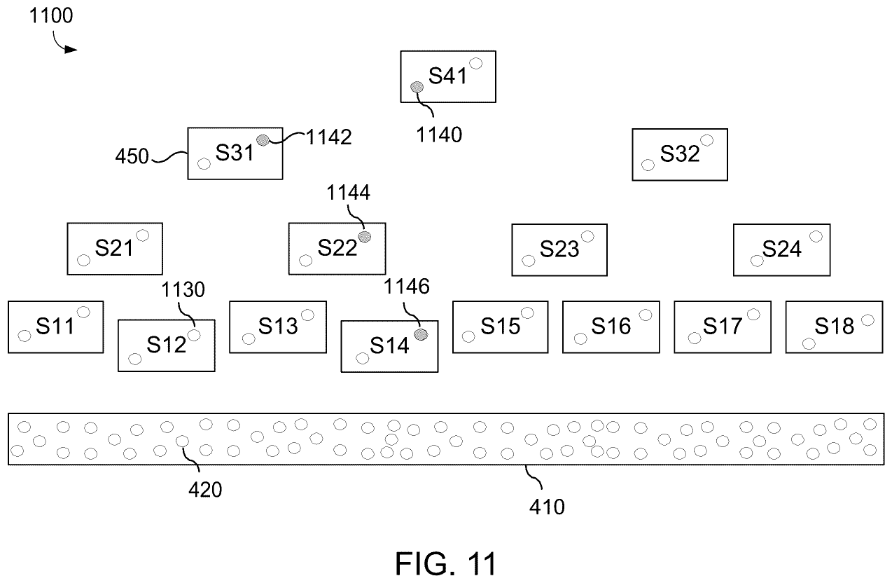

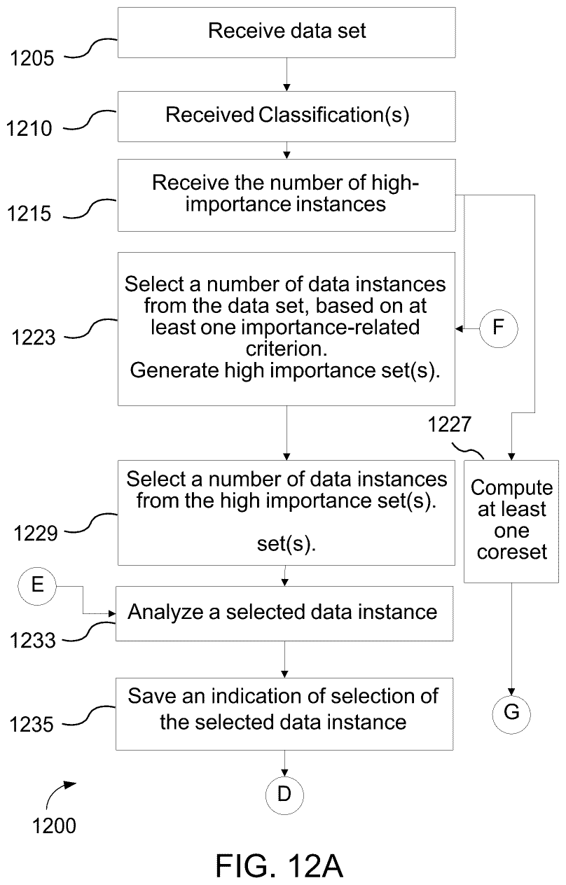

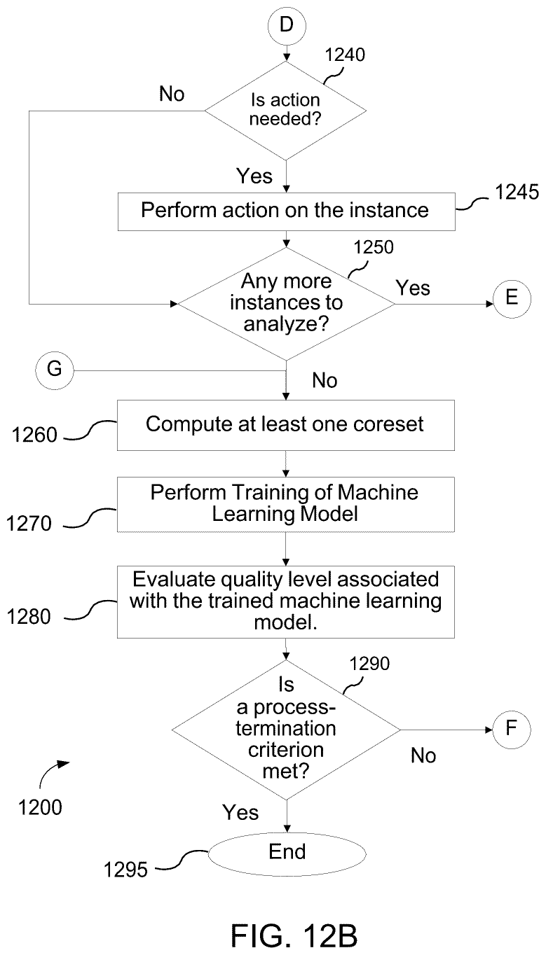

In some examples processor 431 comprises high importance set generation module 437. In some examples, module 437 is configured to compute one or more high importance sets S11, S41, e.g. comprised in a high importance tree or other data structure 1100. Example functions are disclosed with reference to e.g. FIGS. 11 and 12 and related text.

In some examples processor 431 comprises samples selection module 434. In some examples, module 434 is configured to select at least one selected coreset C41. In some examples, module 434 is configured to select a number of coreset samples 546, which will be analyzed. Example functions are disclosed with reference to e.g. FIGS. 5, 6 and 8 and related text.

In some other examples, module 434 is configured to select a number of data instances 1140, which will be analyzed. Example functions are disclosed with reference to e.g. FIGS. 11 and 12 and related text.

In some examples, this module is referred to also as instances selection module 434.

In some examples processor 431 comprises sample analysis module 435. In some examples, module 435 is configured to support analysis of the selected coreset samples 546, or data instances 1140, to determine if action should be performed. The data scientist 490 can interface to this module using e.g. external interface 480 and input/output modules 460, 465. In some examples, this module is referred to also as instances analysis module 435.

In some examples processor 431 comprises sample action module 440. In some examples, module 440 is configured to support actions on the selected coreset samples 546, or data instances 1140, such as correction, deletion and other cleaning activities. The data scientist 490 can interface to this module using e.g. external interface 480 and input/output modules 460, 465. In some examples, this module is referred to also as instances action module 440.

In some examples processor 431 comprises training module 452. In some examples, module 452 is configured to train, or re-train, the machine learning model(s), after the actions are performed. The training can utilize the coreset(s), and/or the dataset 110, 410, depending on the implementation. In examples other than that of the figure, the training is performed on a separate system, which receives the relevant training data from system 700. External training system 490 is an example of external system 490, interfacing with system 700 using the components, 480, 460, 465.

In some examples processor 431 comprises quality evaluation module 443. In some examples, module 443 is configured to evaluate the quality of the models trained by training module 440. In examples other than that of the figure, the model quality evaluation is performed on a separate system. External evaluation system 490 is an example of external system 490, interfacing with system 700 using the components, 480, 460, 465.

In some examples processor 431 comprises repetition module 448. In some examples, module 448 is configured to determine whether or not to repeat the process of e.g. selection/analysis/action/training/evaluation, based on whether one or more process-termination criteria are met, e.g. based on the evaluated quality or other criteria.

In some examples, memory 425 of processing circuitry 423 is configured to store data associated with the image construction process, e.g. comparatively transitory data. Non-limiting examples of data stored include: number of samples or data instances to select, classes to select, various criteria parameters, evaluated quality parameters etc.

In some examples, data cleaning system 700 comprises data store 470. In some examples, more long-term and persistent data is stored in the data store. Non-limiting examples shown include the stored full dataset 473, corresponding to e.g. dataset 100, 410, and coreset data structure 477, corresponding to e.g. coreset data structure 300, 400, 600. Another example shown is cleaning set/high importance set data structure 479.

FIG. 7 illustrates only general schematics of the system architecture, describing, by way of non-limiting example, certain aspects of the presently disclosed subject matter in an informative manner, merely for clarity of explanation. It will be understood that the teachings of the presently disclosed subject matter are not bound by what is described with reference to FIG. 7.

Only certain components are shown, as needed, to exemplify the presently disclosed subject matter. Other components and sub-components, not shown, may exist. Systems such as those described with respect to the non-limiting examples of FIG. 7 may be capable of performing all, some, or part of the methods disclosed herein.

Each system component and module in FIG. 7 can be made up of any combination of software, hardware and/or firmware, as relevant, executed on a suitable device or devices, which perform the functions as defined and explained herein. The hardware can be digital and/or analog. Equivalent and/or modified functionality, as described with respect to each system component and module, can be consolidated or divided in another manner. Thus, in some embodiments of the presently disclosed subject matter, the system may include fewer, more, modified and/or different components, modules and functions than those shown in FIG. 7. To provide one non-limiting example of this, in some examples input module 460 and output module 465 are combined into one module. Similarly, training module 450 and quality evaluation module 443 can be combined.

One or more of these components and modules can be centralized in one location, or dispersed and distributed over more than one location, as is relevant. In some examples, certain components utilize a cloud implementation, e.g. implemented in a private or public cloud.

Each component in FIG. 7 may represent a plurality of the particular component, possibly in a distributed architecture, which are adapted to independently and/or cooperatively operate to process various data and electrical inputs, and for enabling operations related to computerized machine learning model training. In some cases, multiple instances of a component may be utilized for reasons of performance, redundancy and/or availability. Similarly, in some cases, multiple instances of a component may be utilized for reasons of functionality or application. For example, different portions of the particular functionality may be placed in different instances of the component.

Communication between the various components of the systems of FIG. 7, in cases where they are not located entirely in one location or in one physical component, can be realized by any signaling system or communication components, modules, protocols, software languages and drive signals, and can be wired and/or wireless, as appropriate. The same applies to interfaces such as modules 460, 465 and external interface 480.

The above statements, concerning the generalization of FIG. 7, apply as well to, for example, the systems depicted in FIGS. 16 and 20, disclosed further herein. To provide one non-limiting example of this, in some implementations training module 452 and quality evaluation module 1843, and/or instance prediction and evaluation module 1835, can be combined. Similarly, in some cases modules 1843 and 1835 are combined. Similarly, in some cases module 1834 can instead be two modules—one for detach of branches and one for reattach of branches. Similarly, in some cases module 1840 can instead be two modules—one for removal of data instances and one for restoral of data instances. Similarly, in some cases modules 1840 and 1834 are combined. Similarly, in some cases modules 2254 and 2256 are combined.

Attention is drawn to FIGS. 8A-8B, schematically illustrating a generalized flow chart diagram 800, of a flow of a process or method, for data cleaning, in accordance with some embodiments of the presently disclosed subject matter. This cleaning process 800, e.g. a correction process, is, in some examples, carried out by systems such as those disclosed with reference to FIG. 7. The flow 800 starts at 805.

According to some examples, a dataset 100, 410 is received (block 805). In some examples, the data set is received from an external system 490, e.g. via external interface 480. In some examples, the dataset is stored 473 in datastore 470.

According to some examples, the set of classes to be cleaned/analyzed is received (block 810). In some examples, the data set is received from a human user 490 or external system 490, e.g. via external interface 480 and input module 460. For example, system 700 could be told to clean images classified as dogs, or as cats, or as both.

According to some examples, the number of high importance/sensitivity (or, alternatively, low weight) instances to select is received (block 815). In some examples, the one or more importance-related criteria to be used is received. These criteria are indicative of corresponding importance measures of the selected coreset(s) having at least one of high importance values and low weight values. In some examples, this information is received from a human user 490 or external system 490, e.g. via external interface 480 and input module 460.

In some examples, in block 815, and/or in block 810, other cleaning parameters are received, e. g number of coreset tree levels to use, which data should be used for the models training, process termination criteria, required quality levels, etc.

According to some examples, one or more coresets are computed (block 820). In some examples, this is performed utilizing coreset computation module 432. As part of the computation, in some examples, importance measures (e.g. importance and/or weight) are computed in this block. In some examples, the coresets are structured in a coreset data structure 300, 400, 600.

According to some examples, at least one selected coreset C41, that is representative of the data set 110, is selected from the coresets(s), e.g. from coreset tree 400 (block 830). The selected coreset(s) constitute a representative sub-set of the coresets C41. According to some examples, a number of coreset samples are selected, from the representative sub-set (e.g. C41), based on at least one importance-related criterion. The importance-related criteria are indicative of corresponding importance measures of the at selected coreset(s) having at least one of high importance values and low weight values.

For example, a number of high importance coreset samples 540 are selected, from the representative sub-set of the one or more coresets 600. In some other examples, a number of low weight coreset instances 540 are selected. In some examples, this is performed utilizing instances selection module 434. In some other examples, the two selections are performed in two separate blocks. Examples of how the selections are performed are disclosed with reference to FIG. 6.

These selections can give rise to a set of selected coreset samples C41, or C31, C32, having a high probability of at least one of high importance values and low weight values, as compared to a second probability associated with selecting a corresponding number of data instances from the full data set 110 itself.

According to some examples, a particular selected coreset sample is analyzed (block 833). In some examples, is performed utilizing sample analysis module 435.

According to some examples, an indication of selection of the coreset sample is saved (block 835). In some examples, this is performed utilizing sample analysis module 435, or alternatively using some other module. This block 835 is an optional step, which is not performed in other examples. It can be performed in response to the analysis of block 830, which determines whether the particular coreset sample requires an action such as cleaning. In some examples, a flag associated with the particular coreset sample 544, and data instance 420, is set. For example, the flag can be set in dataset 473, and/or in coreset data structure 475, of datastore 470.

In cases of repetition of the flow (per e.g. block 890), such an indication or flag can prevent the performance of iterations of analysis and actions, on the same coreset sample, multiple times. For example, consider that coreset sample 544 is analyzed in the first iteration, and is determined to be clean, or alternatively actions are performed to e.g. clean it. In some examples, there is no reason to re-analyze and re-clean this same sample 544. In e.g. the second iteration, at block 830 there is no need to select again the sample 544, e.g. as one of “500 high importance instances to select”. The iteration can be performed while selecting only samples 430 that were not previously selected and analyzed. that is, the repetition of the flow is performed for non-indicated coreset samples, and not for indicated coreset samples.

In other examples of block 835, the flag is set, or the other indication is saved, in response to a determination at block 840 that an action is needed, or in response to the performance of the action at block 845. In such examples, block 835 thus occurs at a later point in the flow than is shown in the figure. In some other examples, block 835 is performed after the selections of block 830.

In some examples, this marking or indication can thus facilitate a more efficient process of cleaning.

The flow continues A to FIG. 8B.

According to some examples, a determination is made, whether or not an action is needed (block 840). In some examples, this is performed utilizing sample analysis module 435, or alternatively using sample action module 440 or some other module. Responsive to a determination at block 840 that No, an action is not needed, the flow proceeds to block 850.

Responsive to a determination at block 840 that Yes, an action is needed, the flow proceeds to block 845.

According to some examples, an action is performed on the coreset sample (block 845). In some examples, this is performed by sample action module 440. Example actions are disclosed further herein with reference to FIG. 6.

According to some examples, a determination is made, whether or not other selected coreset samples remain to be analyzed (block 850). In some examples, this is performed utilizing sample analysis module 435, sample selection module 434 or another module.

Responsive to a determination at block 850 that Yes, additional coreset samples remain to be analyzed, in some examples the flow proceeds B back to FIG. 8A, looping back to block 833, in which the next of the selected coreset samples is analyzed.

Responsive to a determination at block 850 that No, no additional coreset samples remain to be analyzed, in some examples the flow proceeds to block 850.

According to some examples, training of the relevant machine learning model is performed (block 870). In some examples, this is performed utilizing training module 452. Options for performing the training, and for the training data used, are disclosed further herein with reference to FIG. 6.

According to some examples, quality level(s) associated with the trained machine learning model are evaluated (block 880). In some examples, this is performed utilizing quality evaluation module 443. Examples of quality levels are disclosed further herein with reference to FIGS. 9-10. In other examples, in which the process-termination criteria of block 890 do not rely on quality levels, it is possible that block 880 is not performed.

According to some examples, a determination is made, whether or not other one or more process-termination criteria are met (block 890). In some examples, this is performed utilizing repetition module 448 or quality evaluation module 443.

Responsive to a determination at block 890 that No, the process-termination criteria are not met, in some examples the flow proceeds C back to FIG. 8A, looping back to block 820, in which some or all coreset(s) are computed again. In other examples, there is no re-computation of coresets, and instead the looping back is to block 830, in which a number of high importance (or low weight) coreset samples are selected from coreset(s).

Responsive to a determination at block 890 that Yes, the process-termination criteria are met, the flow proceeds to block 895, the end of the process. The model training has been completed.

Attention is now drawn to FIG. 9, schematically illustrating an example generalized graph 900 of performance of data cleaning, in accordance with some embodiments of the presently disclosed subject matter.

The example graphs of FIGS. 9 and 10 are associated with the following example experimental scenario, which deals with industrial inspection: The dataset 100 has about 15,000 images. They are labelled either “defective” or “non-defective”. The dataset is split into training data and test data, in a 90% /10% split. In the original, clean, training dataset, the labels are in the following quantities: approximately 12,000 labeled “no-defect”, vs. approximately labeled 1,300 “defect”. The data is then intentionally “dirtied” (for the purpose of the experiment) to yield the following: ~12,100 “no-defect” vs. ~1,200 “defect”.

The experiment is for correcting the data labelled “no defect”. The dataset is to be cleaned in an iterative manner: In each iteration, 50 samples are selected, to analysis and possible action (in this example, a correction or fixing of labels). After analysis and action, training is performed, the quality of the model is determined, and the next iteration occurs.

In the example experiment, the iterations are performed using two different methods. In the first method, the selection of 50 samples in each iteration is performed randomly, that is in a uniform manner, as in some cases of the prior art. That is, 50 random data instances are sampled from data set 100. In some examples of such a method, samples are selected randomly from the data set.

In the second method, the selection of 50 samples in each iteration is performed using coresets, per the presently disclosed subject matter, using for example the method disclosed with reference to FIGS. 6 and 8 and the systems of FIG. 7. Recall that in the method of the presently disclosed subject matter, importance measures are used to decide which data to analyze and clean. The selection of sample based on importance measures is done from coreset(s), which statistically have higher importance/low weight values than the full dataset 100, and thus this method selects, in a more focused way, data that is most likely to impact the machine learning models, e.g. problematic data, which most justify attention of the experts for analysis and action.

The graph 900 shows, as the x-axis 930, the number of images selected and seen by the system, and for which analysis and correction is performed. Note that 50 images are analyzed in each iteration. The y-axis 940 is the number of incorrect labels that were found and fixed in that iteration. The results are plotted for the prior art uniform/random method, as curve 910, and for the method the presently disclosed subject matter, as curve 920.

Note that the chances of randomly selecting a mislabeled instance is 100/12,100=0.8%. Given 50 random samples in each iteration, each iteration will correct/fix 0.4 mislabeled samples by average. The number of fixed labels in curve 910 is relatively low, and it stays constant in each iteration.

By contrast, in curve 920, for the coreset-based method, in the first iteration over 30 labels are corrected. In the second iteration, roughly another 10 are corrected, and the third another 4 or so. Comparing curves 910 and 920, it is seen that the coreset-based method cleans many more labels in each iteration, and that it facilitates a quicker cleaning of data (and thus the arrival at high-accuracy models) at a quicker rate. FIG. 10 shows this a well.

Attention is now drawn to FIG. 10, schematically illustrating an example generalized graph 1000 of performance of data cleaning, in accordance with some embodiments of the presently disclosed subject matter. This figure shows the progress, per iteration of selection, analysis and cleaning, of the quality level, exemplified in the figure by the Area Under the Curve (AUC) measure. Four (4) iterations are shown. It is seen that the “cleanliness” of the dataset, in each iteration, naturally translates to the quality of the model.

The AUC of the initial clean data, before the dirtying is introduced, is depicted as curve 1090. Of course, it does not change, as no iterations are needed, as the data is “clean”. Curve 1070 shows the progress of AUC for the prior art, traditional “uniform/random” method. Note that the AUC improves, but at a relatively slow pace.

By comparison, curve 1080 shows that the presently disclosed coresets-based method reaches a comparatively high AUC level after even one iteration. Additional iterations might or might not improve over the AUC level of the previous iteration. Note that the example of the figure illustrates the criterion of reaching a plateau in quality level, where the improvements over earlier iterations are comparatively not large, e.g. below a defined amount.

It will take the traditional method, of curve 1070, many, many more iterations, to approach an AUC level achievable by the coreset-based method of curve 1080. Thus, the coreset-based method saves a large amount of resource utilization (storage and computation), as well as actual time (e.g. many fewer training iterations are required).

Note that the graphs show the value of the presently disclosed method, even in one iteration, as well as the additional improvement possible when performing additional iterations. Using a coreset for data cleaning significantly accelerates the cleaning process, improving data quality and the model as a result. Recall that training a model on a coreset(s) will yield the same result as training it on the full dataset.

Furthermore, creating a small coreset, rather than working with the original dataset 100, makes the data accessible to data analysts or domain experts to view it and clean it themselves, moving the cleaning responsibility from the data scientists to data experts in the organization. The quantity of data to be analyzed in the coreset case, to facilitate training of the models in an accurate manner, is a quantity that the human experts can deal with.

By using the coreset instead of the full dataset, data scientists and experts can explore, clean and label the data much faster, and focusing on the data instances likely to actually merit analysis, resulting in a higher quality dataset.

Note that there are also advantages to training the model on the coreset(s), rather than on the dataset 100 itself. Such training is much faster, allowing the data scientist to run more iterations to improve the model.

It should be noted, also, that performance of the presently disclosed subject matter is not feasible by a human. For example, computing of coresets, in some examples involving the solving of linear algebra and optimization problems with more than 1,000 equations and hundreds of variables, are not practical for a human, and are only feasible, and practical, using a computer. Coreset actions and calculations are thus inherently in the technical field of computer science, and they have no manually performed equivalent. This is relevant to all of the example methods and systems disclosed herein.

An example alternate cleaning method/process is now disclosed. Attention is now drawn to FIG. 11, schematically illustrating an example generalized view of a cleaning set data structure, in accordance with some embodiments of the presently disclosed subject matter. View 1100 depicts a conceptual view of an example cleaning set data structure 1100. In some examples, a plurality of cleaning sets are comprised in a coreset data structure. In some examples, the coreset data structure comprises a cleaning tree 1100, as shown in the figure. The figure illustrates the more specific non-limiting example of a binary cleaning tree 1100.

In many cases, a method such as that disclosed with reference to FIGS. 6 and 8 provides very good results, in terms of identifying data instances of high importance, and thus possibly problematic, corner case or outlier data instances. However, in at least certain situations, such a method might not perform optimally. As the ratio between the size of the full data set 410, and the size of the at least one coreset C41, increases, the performance of the method might decrease. To illustrate this, in the example of FIG. 4, the data set 410 has 160,000 data instances, and coreset C41 has 2000 coreset samples, giving a ratio of 80:1. Consider now instead a case where C41 has 200 samples, and data set 410 has 200 million data instances, giving a ratio of 1 million to 1. For convenience, this ratio is referred to herein as a coreset data compression ratio.

When a coreset is calculated, the statistical sampling process typically considers both importance and weight. However, weight is typically determined both based on importance (e.g. on an inverse of importance), and also on the frequency of occurrence of data instances. Weight is thus in many cases not merely the inverse of importance/sensitivity.

In order to generate a coreset which is statistically representative of data set 410, a certain number of “average/normal/typical” data instances must be chosen, since they represent a relatively large portion of the data instances. The coreset thus has only a limited “budget” of coreset samples which can be “allocated” to instances of high importance and thus high probability of being worth analyzing for correction. Thus, as the coreset(s) decrease in size, and the data sets increase in size, a selection method based on coresets can in some cases yield an insufficient number of data points of interest.

Purely to illustrate this, using arbitrary numbers, consider that the data set has 500 data instances that are worth analyzing and possibly correcting, and that there is a need to select them from the full data set. A coreset implementation with a ratio of 100:1 selects 400 of these 500 points, a relatively high proportion, while an implementation with a ratio of 1,000,000:1 selects only 7 of these 500 points, a very low proportion—in each iteration of the process. It is clear that the implementation which selected only 7 such points per iteration will not facilitate a good enough cleaning of the data, and it will result in a model of lesser quality—and/or it will require considerable additional time and effort.

FIGS. 11 and 12 therefore show an example variant of the presently disclosed process which can better select a larger proportion of high importance data instances.

It should also be noted that the use of coreset trees can increase these ratios, as will now be disclosed. The use of a method such as disclosed with reference to FIGS. 11 and 12 may therefore be additionally advantageous in some cases of coreset trees.

One example advantage of using coreset trees for training ML models is to deal with computation resources limitations. Consider the data set 410, of size 160,000. In some systems, there is insufficient memory, processing power etc. to perform a computation of a single coreset based on the 200K data instances. Splitting the data set 410 into individual “chunks” or sub-sets of data (e.g. eight of them, in the figure, each of size 20K), and separately computing a coreset C11-C18 for each, might in some cases have greater feasibility. However, a root coreset such as C41 can in some cases be more representative of the dataset 410 as a whole, since it is computed based on the entire data set, while each of e.g. C11-C18, separately, is representative of only an eighth of data set 410. Thus, in cases of computational resource limitations, a coreset tree approach gives a more representative coreset, which is better for training.

However, the recomputing of coresets at each level of the tree increases the ratio of compression. Thus, in the example of C11, C18 and C41 each having 2K samples, and data set 410 having 160K instances, e.g. of C11-C18 has a ratio of 20K/2K=10:1, while the root C41 has a larger ratio of 160K/2K=80:1. The non-limiting example of the figure has four levels in the coreset tree. As the number of levels in a tree increases, to e.g. 8, 10 or 20 levels, it is clear that the compression ratio between the data set and the coreset(s) used for data cleaning can further increase, as the total size of the relevant coreset decreases. Therefore, the alternative method of e.g. FIGS. 11 and 12 can become more advantageous, in improving the cleaning process and ultimately training a better model.

Various figures illustrate the concepts of this alternative method Again, FIG. 2 illustrates the concept of a coreset; FIGS. 3-4 illustrate example data structures, and how they are created; FIG. 5A illustrates the concept of importance; and FIGS. 5B-5C provide illustrative examples of labeled data instances. The concept of cleaning datasets using high importance sets (“cleaning sets”) is detailed with reference to FIG. 11. FIG. 7 provides a schematic diagram of systems configured for performing the method of the presently disclosed subject matter. FIGS. 12A-12B disclose an example flow chart of the method. FIGS. 9-10 illustrate example advantages of the presently disclosed subject matter over the prior art. Disclosure with reference to these figures is presented in the presently disclosed subject matter.

FIG. 11 discloses an example of one or more high importance sets S11, S12, S23, S41 etc. These sets will be used for cleaning, and not for training, and are therefore referred to herein also as cleaning sets.

In the example of the figure, the at least one high importance set comprises a plurality of high importance sets, S11-S18. Each such high importance set is generated from a distinct sub-set of the full data set 410. For example, each one of S11-S18 is of size 2,000, and it is derived from a distinct sub-set (not shown) of size 20,000 of data set 410.

In the non-limiting example of the figure, the at least one non-coreset set is comprised in a high importance set tree. This is referred to herein also as a cleaning tree, as distinguished from a training tree such as disclosed in FIGS. 3 and 4, which are used in training of machine learning models. As will be seen, tree 1100 is not composed of coresets, and thus is referred to herein also as a non-coreset tree, comprised of non-coreset sets S11, S31 etc.

At least to address the technical problems and disadvantages disclosed above, there is disclosed here in computerized method of cleaning a data set, as well as a data cleaning system and software products to perform such a method. The method comprises, some examples, the following:
(a) providing the data set 410, which is configured for training of a machine learning model. The data set comprises a plurality of data instances 420. Each data instance of the plurality of data instances comprises a label;
(b) selecting a number of data instances 1130 from the data set 420, based on at least one importance-related criterion. This thereby generates at least one high importance set S11. The at least one importance-related criterion is indicative of corresponding high importance values associated with the plurality of data instances. This gives rise to a set S11 of selected data instances 1130 having a high probability of high importance values, as compared to a second probability associated with selecting a corresponding number of data instances 420 from the data set 410.

The set S41 of selected data instances facilitates determining, for each data instance of the set of selected data instances, whether the particular data instance requires action. This facilitates performing the action, which brings about at least one increased-quality data set 410′, as compared to a quality of the data set 410. The increased-quality data set facilitates a higher-accuracy training of the machine learning model, as compared a second training of the machine learning model which is performed utilizing the data 410. In addition, in cases in which the coreset tree 600 is used for training, the better-quality data set can also be trained more quickly.

Similarly, in some cases, particular with high ratios of data set size to coreset size, selected instances 1130 have a relatively high probability of high importance values, compared to another probability (referred to herein also as a third probability) of having high importance values. This third probability is associated with selecting a corresponding number of data instances using the coreset-based cleaning methodology exemplified by FIG. 6.

Thus, S11, for examples, is generated using one or more importance-related criteria, which are indicative of corresponding high importance values associated with the plurality of data instances. These importance related criteria are referred to herein also as “second” criteria, which are in some examples distinguished from the “first” criteria used to create coresets in e.g. FIG. 6.

Non-limiting examples of selecting the number of data instances, based on the at least one importance-related criterion, include one or more of the following:
selecting data instances of highest importance—e.g. “the top 100 highest importance instances”, or “the top 5% of highest importance instances;
selecting data instances of importance above a defined importance value—“e.g. all instances with importance value above X”; and
selecting data instances based on a class associated with the plurality of data instances. More about selecting based on class is disclosed further herein.

Note that the resulting cleaning sets S11 etc. are NOT coresets, and they are typically not derived using the techniques and criteria used to compute coresets. Recall that coresets are computed using rigorous statistical techniques which ensure that the coreset is statistically representative of the corresponding underlying data set. Therefore, specific statistical computations, including consideration of weight based on frequency of occurrence of data instances 420, are performed for coresets, and thus the coresets are generated utilizing such above disclosed “first criteria”.

However, this is not done for non-coreset cleaning set S11. Rather, S11 considers ONLY importance-related criteria such as those exemplified above, attempting merely to select high- or highest-importance data instances, without being concerned with being representative of the data set—and thus without considering the frequency or prevalence of a particular data instance. That is, the selection is done in a more deterministic manner, rather than using statistical sampling.

Such a technique can in some cases ensure that high importance data instances 1130 are selected, for analysis and possible corrective action, even if the ratio between data set 410 and coreset(s) C11-C18 is relatively high.

The differing natures of coresets, used in this method only for training, and non-coreset sets used for cleaning, is indicated in the figures by the nomenclature of S11 (for “Set”) vs C11 (for “Coreset”).

In some examples, the number of data instances selected for each high importance set is a defined number of data instances, e.g. 2000 instances per set.

In some examples, the importance values associated each data instance 420 are not known a priori, and the selecting of data instances to generate the set S11 includes calculating the corresponding importance values associated with the plurality of data instances. Thus, for example, each one of cleaning sets S11 to S18 calculates the importance values of the data instances in its respective chunk/batch, and it selects (for example) the highest importance ones.

As disclosed above, once the sets S11, S12 of data instances are selected, a determination can be made (e.g. in an automated manner or through analysis by a data scientist), for each such data instance 1130, whether the data instance requires an action. An action can be performed, e.g. by the data scientist, which brings about at least one increased-quality data set, as compared to a quality of the data set 410 itself. Non-limiting examples of such an action include:
a. correcting a sample label associated with the data instance; 1130
b. deleting the data instance;
c. creating a new class, and assigning, to the data instance, a new data instance label, associated with the new class; and
e. adding additional data instances to the data set 410.

These action(s) can yield an increased-quality data set 410′. This increased-quality data set can in turn facilitate a higher-accuracy training of the machine learning model, as compared to a second training of the machine learning model performed utilizing the original uncleaned data set 410. In addition, in cases in which the coreset tree 600 is used for training, the better-quality data set can also be trained more quickly. Note that the model training is not performed using the high importance set(s) itself, as will be disclosed.

Note also, that example automated methods of performing the action, for the flows of FIGS. 8 and 12, are disclosed further herein.

The method has been exemplified so far by a single high importance set (not shown), with selected high importance data instances from data set 410, or by a number of high importance sets S11-S18. In still another example implementation, a cleaning tree 1100, also referred to herein as a high importance tree 1100 comprising high importance sets, is generated. In one example, the following method is utilized to generate the tree based on the leaf non-coreset sets S11-S18:
(a) selecting, from the at least one non-coreset set S11, and at least one other high importance set S12, a second number of data instances, based on at least one other importance-related criterion. The other high importance set(s) S12 are associated with a same tree level (e.g. Level 3) as the high importance set(s) S11. This thereby generates one or more parent high importance sets S21; and
(b) setting the parent high importance set(s) S21 to constitute the one high importance set, for purposes of a possible further iteration.

In some non-limiting examples, the importance-related criteria, used to select e.g. S11, S12, and other importance-related criteria, used to select e.g. S21, are the same. For example, the criterion for both selections can be “choose the top 5% of importance/sensitivity”.

In some examples, the above steps (a) and (b) are repeated at least once. For example, cleaning sets S21 and S23 can be used to derive cleaning set S31, and cleaning set S41 can be derived from sets S31, S32. Thus, the method can repeat the selection process, while considering more and more of the high-importance sets, and in some cases generating a root high importance set/cleaning set/non-coreset set S41.

In some examples, the number of data instances, associated with a leaf cleaning set S11, and the second number of data instances, associated with an internal high importance set S21, S31 or root high importance set S41, are the same. For example, S11, S21, D31 and S41 each have 2000 data instances.

Note also, that performing analysis, and cleaning actions, on relatively higher-level cleaning sets such as S31-S32 and root set S41, can provide at least certain additional example advantages. Consider an extreme case where all of the highest importance data instances are associated with set S18. If the cleaning is done based on e.g. the eight sets S11-S18, only ⅛ of the cleaning is done on the most relevant data instances. As the process is performed up the tree, the selection has an opportunity to select high importance instances from a larger and large portion of data set 410. Thus, S24 considers S17 and S18, and can choose more (even all) instances from S18 as compared to S17. Similarly, S32 selects among instances across all of S15-S18, looking at 50% of the data when determining the selection. Of course, the root cleaning set S41 considers all of the leaf sets S11-S18, and can select e.g. the highest importance data points across all of them. Thus, analyzing and performing actions at higher tree levels can be more efficient, focusing on a relatively smaller number of relatively higher importance data instances (and thus data instance of potentially more relevance for cleaning tasks).

Note also, that as a data instance “moves up” the cleaning tree, its importance value is, in some examples, recalculated and changed. For instance, set S21 calculates the importance values of the instances S11 and S12, and it selects (for example) the highest importance ones. Similarly, the process for S31 calculates the importance of S21 and S22, and so on.

Thus, data instance 1146, as it is selected time after time as points 1144, 1142 and ultimately 1140, may in some examples have different associated importance values at each level. This in some cases is likely to occur, since at each level the importance/sensitivity of instance 1146 is calculated against a different set of other data instances.

In some examples, responsive to the determination whether the each coreset sample requires a cleaning action, and responsive to the performing of the action, the method further comprises performing the training of the machine learning model. In some examples, the training utilizes the now-cleaned full data set 410 itself. In some other examples, the training utilizes one or more coresets generated from the full data set 410. That is, the cleaning is done using cleaning set(s) S41, while the training is done using coreset(s) C41, both generated from the same data set 410. In one such example, the cleaning tree 1100 of FIG. 11 is used to analyze and perform cleaning actions, while a coreset tree 600 of FIG. 6 is used for the actual training of the model. That is, two different trees are constructed, in some cases in parallel, and are used in combination to achieve a possibly better result. Therefore, coreset tree 600 is in this implementation also referred to herein also as a training coreset tree, or more generally as a training tree. By contrast, in the method of e.g. FIG. 8, coreset tree 600 is not only a training tree, but also serves as the cleaning tree.

As disclosed above, with reference to e.g. FIGS. 6 and 8, the model training using coreset(s) utilizes a representative sub-set C31, C32 of coresets. In some examples, this representative sub-set of the coresets, used for training, is derived by the following method:
(i) computing at least one coreset C11, from the increased quality data set 410′. An importance measure is generated for each coreset sample 546 of the coreset(s). The importance measure is indicative of at least one of an importance value (e.g. importance or sensitivity) and a weight value;
(ii) selecting, from the coresets, at least one selected coreset that is representative of the data set. This coreset(s) is the representative sub-set of the coresets.

For example, any of C11-C18, or C11-C14 and C23-C24, or C21-C24, or C31-C32, or C41 etc. are sub-sets of the coresets which are representative of data set 410.

Recall, that the at least one coreset can be comprised in a coreset data structure, which has at least the following properties:
I. an ability to add a coreset sample to the at least one coreset;
II. an ability to delete a coreset sample to the at least one coreset;
III. an ability to modify a coreset sample; and
IV. an ability to find a coreset sample within the coreset data structure.

In some examples, the coreset data structure further has at least the following property:
V. an ability to update the data structure with Log-N time complexity, or with better than in Log-N time complexity.

In the non-limiting example of FIG. 6, the training coreset(s) are comprised in a coreset tree 600.

Considering the interaction between cleaning sets and training sets, the following should be noted. Recall that the coresets and the cleaning sets (e.g. coreset trees and cleaning trees) do not hold the actual data instances 420. They instead contain indices (pointers) to the data instances. When the cleaning tree 1100 (or the coreset tree in the method of e.g. FIG. 8) automatically identifies high importance instances 546, 1146 that should be analyzed and perhaps fixed/corrected/cleaned (e.g. relabeled with an existing or a new class), the data is corrected/cleaned/updated in the underlying data instance 420, within the full data set 410, to which both the cleaning tree 1100 (or 600, if relevant) and coreset training tree 1100 are pointing. The relevant instances are updated e.g. according to the user's (e.g. data scientists) action.

Also, in some cases, as already disclosed, additional data instances are added, or perhaps deleted, to data set 410. These actions yield, in each iteration of cleaning, an updated or corrected data set 410′ (not shown in the figures).

Note also, that once the data instances are cleaned in some manner, some or all levels of the training tree 600 may now be inaccurate, as it no longer statistically represents the updated data set 410′. The importance of the samples has changed, samples have been removed or added etc.

Therefore, there may be a need to re-calculate the coresets in the training tree, that is to update the training tree 600, before it is used for training or for re-training. The coresets C11, C31 in the training tree are thus updated, e.g. up to the root coreset C41, and the model trained on the updated coresets training tree 600′. That is, the user can retrain again on the training tree 600′, as its coresets have been updated, and it now reflects the latest changes done.

Note that, strictly speaking, after recomputing e.g. a coreset C11 based on the cleaned data set 410′, it is a different coreset C11′, with different importance and weight values—and so on for all coresets in the tree. However, for ease of exposition, the recomputed coresets C11′ etc., as well as the recomputed tree 600′, are not shown separately in the figures, and they are instead implied.

In short, it can be said that the cleaning tree 1100 is used to find data instances that need to be “fixed”, the fixing is done in data set 410, the coresets in the training tree 600 are then updated, and the model is trained/re-trained on the coresets training tree. This is true whether the original coreset tree was computed before the cleaning process, in parallel with creation of cleaning sets S11, S41, or after their creation and/or after and iteration of cleaning (per e.g. the flowchart of FIG. 12). Thus, the cleaning tree 1100 is a special purpose structure utilized only for cleaning, not for training.

Note also, that in each iteration of cleaning, top importance or high importance samples are chosen. However, since the importance values have typically changed, other samples might be selected now, and of course samples might have been removed. Therefore, a new selection is done for the leaf cleaning sets, as well as for their various levels of parent sets as relevant, e.g. up to the root set S41.

After each iteration of cleaning and re-training, the process can include evaluating a model quality associated with the trained machine learning model. In some examples, these iterations can be repeated until meeting one or more process-termination criteria. Examples of such criteria include:
I. a defined number of repetitions have been performed; and
II. an improvement of the quality level over at least one previous iteration is below a defined improvement level.

As disclosed above, in some cases, the selecting of the data instances for the cleaning set(s) is based at least partly on a class associated with the plurality of data instances. For example, consider a case where the data set 410 comprises 80% of the class Dogs and 20% of class Cats. Assume that overall, the Dogs data instances have a higher importance value than do the Cats. There can be a fear that no Cats, or very few, e.g. only 5% or 1%, will be selected for cleaning set S11, and analyzed for cleaning. Such unbalanced cleaning can bias or distort the model training set.

Thus, the method can be configured to ensure that a certain number of certain classes, or even a certain number of all classes in the data set, will be selected for S11.

In some examples, this comprises selecting, from a particular class, in proportion to a prevalence of the particular class within the plurality of data instances. In the example above, the configuration can be that e.g. 80% of the selected set S11 will be high importance Dogs, and 20% of the set S11 will be high importance Cats.

Note that there are certain technical disadvantages of performing the method disclosed with reference to FIGS. 11 and 12. This method has the additional effort, in terms of both processing/computation and memory/storage resources, of calculating two different sets of data—coreset(s)/coreset trees to be used for the training functionality, and cleaning sets (non-coresets)/cleaning trees for the cleaning functionality. Both data structures must be continually updated in each iteration.

However, in at least some cases, as disclosed above, this additional effort can pay off, and provide at least certain example advantages. In some examples, this “combination of two trees” method can provide the improved performance disclosed e.g. with reference to FIGS. 9 and 10, even in cases where the coreset C41 is relatively small compared to the original data set, in which the “coresets only” method of e.g. FIG. 9 might not provide enough relevant candidate data instances 420 for analysis and cleaning.

Attention is drawn to FIGS. 12A-12B schematically illustrating a generalized flow chart diagram, of a flow of a process or method, for data cleaning, in accordance with some embodiments of the presently disclosed subject matter. This cleaning process 1200, e.g. a correction process, is, in some examples, carried out by systems such as those disclosed with reference to FIG. 7. This flow utilizes the high importance set(s) of FIG. 11. The flow 1200 starts at 1205.

According to some examples, a dataset 100, 410 is received (block 1205). In some examples, the data set is received from an external system 490, e.g. via external interface 480. In some examples, the dataset is stored 473 in datastore 470.

According to some examples, the set of classes to be cleaned/analyzed is received (block 1210). In some examples, the data set is received from a human user 490 or external system 490, e.g. via external interface 480 and input module 460. For example, system 700 could be told to clean images classified as dogs, or as cats, or as both.

According to some examples, the number of high importance/sensitivity instances to select is received (block 1215). In some examples, the number of instances to be analyzed in block 1233 is selected. In some examples, the one or more importance-related criteria to be used is received. These criteria are indicative of corresponding data instances of the plurality of data instances being associated with high importance values. In some examples, the data set is received from a human user 490 or external system 490, e.g. via external interface 480 and input module 460.

In some examples, in block 1215, and/or in block 1210, other cleaning parameters are received, e.g. the number of cleaning tree levels to use, which data should be used for the models training, process termination criteria, required quality levels, etc.

According to some examples, one or more coresets are computed (block 1227). In some examples, this is performed utilizing coreset computation module 432. In some examples, this block is the same as, or is similar to, block 820 of FIG. 8. In some examples, this block is performed in parallel to one or more of blocks 1239-1250. In some other examples, block 1227 is not performed.

Possibly in parallel with the above block, according to some examples, a number of data instances 1146 are selected from the data set 410, based on at least one importance-related criterion (block 1223). High importance set(s) S11, S12 are generated. In some examples, this block includes calculating the importance values of the data instances 420 in the data set 410. In some examples, this is performed utilizing high importance set computation module 437, and/or sample selection module 434.

According to some examples, a second number of data instances 1144 are selected from the generated high importance sets S11, S12, etc. based on at least one other importance-related criterion (block 1229). The relevant high importance sets are referred to herein as the high importance set(s) S11, and at least one other high importance set S12, which is associated with a same tree level as high importance set(s) S11. High importance parent set(s) S21, S22 etc. are generated. In some examples, this is performed utilizing high importance set computation module 437.

In some examples, this block 1229 is performed in a loop, repeated at least once. After each iteration, the parent high importance set(s) are set to constitute the high importance set(s), for purposes of the next iteration. In some examples, this block is repeated until the root high importance set S41 is generated. In some examples, in each iteration, the importance value of a particular selected data instance is re-calculated, as that data instance is repeatedly selected 1146, 1144, 1142 in each iteration for the next-highest parent set.

This block 1229 is optional. In some examples, the block is not performed, only a first layer/level of cleaning sets S11-S18 is generated, without any parent sets. That is, no cleaning tree is generated.

According to some examples, a particular selected data instance is analyzed (block 1233). In some examples, is performed utilizing sample analysis module 435.

According to some examples, an indication of selection of the selected data instance is saved (block 1235). In some examples, this is performed utilizing sample analysis module 435, or alternatively using some other module. This block 1235 is an optional step, which is not performed in other examples. It can be performed in response to the analysis of block 1233, which determines whether the particular selected data instance requires an action such as cleaning. In some examples, a flag associated with the particular data instance 1144, and data instance 420, is set. For example, the flag can be set in dataset 473, and/or in cleaning set data structure 477, of datastore 470.

In cases of repetition of the flow (per e.g. block 1290), such an indication or flag can prevent the performance of iterations of analysis and actions, on the same data instance, multiple times. For example, consider that selected data instance 1144 is analyzed in the first iteration, and is determined to be clean, or alternatively actions are performed to e.g. clean it. In some examples, there is no reason to re-analyze and re-clean this same data instance 1144. In e.g. the second iteration, at block 1223 there is no need to select again the data instance 1144, e.g. as one of “500 high importance instances to select”. The iteration can be performed while selecting only data instances 1130 that were not previously selected and analyzed. that is, the repetition of the flow is performed for non-indicated data instances, and not for indicated data instances.

In other examples of block 1235, the flag is set, or the other indication is saved, in response to a determination at block 1240 that an action is needed, or in response to the performance of the action at block 1245. In such examples, block 1235 thus occurs at a later point in the flow than is shown in the figure. In some other examples, block 1235 is performed after the selections of e.g. block 1223.

In some examples, this marking or indication can thus facilitate a more efficient process of cleaning.

the flow continues D to FIG. 12B.

According to some examples, a determination is made, whether or not an action is needed (block 1240). In some examples, this is performed utilizing sample analysis module 435, or alternatively using sample action module 440 or some other module. Responsive to a determination at block 1240 that No, an action is not needed, the flow proceeds to block 1250.

Responsive to a determination at block 1240 that Yes, an action is needed, the flow proceeds to block 1245.

According to some examples, an action is performed on the coreset sample (block 1245). In some examples, this is performed by sample action module 440. Example actions are disclosed further herein with reference to FIG. 11.

According to some examples, a determination is made, whether or not other selected coreset samples remain to be analyzed (block 1250). In some examples, this is performed utilizing high importance set computation module 437, sample selection module 434 or another module.

Responsive to a determination at block 1250 that Yes, additional selected data instances remain to be analyzed, in some examples the flow proceeds E back to FIG. 12A, looping back to block 1233, in which the next of the selected data instances 1130 is analyzed.

Responsive to a determination at block 1250 that No, no additional selected data instances remain to be analyzed, in some examples the flow proceeds to block 1250.

According to some examples, one or more coresets are computed, or are re-computed (block 1260). In some examples, this is performed utilizing coreset computation module 432. In some examples, this block is the same as, or is similar to, block 820 of FIG. 8, and/or to block 1227 of FIG. 12A.

In implementations where block 1227 is not performed, block 1260 comprises the first computation of the training coreset(s), e.g. the training coreset tree. In implementations in which block 1227 is performed, to initially compute the coreset(s), block 1260 comprises a re-computation of the training coreset(s). Similarly, in repeat iterations of the loop indicated by F, block 1260 comprises a re-computation of the training coreset(s).

For ease of exposition, block 1227 was shown as occurring in parallel with some or all of the flow of blocks 1223-1250. In other examples, the initial coreset computation of block 1227 is instead performed before 1223. The presently disclosed subject matter is not dependent on whether the “cleaning tree” 1100 and the “training tree” 600 are built and/or updated in parallel, or sequentially, or the particular sequence order.

According to some examples, training of the relevant machine learning model is performed (block 1270). In some examples, this is performed utilizing training module 452. In some examples, this block is identical or similar to block 870 of FIG. 8. Options for performing the training, and for the training data used, are disclosed further herein with reference to FIG. 6.

According to some examples, quality level(s) associated with the trained machine learning model are evaluated (block 1280). In some examples, this is performed utilizing quality evaluation module 443. Examples of quality levels are disclosed further herein with reference to FIGS. 9-10. In other examples, in which the process-termination criteria of block 1290 do not rely on quality levels, it is possible that block 1280 is not performed.

According to some examples, a determination is made, whether or not other one or more process-termination criteria are met (block 1290). In some examples, this is performed utilizing repetition module 448 or quality evaluation module 443.

Responsive to a determination at block 1290 that No, the process-termination criteria are not met, in some examples the flow proceeds F back to FIG. 12A, looping back to block 1223, in which data instances are selected and cleaning set(s) S11, S12 are recomputed or regenerated.

Responsive to a determination at block 1290 that Yes, the process-termination criteria are met, the flow proceeds to block 1295, the end of the process. The model training has been completed.

Attention is now drawn to FIG. 13, schematically illustrating an example generalized view 1300 of cross validation, in accordance with some embodiments of the presently disclosed subject matter. Illustration 1300 illustrates conceptually cross-validation of a trained machine learning model 1875 using coreset trees comprising coresets such as C41, C31, C23.

The full dataset 410 is composed of a plurality of data instances 420.

A coreset tree 1300 is shown. It comprises a plurality of coresets. The example tree has four levels, numbered in this FIG. 1 through 4. Level 1, the root coreset C41, is referred to herein as the highest level. Level 4, the leaf coresets C11 through C18, are referred to herein as being at the lowest coreset level of the tree. Levels 2 and 3 are referred to herein as comprising internal nodes C21 to C24 and C31-C32 of the coreset tree, that is non-root and non-leaf coresets.

The leaf corsets are each computed from a sub-set of the full data set 410, that is a sub-set of data instances 420. Thus, example coreset C17 is computed from data sub-set 1511, and example coreset C18 is computed from data instances sub-set 1513. The higher level coresets are computed from the lower level coresets. (“Higher” refers to “at a level closer to the root C41 of the coreset tree 1300”.) Thus, internal node coreset C24, computed from leaf coreset C17 and C18, is representative of the two sub-sets 1511, 1513 of the data. These two sub-sets in combination are denoted in the figure by 1515.

In one example, cross-validation is performed using eight (8) sub-sets of the full data set 100, 410. For example, the first iteration of testing will be performed on sub-set 1513, and thus the training will be done representative of the “remaining” portion of data set 410, that is the portion (1511, 1517 and 1519) of the dataset 410 which is exclusive of data sub-set 1513.

The method detaches/disconnects one or more branches of the coreset tree, i.e. sub-trees, from the tree 1300. For example, leaf coreset C18 is the chosen branch, and it is detached. Training is performed e.g. using coresets C11-C17, at the same level 4 as the detached branch. Then a prediction is performed for the portion 1513 of data set 410 that is associated with the detached C18. In some examples, the process of detachment, training and evaluation is repeated in respect of at least one other branch, for example leaf coreset C17. In this repetition, C17 is detached from the tree 1300, training is performed e.g. using coresets C11-C16 and C18, Then a prediction is performed for the portion 1511 of data set 410 that is associated with the detached C17.

In some examples, the process is repeated until the evaluation of the trained mode, has been performed with respect to data that is representative of all data instances of data set 410. That is, evaluation has encompassed ALL of the data instances 420, and/or of coresets (e.g. C11-C18) that represent ALL of the data instances. Such a full repetition. thereby facilitates a full cross-validation of the machine learning model.

In other examples, cross-validation is performed for only part of the data set 410. In some cases, such a “partial cross-validation” provides useful model quality metrics, although it may provide a poorer validation of the trained model as compared to a full cross-validation.

In another example, a higher-level branch or sub-tree is detached, e.g. C24 of level 3. Coreset C24 comprises, under it, coresets C17 and C18. Thus, branch C24 comprises also C17, C18. In one example implementation of this case, training is performed e.g. using coresets C21-C23, at the same level 3 as the detached branch.

Note that each detached branch has an associated tree level. Thus, for example, detaching the branch of C24-C17-C18 involves detaching at tree level 3, while detaching the branch of C18 involves detaching at tree level 4. Detaching the branch of C32-C23-C15-C16-C24-C17-C18 involves detaching at tree level 2. This tree level, of the detached branch, is referred to herein also as a first tree level, to distinguish it from other tree levels disclosed herein.

Thus, in the terminology of the presently disclosed subject matter, each branch represents a portion 1511, 1515 of the original full data set 410, but not all of it. The branch can be a leaf C18, that is one node of the tree, that is a single coreset. Each branch can instead comprise more than one coreset, if the detachment is performed at a higher level of the tree, e.g. at the level of an internal node C24, C32.

Note that the detached branch can be a leaf coreset, or a coreset which is an internal node of tree 1300. However, root coresets C41 would not be detached, since the reduced coreset tree would be empty, with no coresets to train.

In some other examples, multiple branches are detached in each iteration. Consider, for example, a case in which there are 16 branches at the level in which detachment will be performed, but there is a desire to cross-validate 8 times. In such a case, it might be decided to remove/detach two branches at a time.

For example, three leaf coresets C18, C11 and C15 are all detached at the same time, and training is performed e.g. using coresets C12-C14 and C16-C17.

In another example of such a case, branches C24 (including its sub-trees C17 and C18) and C22 (including C13 and C14) are both detached. Training can be performed using the remaining coresets C21 and C23, for example.

When one or more branches are detached, the original coreset tree gives rise to a reduced coreset tree. This reduced coreset tree comprises the remaining coresets of the original tree, which are exclusive of the detached branch(es). These remaining coresets are representative of a remaining portion of the data set 410. The remaining portion of the data set is that portion which is exclusive of those portions of the full data set which are associated with the detached branch(es). Thus, if C32 is detached, the reduced coreset tree comprises C41, C31, C21-22, C11-C14. This reduced tree is exclusive of branch C32, and it is representative of that portion 1519 of data set 410 which is exclusive of portions 1515 and 1517. (Portions 1515 and 1517 are associated with the detached branch C32-C23-C15-C16-C24-C17-C18). Note that in this case, the root coreset C41 should be recomputed, if the reduced coreset tree is to be truly representative of the remaining portion of the data set 410—as will be disclosed further herein.

In some examples, after detaching a branch, performing training using coresets representative of the remaining portion of the dataset, and performing evaluation on the model using data represented by the detached branch, the coreset tree is then restored before the next iteration. Thus, for example, if branch C18 was detached, after the associated evaluation of the model the branch C18 is re-attached to the reduced coreset tree, to restore tree 1300.

Thus, in such a case the method further comprises restoring the coreset tree, where the restoring comprises:
i. reattaching the detached at least one branch; and
ii. repeating the process of detaching, selecting coresets for training, training and evaluation of model quality, in respect of at least one other branch.

In some such cases, before detaching other branches, the method comprises storing a coreset tree configuration associated with the coreset tree. In such an implementation, the restoring of the coreset tree comprises restoring the stored coreset tree configuration.

In some other examples, cross-validation can continue without always restoring detached branches. However, such a process is expected to result in a comparatively poorer-quality model, one not utilizing as full a training set as possible.

Returning to the example case of detaching coreset C18 as the branch, it was disclosed that the training can be performed, in a first example implementation, on coresets C11-C17. That is, in such a case the training of the machine learning model 875, utilizing the representative sub-set of the remaining coresets, comprises training utilizing leaf coresets C11-C17 of the remaining coresets C11-C17, C21-C24, C31-C32, C41 of the coreset tree 1300. Note also that this is one non-limiting example of a case in which all of the selected training coresets C11-C17 are at a single tree level (Level 4).

However, other implementations are possible. In some examples, it is quicker, and less resource-intensive, to train using coresets of a higher level, which are in aggregate smaller than their child coresets. Thus, for example, instead of using the Level 4 training set C11-C16, in a second example implementation some leaf coresets can be replaced with the smaller Level 3 training set C21-C23. Thus, training using coresets C21-C23 and C17 uses data that is still representative of the remaining data portion 1519+1517+1511, but it can be more efficient than training using coresets C11-C17. Thus C11-C17 and C21-C23+C17 are both examples of a representative sub-set of the remaining coresets C11-C17, C21-C24, C31-C32, C41.

Note that the selected coresets used for training are associated with at least one tree level. The highest level of the training coresets C21-C23, C17 is referred to herein a training tree level, or as a defined tree level. Note that in the second example, the selected coresets are associated with more than one training tree level, that is with both Levels 3 and 4. Note also, that in such a case, the training utilizes internal nodes C21-C23 of the coreset tree. It is also possible to train using the root coreset C41, but that will always require re-computation of coresets, disclosed further herein.

Note also, that in the first example presented, of training with C11-C17 and evaluating with C18, the second tree level, associated with selected coreset(s), is identical to the first tree level of the detached branch—that is, both are at Level 4. This is only one possible implementation. In the second implementation, the detached branch is at Level 4, but the training utilizes both Levels 3 and 4.

Similarly, in some examples all detached branches are associated with a same coreset tree level. For example, in a particular iteration of training and evaluation, branches C14 and C18 are detached, or C24 and C22. Note that in such a case, a plurality of distinct branches are being detached in each iteration of training and validation.

In other examples, detached branches of a particular iteration, or across iterations, are of different levels. In one example, in a particular iteration C18 and C22 are both detached. In another example, in a first iteration C18 is detached and in a later iteration C31 is detached.

In some examples, at least one coreset selected for use in training, in a particular iteration of the cross-validation process, is at a tree level higher than the tree level of one or more of the branches. One example of this is where one of the coresets to be used for training is an ancestor coreset of the detached branch. Consider, for example, the case in which C18 was detached, and there is a desire to train entirely at Level 3, that is using C1-C24. There will be a need to modify coreset C24, an ancestor of C18, e.g. by recomputing it after the detaching of C18. The recomputed coreset C24 is referred to in the figure as C24′, to distinguish it from the original coreset C24.

The training tree level of such an ancestor coreset C24 is referred to herein also as an ancestor coreset level or as a second tree level, to distinguish it from the first tree level associated with the detached branch(es). This is true also in a case in which the training set will be of multiple levels, e.g. C11-C16 of Level 4, and C24′ of Level 3, in which the second tree level is thus Level 3.

Thus, the method in such cases includes recomputing at least all ancestor coresets of each detached branch whose first/branch tree level is either at the second tree level or is lower than is the second tree level (that is, where the first tree level is further from the root C41 than is the second tree level). For at least one of those ancestor coresets, the recomputing comprises recalculating an importance measure for at least one coreset sample. The importance measure is indicative of at least one of the importance value and the weight value of the coreset sample(s). The result of this is that the reduced coreset tree can now be referred to as an updated, corrected, or modified reduced coreset tree-one which includes at least modified one selected coreset C24′ on which training will be performed. The coresets C21-C24′ selected for training will thus be a modified representative sub-set C21-C24′, which is representative of the remaining set 1519+1517+1511—instead of the original representative sub-set C21-C24, which is representative of the entire data set 410.

Consider the case in which C18 was detached, and training should be done using C21-C24. For ease of exposition, only two points of coreset C24 are considered. The original coreset C24 included, among others, the white coreset sample 560, which it inherited from its child corset C17, and the gray coreset sample 1544, which it inherited from its child corset C18. Coreset sample 1550 of C17 corresponds to sample 1560 of C24, and sample 1546 of C18 corresponds to sample 1544 of C24. However, the weights or importance values of each sample may be different at each coreset level. As one example, coreset sample 1550 in C17 has weight 0.3. However, the corresponding sample 1560 in C24 has weight 0.5, since 1560 now represents also other coreset samples of child coreset C17, which do not appear in parent coreset C24.

Once C18 is detached, if there is a desire to train the model using C24, C24 must be recomputed. Coreset sample 1544, for example, must be removed, as it corresponds to coreset sample 1546 of the now-detached C18. When recomputing, to obtain a new or modified coreset C24′, it is possible that the coreset samples of C24 might change. For example, black sample 1552, which was not in the original C24, may appear as sample 1562 in the recomputed coreset C24′.

Recall that coresets 200, while being a reduced version of dataset 100, have the same statistical properties as does dataset 100. Thus, as coreset samples 1544 are removed, and others 1552 are added, there may be cases in which weights/importance values of at least some coreset samples 1550 must be recalculated 1560, to maintain statistical integrity.

Thus, in some examples at least one weight/importance of at least one coreset sample 1550, 1560 will change, in at least one of the coresets C24′ selected to be used for the training, to compensate for the detached branch C18, to maintain the statistical integrity of the coresets.

Similarly, in some examples at least one coreset instance in at least one coreset will be different than it was before (e.g. 1552, 1562 replaces 1546, 1544, or it possibly replaces 1550, 1560).

Note that in some examples, at least some of the original coreset samples 1560 remain in the modified coreset C24′. Note also that in some examples, for at least some of coreset samples, the weight/importance value does not change.

Returning to the example of the detached C18, consider another case, in which it is decided to train using Level 2, using C31 and C32, or perhaps C32+C21+C22. In such a case, in addition to recomputing C24 (in a manner disclosed above, thereby deriving C24′), C24's parent coreset C32 must also be recomputed (using C23 and C24′), to obtain modified coreset C32′. Similarly, consider a case in which training will be done using the smallest statistically relevant data set, i.e. the root coreset C41. The root C41 will have to be recomputed to obtain C41′, in addition to the re-computation of C24 and C32. Thus, in some examples, only one ancestor coreset C24 is recomputed C24′, while in others a plurality of ancestor coresets C24, C32 are recomputed C24′, C32′.

Thus, the method in such cases includes recomputing at least all ancestor coresets C32 of each detached branch which are part of the selected coresets C31, C32 which will be used in training the model 1875, as well as recomputing those ancestor C24 coresets located between this selected ancestor coreset C32 and the detached branch C18. For at least one of those ancestor coresets, the recomputing comprises recalculating an importance measure for at least one coreset sample. The importance measure is indicative of at least one of the importance value and the weight value of the coreset sample(s). The result of this is that the reduced coreset tree is now a modified reduced coreset tree, which includes at least modified selected coreset C32′ on which training will be performed.

To further illustrate the need for recomputing, consider a case in which two Level 3 branches, C22 and C24 (including C13, C14, C17, C18) are detached. It is possible to train on C11, C12, C15, C16, at Level 4. Alternatively, training can be on C21 and C23, at Level 3. Training can instead be on C21+C15+C16, or on C11+C12+C23, at Level 3 and also Level 4. None of these selected coresets are at a level about the first tree level (Level 3), and none are ancestors of C22 and C24. In all such cases no coreset recomputing is required. However, if it is instead decided to train using e.g. C31 and C32, e.g. C31 and C23 etc., then C31 and/or C32 will need to be recomputed to obtain C31′ and/or C32′. If training will be performed at the root C41, it will have to be recomputed to obtain C41′. This may require, in some cases, recomputing of all ancestor coresets of the detached branch.

In all such cases, it may be that importance values for at least some coreset samples, of at least some recomputed coresets, will be recalculated.

Note again, that in a case in which training is not performed using ancestors of any detached branch, it can be possible with an unmodified coreset tree 1300.

Recall also, that in some implementations the coreset tree is restored when reattaching the detached branch(es), prior to detaching the next branch(es), and that in some such cases this accomplished utilizing a coreset tree configuration associated with the coreset tree, which is stored and restored. In some cases where ancestor coresets are recomputed, and importance measures are recalculated, the importance measures for one or more coreset samples 1550 are stored prior to the detaching, and such measures are restored after the model quality is evaluated for the particular iteration. That is, both the coresets C14 themselves, and the importance/weight values of the relevant coreset samples 1550, are restored to their original values, before the next repetition of the process is performed.

FIG. 13 disclosed the non-limiting example of a binary coreset tree. Other tree arrangements are possible. It is common, for example, to perform cross-validation using ten (10) groups or sub-sets 1513 of the full data set 410. Thus, the tree could instead be constructed to provide 10 leaf coresets at Level 4, e.g. using known per se methods. The number of groups to use for cross-validation can in some implementations be a configurable parameter of the model training system, e.g. preconfigured, or e.g. entered in each case by human operator 490.

In many implementations, the training of the model 1875 is not done at the level of the base data 410, that is using full sub-sets of data instances such as 1519+1517+1511, since that consumes a comparatively large number of computer resources (CPU, memory etc.), and takes more time. Since, in the example of FIG. 13, this training is repeated eight times, to provide full cross-validation, the resource impact is of course even larger than that for a single round of training. Rather, training using coresets (e.g. leaves such as C11-C17, and/or internal nodes such as C21-C23+C24′ etc.) is more resource efficient. In some examples, it is most efficient to train using the (modified/recomputed) root coreset C41′, of the modified reduced coreset tree.

As disclosed further herein, in some examples the evaluating of the quality of the trained machine learning comprises evaluating of hyperparameters associated with the model 1875. In some examples the evaluating of the model quality comprises generating one or more quality metrics associated with the evaluation. In some cases, in which the process of detaching, training and evaluation is repeated, a total quality metric, which is indicative of the one or more of the quality metrics generated in each iteration, is generated. In some implementation, the evaluating of the model quality, utilizing detached branch(es) C24, utilizes representative branch coresets of the relevant branch, e.g. uses C24 or C17+C18. In other examples, the evaluation of the model quality utilizes the portion 1550 of the full data set of the relevant branch C24. In some examples, it is more advantageous to evaluate based on the actual data instance 420, 1550, rather than on coresets. Firstly, the evaluation time is often much less than the training time, so evaluation using coresets rather than data instances saves comparatively fewer resources. Secondly, coresets C18 provide only an approximation of the underlying data 1513, and they are not exact. If, for example, the coreset has 100 points, each mistake in prediction can affect the evaluation by at least 1%. Utilizing the underlying data instances 1513 will provide more data points for the evaluation, and thus the metrics derived by the evaluation will have better resolution.

In addition, if evaluation is done utilizing all data instances under the branch, it is possible to find dirty or problematic data, and to thus enable its cleaning or correction. More on this is disclosed further herein.

Some non-limiting example technical advantages of cross validation using a coreset tree architecture are now disclosed. As indicated earlier, cross-validation can in some cases involve high cost and resource use. Training using coresets C11-C17, instead of using the data instances of the actual data set 410, can in some cases be much faster, and use fewer resources.

Consider, for example, a data set of 1 billion data instances. To perform cross-validation of 10 groups, each of size 100 million, training would have to be performed, ten times, each time for 900 million data instances. Compare this to a coreset tree in which each leaf is of size 50,000 coreset samples. Each cross-validation iteration would require training of 9 coresets, comprising 9×50,000=only 450,000 coreset samples, and this would be performed 10 times. The scale of the improvement in performance is evident.

For example, in some typical cases of a data set of tens of millions of data items, traditional cross-validation methods can take in the vicinity of 10 hours.

Note that even if a user of the traditional method wishes to speed up this time-consuming process, by performing parallel computing using multiple servers/computers, the same amount of CPU time and other computer resources will be required. Only the “absolute time elapsed” from start to finish will be decreased. The computing costs, and carbon emissions, will still remain roughly the same. In addition, in some cases the data scientists will not use parallel computing on multiple computers because of the operational complications involved. In addition, they in some cases may need DevOps help or approval for such large runs.

By comparison, using the presently disclosed methods utilizing coreset trees, a full cross-validation can be performed in approximately 10 minutes.

Note that in addition to improved performance, in some cases cross-validation tasks which would otherwise be not feasible at all can become feasible using the presently disclosed subject matter.

Some existing methods of cross-validation, which use coresets, also have at least certain disadvantages. See e.g. M. Stone, “Cross-validation: a review”, Series Statistics, Vol. 1 (1978), Issue 1, pp. 127-139, published online 27 Jun. 2007, https://www.tandfonline.com/doi/abs/10.1080/02331887808801414?journalCode=gsta1 9, see Footnote 2.

One commonly performed method creates a coreset based on data set 410, and then splits that coreset into e.g. 10 groups. For example, if there is a coreset of 1000 items, it is split into 10 groups of 100 items within each coreset. Cross-validation is performed using these resulting groups. However, such a method is mathematically incorrect. It is wrong to split the coreset into 10 independent sections or groups. The coreset includes weight or importance values, which were calculated using all of the data 410. The members of the coreset are thus in fact dependent on each other, and thus the groups are dependent on each other. The coreset cannot be split without re-calculating the weight/importance values.

A second existing method is to split the data set 410 into 10 groups. For each group, a coreset is calculated. That method then takes coresets 1-9, combines them into one coreset, trains the model 1875 using the combined coreset, and tests the model against the tenth coreset. Then coresets 1-8+10 are combined into a coreset, which is used to train the model, and the model is trained against the coreset 9, and so on. No coreset tree is used. Again, it is mathematically incorrect to combine coresets without adjusting the importance measures each time.

In addition, using coreset tree 1300, the amount of updating required in each iteration of cross-validation can in some cases be minimalized. Consider the case of detaching each Level 4 node, in turn, and training on the root node C41. The three nodes C24, C32, C41 must be re-computed, but the other 11 nodes C11-C17, C21-C23, C31 need not. When C18 is reattached and C17 is detached, the effect is similar. In each iteration of the cross-validation, much of the existing coreset information can be reused, and only a relatively small number of coresets must be re-computed. This simplifies the adjustments to the tree.

By comparison, were the training to be performed on the data instances 420 level, in each iteration the composition of the entire data set 410 is modified.

Consider also a case in which the second existing method disclosed above is used to cross-validate using e.g. 8 groups, but now the user requests to cross-validate using the same data but with a larger number groups, e.g. 10 groups. The data must be split anew, and new coresets calculated and combined. All of the previously performed calculation work is lost, and cannot be re-used. By contrast, in the presently disclosed subject matter, there is not necessarily the need to rebuild the tree. The training can simply be moved a level up or down the tree, e.g. moving from a level with 8 nodes to one with 16 nodes. In another such case, some programming can be performed to handle e.g. 13 groups instead of 10 groups, if the user requires such a change.

In addition, cross validation is a standard part of hyperparameter tuning. Different hyperparameter combinations are tested to see which provides the best model. For every combination of hyperparameters in the model, cross validation can be performed, and the quality metrics can be evaluated. After trying different hyperparameter combinations, doing cross validation for each one and receiving the quality metrics, the best hyperparameter combinations can be selected (typically the ones that obtained the best quality metrics). One of the best techniques for hyperparameter optimization is grid search. However, grid search is typically not feasible because of the large number of the combinations it tries—each of which requires cross-validation. With the use of coreset trees per the presently disclosed subject matter, a grid search technique becomes feasible, even in cases where the technique would normally not be feasible.

Similarly, in prior art methods, if some of the data is found to be unclean (e.g. mislabeled), or otherwise problematic, the problematic point/data instance 420 must be thrown out, and all of the coresets must be recalculated. By contrast, using coreset trees, most of the data structure need not be touched, and only the relevant paths of the tree 1300 (those which utilize the problem data instances 420) need be recomputed.

Thus, the presently disclosed subject matter discloses a new paradigm for training machine learning models 1875, including their validation. The re-engineering of the existing training data set 410, to utilize the coreset tree structure 1300, facilitates a process of training and validation, of various machine learning models, in a manner that is more efficient and can consume fewer resources. This new paradigm can additionally enable greater flexibility in the process, for example in cases where changes to the data set (e.g. data is found to be problematic), or to the cross-validation scheme (e.g increase the number of validation groups), are required.

An additional example benefit of the presently disclosed subject matter is the ability to facilitate cleaning of data. As part of the evaluation of the model quality, one or more problematic data instances 420 can be identified, as contributing to a possibly lower than desired quality metric. The method can further include at least one of the following steps:
(a) deleting, from the data set, the problematic data instance(s); or
(b) marking, for cleaning, the identified problematic data instance(s). In some examples, the cleaning is performed by a human data scientist.

In some examples, this identification step is performed after each group is cross-validated. In other examples, it is performed after several cross-validation iterations are performed, e.g. for several branches C18, C17, C16 etc. The later the identification step is performed, that is, after more cross-validations have been performed, the statistically higher is the probability that the identified data instance 420 is in fact problematic. In some examples, this identification step is done after the system finishes the full cross-validation, across all groups.

Other variation of “classic” cross-validation techniques, such as time series validator technique, stratified group split fold, and leave-one-out split, can also be implemented using the above techniques, mutatis mutandis.

Consider, for example, a case where the data is in a time series, e.g. to predict rises and drops in a stock share price. It is not correct to, for example, train on the 1^{st} through 8^{th} portions of this time series, and on the 10^{th} portion, and then to validate using the 9^{th} portion (where the 9^{th} portion is associated with a time period between the 8^{th} and 10^{th} portion). Thus, the “standard” cross-validation technique would not be used. Such a series would instead be validated using e.g. a time series validator technique, i.e. a times series split. The presently disclosed subject matter can be applied as well to e.g. a time series validator technique.

Attention is now drawn to FIG. 14, schematically illustrating an example generalized view 1400 of prediction for data instances, in accordance with some embodiments of the presently disclosed subject matter. Illustration 1400 illustrates conceptually prediction for specific data instances, utilizing a trained machine learning model 1875, and using coreset trees comprising coresets such as C3, C6, C7.

Recall that in the real world, it is often not sufficient to obtain a trained machine learning (ML) model 1875 that predicts most cases correctly. A determination that statistically the model is expected to work well, e.g. that is can predict correctly the “average” or “typical” case, is in some cases not good enough. The model is often required to be able to handle special cases, e.g. edge cases, which affect even fractions of a percent of all possible data. Recall the above-disclosed example of a lion incorrectly predicted, by an autonomous vehicle, as being a cat. Another example is an image of a cow located in a living room. Most training data for identifying the image of a cow shows a cow in a more standard setting, e.g. a meadow, barn etc. These are examples of edge cases, also referred to herein as corner or border cases.

More generally, and again from the example field of image identification, consider an image that is in fact of class 2, but it looks very much like class 1. Alternatively, it is in fact of class 1, but it is close in appearance to class 2. There is a need to determine if the model correctly classifies such images as class 1, or as class 2.

Considered from another point of view, a model that performs well statistically will have certain failure points, that is data instances which it will not be able to predict correctly. The subject matter disclosed with reference to FIG. 14 attempts to ensure that failure points are not very serious or catastrophic, i.e. that the model will not make very bad decisions in the rare edge cases, e.g. the vehicle will not drive over to the lion due to misidentification as a cat.

The evaluation to be performed will answer questions such as: is the particular model robust enough to also correctly classify unusual edge cases, or more generally classify any specific cases of interest? A robust model will have the minimum possible errors in such cases. One example term for the process disclosed with reference to this figure is edge case validation.

Such testing of special cases, such as edge cases, is referred to herein also as business testing, since it may be that the needs of the particular business or application, or the system which makes use of the trained model, require robust correct prediction of these special cases, for the model to be of value or use. This can be seen as a sensitivity test of the trained ML model.

In FIG. 14, the full dataset 100 is composed of a plurality of data instances 310. Each is labeled “x<number>’. The full dataset is composed of a plurality of sub-sets of data instances, e.g. 315, 617 and 619. Each leaf coreset C4 of the coreset tree 1400 is based on a corresponding data sub-set 617. Similarly, leaf coreset C5 is based on corresponding data sub-set 619.

Reverting now to the figure, a second example coreset tree 1400 is shown. It comprises a plurality of coresets. The example tree has three levels. Level 1 is the root coreset C7. Level 2 comprises internal nodes, coresets C3 and C6. Level 3 comprises the leaf coresets C1, C2, C4 and C5.

Consider first the example “special” data instance x13 within subset 617, indicated with diagonal shading. There is a desire or a need to evaluate the ability of the trained ML model to predict x13 correctly. In some cases, this data instance x13 is indicative of an edge case of the machine learning model 1875.

Therefore, the model 1875 must be trained without using x13. Point x13 is removed from sub-set 617, and thus from data set 100. (In one implementation, the index in the data structure to x13 is temporarily removed). Instance x13 is thus referred to herein also as a removed data instance x13.

This action generates, from the data sub-set(s) 617, reduced data sub-set(s) 617′. Similarly, the removal generates, from full data set 100, a reduced data set 100′, one which does not include data instance x13.

Recall that leaf coreset C4 is derived from sub-set 617 and is representative of it. Sub-set 617 of course contains data instance x13. However, after the removal of x13, coreset C4 might no longer be statistically representative of reduce sub-set 617′, since 617′ does not contain/include x13. In this sense, after the removal of x13, C4, is referred to herein as an invalid coreset C4. There is therefore a need to recompute at least leaf coreset C4, an ancestor coreset C4 that is an ancestor of the now reduced sub-set 617′—to reflect the removal of the at one or more data instances x13. As will be seen further herein, in some examples there is a need to recompute also additional coresets that are ancestors of reduced sub-set 617′. The recomputing of these one or more ancestor coresets gives rise to a modified coreset tree 1400′, which comprises e.g. C4′ in place of the original C4. The recomputed coreset C4′ is referred to herein also as a corrected leaf coreset C4′, since the coreset C4′ is now statistically representative of the reduced sub-set 617′.

In some examples, the recomputed or modified coreset C4′ contains different data instances than did the original coreset C4. For example, x14 appeared as a coreset sample in C4, but it does not appear in C4′. Alternatively, in some examples the same data instance x14 appears as a coreset sample in both C4 and C4′, but the weight, importance, and/or sensitivity associated with x14 in the two coresets is different. That is, the removal of data instance x13 can be reflected in the composition of C4′, as well as in the weights of coreset samples in C4′.

Once such re-computation is performed, the method selects, from the modified coreset tree 1400′, coresets that are representative of the reduced data set 100′, that is from the data exclusive of the removed data instance(s) x13. For example, C1, C2, C4′ and C5 are statistically representative of 100′, which does not include x13. The machine learning model 1875 is trained using these selected representative coresets. This gives rise to a trained machine learning model 1875. Now a claim In some non-limiting examples, the training of the model can use the cross-validation methodology disclosed with reference to FIGS. 13 and 17.

One or more predictions can be performed, for the removed data instance(s) x13, utilizing the trained machine learning model 1875. In some examples, the prediction comprises predicting a class associated with the removed at least one data instance, for example predicting whether the data instance x13 is an image of class “cat”, “lion” or perhaps something else. One or more model predictability metrics, associated with the prediction(s), are then evaluated. These predictability metrics are indicative of an ability of the trained learning model to correctly predict the removed data instance(s).

In the above examples, one point was removed in an iteration of the training and evaluation process. In some other examples, multiple data instances are removed in a particular iteration of the method. For example, data instances x10 and x19 (indicated with dotted shading) are both removed from data set 100. One case in which such an action might be performed is where at least some data instances to be removed are associated with a group that shares at least one feature of interest. For example, data instances x10 and x19 both are images of a special case such as redhead boys with dark tan skin. In still other example cases, the method removes, in a particular iteration, various data instances which do not necessarily share any features. Thus, it can be that the unrelated x13 and x19 are deleted from the full data set 100.

If, in an iteration the training and validation process, multiple instances x10 and x19 are removed, and if they are associated with different sub-sets 615 and 619, this results in multiple reduced data sets 615, 619′. Therefore, in such a case, multiple ancestor coresets, e.g. leaf coresets C2, C5, become invalid coresets, and must be recomputed to obtain multiple recomputed coresets C2′, C5′. Training using the modified/reduced data set 100′ can be performed using e.g. C1+C2′+C4+C5′. Then prediction for data instances x10, x19 is performed, and the model predictability is evaluated.

Similarly, if x13 and x19 are removed in an iteration, the recomputed coresets C4′, C5′ are obtained. Training using the modified/reduced data set 100′ can be performed using e.g. C1+C2+C4′+C5′. Then prediction for data instances x13, x19 is performed, and the model predictability is evaluated.

The discussion above disclosed the example of training at the level of the leaf coresets (Level 3 in FIG. 14).

As disclosed above e.g. with reference to FIG. 13, in some cases it is faster, and/or more efficient in use of other resources, if the training of a model is done using higher-level coresets of coreset tree 1400, closer to the root C7, rather than training only with leaf coresets of e.g. Level 3. Thus, in the example of the figure, it can be advantageous to train using e.g. internal nodes C3+C6, nodes on a combination of levels e.g. C1+C2+C6, or root node C7.

The selected coresets used for training are associated with at least one tree level. The highest level of the training coresets C21-C23, C17 is referred to herein a training tree level, or as a defined tree level. Note that in the example of C1+C2+C6, the selected coresets are associated with more than one training tree level, that is with both Levels 2 and 3. That is, the selected coresets are comprised in different tree levels of the coreset tree 1400, 1400′.

In such cases, after creating reduced sub-sets and recomputing each corresponding leaf coresets, there can be a need to recompute as well additional coresets which are ancestors of the removed data instance(s). Consider the first case, in which x13 was removed, and recomputed leaf coreset C4′ derived.

If the training of the model will utilize e.g. C3+C4′+C5, no additional coresets need be recomputed. However, if the training will utilize e.g. C1+C2+C6, or C3+C6, then C6, being an ancestor of C4, C4′ which is at a higher level than them, will also have to be recomputed, to generated recomputed coreset C6′. In such an example, the defined tree level is Level 2.

That is, for each corrected leaf coreset, recomputing should be performed for all ancestor coresets C6 which are at the defined tree Level 2, or which are lower than is the defined tree level. In such a case, it may not be necessary to recompute higher ancestors such as coreset C7.

Training using the root coreset C7 will always require re-computation of coresets. Coreset C7, an ancestor of C4 which is at the defined tree Level 1, will be recomputed. Coreset C6, which is an ancestor of C4 that is at a lower level (Level 2) than is the defined tree Level 1, will also have to be recomputed—since the re-computation of C7 will be based on C6′, the recomputed version of C6.

Note that the training process is resource consuming, and training is performed multiple times to enable separately prediction of each special data instance. Therefore, in many cases, it is disadvantageous to train at the base data 100 level, rather than at one of the coreset levels.

The training tree level of such an ancestor coreset C6 is referred to herein also as an ancestor coreset level or as a third tree level, to distinguish it from the first and second tree levels disclosed with reference to FIG. 5. This is true also in a case in which the training set will be of multiple levels, e.g. C1+C2+C6.

As disclosed above, and with reference to FIG. 13, coresets 1400, while being a reduced version of dataset 100, have the same statistical properties as does dataset 1400. Thus, there may be cases in which weights/importance values of at least some coreset samples must be recalculated, to maintain statistical integrity. Thus, in some examples at least one weight/importance of at least one coreset sample 660 will change, in at least one C6′ of the coresets selected to be used for the training, to compensate for the removed data instance(s) x13, to maintain the statistical integrity of the coresets.

Similarly, in some examples at least one coreset instance in at least one coreset will be different than it was before.

Note again, that in some examples, at least some of the original coreset samples remain in the modified coreset C6′. Note also that in some examples, for at least some of coreset samples, the weight/importance value does not change.

The coresets, e.g. C3-C6′, selected for training will thus be a modified representative sub-set C3-C6′, which is representative of the reduced data set 100′—instead of the original representative sub-set C3-C6′, which is representative of the entire data set 100.

Consider now another case, in which x13 and x19 are deleted. Leaves C4 and C5 are recomputed. If training utilizes leaves C1, C2, C4′ and C5, no additional recomputing need be done. However, if training is done using e.g. C1+C2+C6 or C3+C6, it will be necessary to recompute both C6, which is a selected ancestor of C4 and C5, both of which were modified. If training instead uses root C7, it too will have to be recomputed. These re-computations reflect the removal of data instances from sub-sets 617 and 619.

Consider now a third case, in which x10, x13 and x19 are all deleted. Leaves C2, C4 and C5 are recomputed. If training utilizes leaves C1, C2′, C4′ and C5, no additional recomputing need be done. However, if training is done using C3+C6, it will be necessary to recompute both C3 and C6, which are selected ancestors of C2, C4 and C5, all of which were modified. If training instead uses root C7, it too will have to be recomputed. These re-computations reflect the removal of data instances from sub-sets 615, 617 and 619.

In all of the above examples, the re-computation of the invalid leaf coresets C4, and in some cases, the re-computation of selected ancestor corsets C6, give rise to a modified coreset tree. That is, the tree 1400 is updated, up to the desired level associated with the training, and then the training is performed.

In a fourth case, x10 and x19 are deleted in one iteration of model training and evaluation, and x13 is deleted in a different iteration of model training and evaluation. In each case, different leaf coresets, and possibly ancestor coresets, are recomputed.

Such a process has at least certain example technical advantages. For each set of data instances for which the model quality should be evaluated, a relatively quick process is performed: the relevant instances are deleted, the corresponding leaf coresets are recomputed, and the coreset(s) of that coreset(s), are recomputed, going as far up the tree as is needed for the particular selected training coresets. In each iteration, the method rebuilds the coreset tree relatively quickly, without those particular removed data instances.

Since the evaluation and tuning of ML models is often a difficult and expensive part of the model construction/training process, such an increase of efficiency in the evaluation and tuning can be particularly advantageous.

For example, in some typical cases of a data set of tens of millions of data items, traditional methods of predicting edge cases can take in the vicinity 1-2 hours. Again, if the user of such a method wishes to speed up the process using parallel computing, the challenges disclosed further herein remain.

By comparison, using the presently disclosed methods utilizing coreset trees, a full validation of edge cases can be performed in approximately 3-4 minutes.

In cases of evaluating the models separately for different data instances and/or groups of data instances, the method comprises performing the process, in respective of one or more data instances x10, x19, and then repeating the above process, in respect of at least one other data instance x13. In some such cases, first data instance(s) x10, x19 are associated with a first group that shares at least one feature of interest (e.g. images of tanned redheads), and second data instance(s) x13 are associated with a second group that shares at least one other feature of interest (e.g. images of cows in a living room).

Note that in some examples, the ML models in all of the iterations have the same hyperparameters. The evaluations can check the quality of these hyperparameters.

In some other examples, in each repetition of the process a single data instance x13 is removed, and re-computation, training, prediction and evaluation are performed. This can facilitate cross-validation of the machine learning model utilizing a “leave one out” methodology.

More generally, the method of FIG. 14 can be viewed as an edge case of cross validation. This method can be seen as a subcase of “leave one out”—as it performs “leave one out” for specific data items of interest, e.g. for high importance data, for those points of high importance which were not taken out of the data sets but were used for training. A special validation of these points is performed.

In at least some cases the methodology works less well if in each repetition more and more data instances are removed from data set 100, and the data set continually shrinks and loses data instances. The training will be less good in such a case. Therefore, in some example implementations the process comprises, prior to the repetition of the process:
I. restoring the removed data instance(s) x13 to the data sub-set(s) 100′; and
II. restoring the coreset tree 1400. The restoring of the coreset tree comprises restoring the importance measure of the relevant coreset sample. That is. the coresets and the importance/weight are restored to their original values, before the next repetition of the process.

In some such cases, before the deletion of data instance(s) x13, the method comprises storing a coreset tree configuration associated with the coreset tree. In such an implementation, the restoring of the coreset tree 1400 comprises restoring the stored coreset tree configuration.

After completion of the process of repetition, the system will have evaluated the ability of the trained model to predict each of a plurality of special cases (e.g. edge cases), and in some implementations will have generated model predictability metric(s) for each such evaluation. In some implementations, after completion of the repetitions, the system is configured to generate an overall metric for each group of special cases, based on prediction success of each case in the group. The overall metric can apply to a particular shared feature(s). In some implementations, a more general overall metric, indicative of the ability of the trained model to predict ALL of the identified special cases, across all groups and features, can be generated.

As one example, model 1875 is trained using the cross-validation method of FIG. 13, and an overall metric shows that the model can predict the data set with 99% accuracy. In addition, 100 edge cases, or other special cases within the data set, are predicted, using the methodology of FIG. 14. A first model predictability metric is determined for each such case. In addition, a second metric, an overall metric, is determined across all 100 cases, considering statistically the individual model predictability metrics. For example, it is determined that trained model 1875 is able to predict the edge cases, at an overall level, with only 95% accuracy, less than the 99% achievable for all data instances of the data set 100.

Thus, in some examples, FIG. 14 discloses a computerized method of training a machine learning model 1875, as well as a machine learning system 1800 (see e.g. FIG. 16) and software products to perform such a method. The method comprises, in some examples, the following steps or stages:
(a) provide a data set 100, which is configured for training of a machine learning model 1875. The data set includes a plurality of data sub-sets 315, 617, and each data sub-set comprising a plurality of data instances x1, x2;
(b) providing a coreset tree 1400, which is computed from the data set 100, and which comprises a plurality of coresets C7, C4. Each leaf coreset C5 of the tree is based on a corresponding data sub-set 619;
(c) removing one or more data instances x19 from one or more data sub-sets 619. This action generates, from the data sub-set(s) 619, at least one reduced data sub-set(s) 619′;
(d) setting one or more leaf coresets C5 of tree 1400, corresponding to the reduced data sub-set(s) 619′, to constitute invalid leaf coreset(s) C5;
(e) selecting a defined tree level (e.g. Level 1) at which training of the machine learning model will be performed;
(f) for each invalid leaf coreset C5, performing the following:
   i. recomputing each invalid leaf coreset, thereby giving rise to corrected leaf coreset(s) C5′; and
   ii. recomputing at least all ancestor coresets C6, C7 of the corrected leaf coreset C5′ that are at the defined tree level (i.e. Level 1) or are lower (Level 2) than is the defined tree level (Level 1), thereby giving rise to a modified coreset tree 1400′. The modified coreset tree 1400′ comprises modified ancestor coreset(s) C6′, C7′ and corrected leaf coreset(s) C5′.

For at least one such ancestor coreset, the recomputing comprises recalculating an importance measure for at least one coreset sample of the all ancestor coresets. (The importance measure is indicative of at least one of an importance value and a weight value.)
(g) selecting, from the modified coreset tree 1400′, coresets (e.g. C3+C6′, or C1+C2+C6′) that are representative of the data set exclusive of the removed at least one instance data instance, wherein at least one selected coreset C6′ is located at the defined tree level (Level 1). These selected coresets are referred to herein also as a representative sub-set C3+C6′ of the coresets of the modified coreset tree 1400′.
(h) training the machine learning model 1875 utilizing the selected coresets, giving rise to a trained machine learning model;
(i) performing one or more predictions for the removed data instance(s) x19, utilizing the trained machine learning model 1875; and
(j) evaluating model predictability metric(s), associated with the prediction(s), which is indicative of an ability of the trained learning model to correctly predict (e.g. classify) the at least one removed data instance(s) x19.

There are at least some additional example advantages of a special-cases evaluation methodology using coreset trees, as disclosed with reference to FIGS. 14, 15 and 18. Recall that in current methods, the special case data instances are removed from the training data set 100, training is done without those instances, the model is validated using a “train and test” methodology, and then the removed case(s) is tested. Ideally, the data scientist will find the edge cases, or other special cases, up front before training, and will take some or all of the cases out of training set 100. (Note: it is in some cases better to not to remove all such special cases, since, to train a good model, the training should include such cases.) However, these special cases are often not identified or found until the middle of training process.

For example, only after the training is done using data item x13, it is understood that it is in fact an edge case, and there is a desire that special, interesting or problematic point, to see if the model 1875 is good at catching such cases. That is, the point x13 is so important that the data scientist wants to both (1) train the model with it and (2) test the model's ability to predict that point (which requires training the model without it.) Such a process can be in some cases very expensive—the model must be retrained again without that point. If, for example, there are 200 such points, such a method would require 200 model trainings, which can be very difficult, very time-consuming and very expensive. That is, in the prior art, once a training set 100 is chosen with includes the special case data instance x13, it is problematic to perform such a method.

In addition, if there are only a relatively small number of edge or special cases, it is not wise to remove too many from the training set.

By contrast, using a coreset-tree based methodology, more flexibility for removing data instances later in the model creation process is possible, since the performance penalties are lower. Similarly, the method disclosed with reference to FIG. 14 enables, in a relatively efficient manner, the use of special cases in the training set, as well as there removal and their prediction by the model.

Attention is now drawn to FIG. 15, schematically illustrating an example generalized view 1500 of prediction for data instances, in accordance with some embodiments of the presently disclosed subject matter. Illustration 1500 illustrates conceptually an alternate implementation of prediction for specific data instances, utilizing a trained machine learning model 1875.

As was seen in FIG. 14, if e.g. x10, x13 and x19 are deleted from data set 100, all of leaf coresets C2, C4 and C5 must be recomputed. Also, if training is performed e.g. using C3+C6, both of these coresets must be recomputed as well. FIG. 15 illustrates a variation of the method, which can in some cases provide additional efficiency improvements. In FIG. 14, the special data instances of interest might be randomly distributed within the data set 100, and thus appear in multiple sub-sets 615, 619, possibly in all of the sub-sets. This may be the best that can be achieved, if there are a relatively large proportion of data instances x13 for which model predictability is to be evaluated, or if the method is being utilized to perform “leave one out” cross-validation.

However, if evaluation is to be performed for relatively few instances of data set 100, e.g. evaluation is being performed for only a few rare classes or edge cases, the alternate coreset tree architecture 1500 can be utilized. The data set 100 is arranged, or re-arranged, to that the special data points are placed, or moved, to one or more dedicated sub-sets 1520. That is, the method comprises grouping data instance(s) x10, x13 into at least one additional sub-set 1520. In the example, these sub-sets 1520 in aggregate contain all of, or most of, the special data instances x10, x13, x19. One or more corresponding leaf coresets are computed for these dedicated sub-sets.

In the example of the figure, existing coreset tree C1 through C7 is modified. Those data instances, for which evaluation be performed, are re-allocated or assigned to a new or additional sub-set 1520.

New coreset C8 is computed from this sub-set 1520. New coreset C8 is “attached” to the tree as needed, using e.g. known per se methods.

Existing leaf coresets C2, C4, C5 are recomputed, to derive corrected coresets C2′, C4′, C5′. Parent coresets C3, C6 and C7 are in turn recomputed to C3′, C6′ and C7′, to reflect the movements of the data instances.

Now, when the iterations of training and iterations are performed, fewer re-computations have to occur. For example, in the first iteration, x13 is removed from sub-set 1520. New leaf coreset C8, now invalid, is re-computed a first time, resulting in corrected coreset C8′. Training is done e.g. on C3′ and C6′, after C6′ is recomputed again to C6″. If training is at root level, also C7′ will be recomputed to C7″. After prediction of x13 and evaluation of metrics, x13 is then restored to sub-set 1520, and the tree 1500 is restored. In the second iteration, x10 and x19 are removed from 1520, C8 is recomputed yet again to C8″, and training is to be done e.g. at C3′ and C6′, or at C7′, after C6′ (and perhaps C7′) is recomputed again to C6′″ (and perhaps C7′″). (No reference designations of C6′″ and C7″′ appear in the figure, for clarity of exposition.)

Note that in the method of FIG. 15, only C8 and its ancestor(s) C6, C7 need be re-computed in every iteration. There is no need to recompute the other leaf coresets C1, C2′, C4, C5 regularly, since in this method they are not impacted by the repeated data instance removals. Similarly, there is no need to regularly recompute C3′, since the children of C3′ are not impacted by the repeated data instance removals. By contrast, in the FIG. 14 method certain of the other leaf coresets C1 to C5 would be repeatedly recomputed, and restored, as data instances are added and removed from data set 100. Moreover, when training above the leaf Level 3, there will be a need to repeatedly recompute and restore internal nodes such as C3′. For example, in a case where x13, x16 and x18 are to be each removed separately from the data set 100′, it is more efficient to assign them all at once to C8, and to recompute C4 to C4′ once, rather than removing each separately from sub-sub-set 617′, and having to recompute C4 three different time to C4′, C4″ (not shown) and C4′″ (not shown).

That is, since for the special data instances a new node C8 was created, all of the computational work can be performed on that node and its ancestors, without disturbing and affecting the rest of the tree. Thus, the method can facilitate the minimizing of the computational effort of the repeated recomputing of invalid leaf coresets, and of the recomputing of the ancestor coresets. In some examples, there is less impacts also in terms of index processing etc. to repeatedly add and remove the various data instances to/from sub-sets. Thus, fewer adjustments to the tree 1500 and to the sub-sets are required. In the above example, only sub-set 1520 is constantly being adjusted.

Attention is now drawn to FIG. 16, schematically illustrating an example generalized schematic diagram 1800 of a computerized machine learning system 1800, in accordance with some embodiments of the presently disclosed subject matter. In some non-limiting examples, computerized system 1800 includes a computer. It may, by way of non-limiting example, comprise a processing circuitry 1820. This processing circuitry may comprise a processor 1830 and a memory 1825.

This processing circuitry 1820 may be, in non-limiting examples, general-purpose computer(s) specially configured for the desired purpose by a computer program stored in a non-transitory computer-readable storage medium. They may be configured to execute several functional modules in accordance with computer-readable instructions. In other non-limiting examples, this processing circuitry 1820 may be a computer(s) specially constructed for the desired purposes.

Example uses of these modules are disclosed further herein, with reference to the flowchart FIGS. 17 and 18.

In some examples, computerized data cleaning system 1800 comprises an external interface 480, enabling communications with external devices/systems 490, and or providing a user interface to a human user 490, e.g. a data scientist or other domain expert. An example, it can interface to training system 1800, to receive identified problematic selected coreset samples 1544 or data instances 420 for analysis. In some examples, this interface is used by user 490 or external system 490 to perform actions on analyzed coreset samples or data instances which need action, e.g. updating labels, deleting samples etc.

Turning now to processor 1830 of processing circuitry 1820, in some examples it comprises input module 460. In some examples, module 460 is configured to receive input from e.g. human user 490, e.g. using external interface 480—e.g. instructions which models to train, and using how many groups to cross-validate. Another example input to the system 1800, by data scientist 490, is cleaning/corrections to specific problematic data instances 420 residing e.g. in stored data set 410, 473.

In some examples processor 1830 comprises output module 465. In some examples, module 465 is configured to provide output to e.g. human user 490 or external system 490, e.g. using external interface 480. Example outputs are various calculated quality metrics, and possibly problematic data instances 420 that require especial handling. In some examples processor 1830 comprises coreset computation module 432. In some examples, module 432 is configured to compute one or more coresets 200, e.g. comprised in a coreset data structure 300, 400, 600, 1300, 1400, 1500, e.g. a coreset tree. The module can also be used to recompute coresets C41′ as needed, including recalculation of importance measures such as importance and weight.

In some examples processor 1830 comprises branch detach/attach module 1834. In some examples, module 1834 is configured to detach one or more branches C18 from coreset tree 1300. In some examples module 1834 is configured to re-attach one or more branches C18 to the tree. In some examples, this module also stores and restores coreset tree configurations. In other examples, a separate module(s), not shown, performs the storing and/or restoring functionalities.

In some examples processor 1830 comprises data instance removal/restoral module 1840. In some examples, module 1840 is configured to remove one or more data instances x13, x19, e.g. for edge cases, from coreset tree 1400. In some examples module 1840 is configured to restore removed data instance(s) x13, x19 to the tree. In some examples, this module also stores and restores coreset tree configurations. In other examples, a separate module(s), not shown, perform the storing and/or restoring functionality.

In some examples, this module also performs the re-arrangement of data instances to a separate group(s), e.g. as disclosed with reference to FIG. 15. In other examples, a separate module(s), not shown, performs the functionalities disclosed with reference to FIG. 15.

In some examples processor 1830 comprises training module 452. In some examples, module 452 is configured to train, or re-train, the machine learning model(s) 1875, after the branch detachment or data instance removal actions are performed. The training can, in some implementations, utilize the relevant selected coreset(s), as disclosed elsewhere herein.

In examples other than that of the figure, the training is performed on a separate system, which receives the relevant training data from system 1800. An external training system 490 is an example of external system 490, interfacing with system 1800 using the components, 480, 460, 465. In such examples, training module 452 is not required.

In some examples processor 1830 comprises model quality evaluation module 1843. In some examples, module 1843 is configured to evaluate quality metric(s) for each iteration of cross-validation, e.g. per FIGS. 13 and 17. In some examples, the module is configured also to determine overall quality metrics for the cross-validation process.

In examples other than that of the figure, the model quality evaluation, is performed on a separate system. External evaluation system 490 is an example of external system 490, interfacing with system 1800 using the components, 480, 460, 465.

In some examples processor 1830 comprises instance prediction and evaluation module 1835. In some examples, module 1835 is configured to perform prediction for removed data instance(s), e.g. for edge cases, e.g. per FIGS. 14 and 18. In some examples, the module is configured also to evaluate model predictability metric(s), associated with the at least one prediction(s). In other examples, separate modules perform the prediction and the evaluation of the model predictability metric(s).

In examples other than that of the figure, the prediction, and/or the evaluation of the model predictability metrics, are performed on a separate system. External evaluation system 490 is an example of external system 490, interfacing with system 1800 using the components, 480, 460, 465.

In some examples processor 1830 comprises repetition module 1848. In some examples, module 1848 is configured to determine whether or not to repeat the process of e.g. branch detachment/data instance removal, training and evaluation actions, based on whether one or more process-termination criteria are met, e.g. based whether cross-validation has been completed, or whether a quality evaluation has been performed for all relevant edge cases. In some examples, repetition module 1848 is the same as, or is similar to, repetition module 448 of FIG. 7, in some cases perhaps utilizing different criteria than those of e.g. the flows of FIGS. 8 and 12.

In some examples, memory 1825 of processing circuitry 1820 is configured to store data associated with the training process, e.g. comparatively transitory data. Non-limiting examples of data stored include: number of groups samples or data instances to use in cross-validation, the level(s) at which branches should be detached, the level(s) at which training should be performed, various criteria parameters, evaluated quality parameters and metrics etc.

In some examples, memory 1825 is configured to store coreset tree configurations 1828, so that they can be restored after an iteration, or after each iteration. For example, the tree structure can be stored, with pointers to data stored in the data store. In some examples, this information 1828 is instead stored in data store 1870.

In some examples, the machine learning model 1875 that is to be trained resides in memory 1825.

In some examples, the coreset data structure 1877, the hyperparameters (not shown), and/or machine learning model 1875, is stored in memory 1825.

In some examples, the memory 425 of data cleaning system 700 of FIG. 7 is the same as, or is similar to, the memory 1825 of FIG. 7, and system 700 comprises components 1828, 1877 and/or 1875.

In some examples, data cleaning system 1800 comprises data store 1870. In some examples, more long-term and persistent data is stored in the data store. Non-limiting examples shown include the stored full dataset 473, corresponding to e.g. dataset 100, 410, and coreset data structure 1877, corresponding to e.g. coreset data structure 300, 400, 600, 1300, 1400, 1500. In some examples, hyperparameters (not shown) associated with the model 1875 are stored in data store 1870.

In some other examples, e.g. as shown in this figure, coreset data structure 1877 is instead stored in memory 1825.

In some examples, coreset data structure 1877 is the same as, or is similar to, coreset data structure 477 of FIG. 7.

Another example is cleaning set/high importance set data structure 479, not shown in FIG. 16 (purely for ease of exposition), but shown in in the example schematic architectures of FIGS. 7 and 20.

In some examples, datastore 1870 is the same as, or is similar to, datastore 470 of FIG. 7. In other examples, in which the training occurs externally to system 1800, also the ML model 1875 can be stored externally.

In some examples, system 1800, its processing circuitry, processor, and/or memory etc., is the same as, or is similar to, data cleaning system 700 of FIG. 7, but with the additional functional modules and components described with reference to FIG. 16.

Note that interface components 480, 460, 465, shown in FIG. 16 as being identical to those of FIG. 7, in some cases are not identical to those of FIG. 7, but rather have differences required to perform the functions of FIGS. 17 and 18. The same possibility is true also for the interface components 2280, 2260, 2265 shown for FIG. 20—they may or may not be identical to the corresponding components of FIGS. 7 and/or 16. The same possible implementation options apply also to coreset computation module 432 and training module 452.

Attention is drawn to FIGS. 17A-17C, schematically illustrating a generalized flow chart diagram 1700, of a flow of a process or method, for machine learning model training, in accordance with some embodiments of the presently disclosed subject matter. This training process 1700, e.g. a cross-validation process, is, in some examples, carried out by systems such as those disclosed with reference to FIG. 16. The flow 1700 starts at 1905 of FIG. 17A.

According to some examples, a dataset 100, 410 is received (block 1905). In some examples, the data set is received from an external system 490, e.g. via external interface 480. In some examples, the dataset is stored 473 in datastore 1870.

According to some examples, one or more coresets are computed (block 1910). In some examples, this is performed utilizing coreset computation module 432. As part of the computation, in some examples, importance measures (e.g. importance/sensitivity and/or weight) are computed in this block. In some examples, the coresets are structured in a coreset data structure 300, 400, 600, 1300, 1400, 1500, e.g. a coreset tree.

Block 1910 can be skipped in some examples, if the coreset tree 600, 1300 was previously computed as part of a different process.

According to some examples, the coreset tree 600, 1300, computed from data set 410, is provided to system 1800 (block 1915). In some examples, e.g. in which the coreset tree was computed external to system 1800, this block is performed utilizing external system 490, interface 480 and input module 460. In some other examples, the coreset tree already resides 1877 in data store 1870, or in memory 1825.

According to some examples, the tree level at which one or more branches will be detached is selected or otherwise determined (block 1920). This tree level is referred to herein also as the first tree level. In some examples, this is performed by branch attach/detach module 1834. In some examples, the value of this level is configured data, e.g. in memory 1825. In some examples, the level is dependent on the branch to be detached, while in other examples the level is the same for all iterations.

According to some examples, the tree level, a defined tree level, associated with the training of the machine learning model, is selected or otherwise determined (block 1930). This tree level is referred to herein also as the second tree level. For example, this is the level at which model training will be performed, or the level of the highest representative coreset to be used in the training, e.g. as disclosed with reference to FIG. 13. In some examples, several second levels may be used for training (for example, training using C31, C23 and C17, as representative of data 1519+1517+1511).

In some examples, this is performed by branch attach/detach module 1834, or by training module 452. In other examples, another module, e.g. one not shown in FIG. 16, is utilized. In some examples, the value of this second tree level is configured data, e.g. in memory 1825.

According to some examples, at least one branch of the coreset tree 1300 is detached (block 1935). In some examples, this is performed by branch attach/detach module 1834. For example, branch C18 is detached, or branch C24+C17+C18 is detached. This detaching gives rise to a reduced coreset tree that is exclusive of the detached branch(es) C24+C17+C18, and which comprises remaining coresets of the plurality of coresets. The remaining coresets are representative of the remaining portion 1519+1517+1511 of the data set 410.

According to some examples, at least one coreset C31, C23, which is representative of the remaining portion 1519+1517+1511 of the data set, is selected from the reduced coreset tree (block 1938). At least one of these selected coreset(s) is located at the second tree level (of block 1930). In some examples, this is performed by branch attach/detach module 1834. In other examples, another module, e.g. one not shown in FIG. 16, is utilized.

According to some examples, a determination is made, whether or not the second tree level (e.g. Level 2), associated with the training, is higher than the first tree level(s) (e.g. Level 3) associated with the particular detached branches (block 1940). In some examples, the determination in block 1940 is whether or not there are ancestor coresets C32 of each detached branch C24 which are part of the selected coresets C31, C32 which will be used in training the model 1875. In some examples, this is performed utilizing branch attach/detach module 1834. In other examples, another module, e.g. one not shown in FIG. 16, is utilized.

Responsive to a determination of No at block 1940, the flow proceeds I directly to block 1960 on FIG. 17B. This block is disclosed further herein.

Responsive to a determination of Yes at block 1940, the flow proceeds H to block 1950 on FIG. 17B.

According to some examples, a configuration of all or part of coreset tree 1300 is stored (block 1950). In some examples, this is performed by branch attach/detach module 1834. In other examples, another module, e.g. one not shown in FIG. 16, is utilized. Note that in some examples, block 1950 is instead performed at a stage that is prior to the detaching at block 1935. Note also that some implementations do not include this step 1950.

According to some examples, at least all ancestor coresets C32 of the detached branch(es) C24, which are at the second tree level or are lower than is the second tree level, are recomputed (block 1955). In some examples, this is performed by coreset computation module 432, e.g. per instruction by branch attach/detach module 1834.

In some examples, this block 1955 comprises recomputing at least all ancestor coresets C41 of each detached branch(es) C24 which are part of the selected coresets C41 which will be used in training the model, as well as recomputing those ancestor coresets C32 located between this selected ancestor coreset C41 and the detached branch C24.

In some examples, for at least one ancestor coreset C32, the recomputing includes recalculating an importance measure for at least one coreset sample 1560. The importance measure being indicative of at least one of an importance value and a weight value of the coreset sample 1570. This in some cases gives rise to a modified reduced coreset tree comprising a modified selected coreset(s) C32′.

In some examples, as a preparation for the next block 1960, the modified selected coreset(s) C32′ is set to constitute the selected coreset(s).

According to some examples the machine learning model 1875 is trained, utilizing the selected coreset(s) (block 1960). As disclosed above, examples of the selected coreset(s) are root coreset C41 (or C41′, if it was modified), and coresets C31 and C32 (or C32′, if it was modified). This block gives rise to a trained machine learning model 1875. In some examples, this is performed by model training module 452.

According to some examples the model quality, associated with an ability of the trained machine learning model to perform prediction, is evaluated (block 1965). In some examples, this block utilizes the detached branch(es) C24. The detached branch (e.g. the data sub-set 1515, or coresets C17, C18 or C24, depending on the particular implementation) is run on the trained model 1875, and a prediction is performed for the branch data. In some examples, this is performed utilizing model quality evaluation module 1843.

According to some examples model quality, one or more quality metrics, associated with the evaluation of block 1965, are generated (block 1970). In some examples, this is performed utilizing model quality evaluation module 1843.

Note that in some examples, blocks 1965 and 1970 are combined.

The flow continues J to block 1975 on FIG. 17C.

According to some examples, a determination is made, whether or not problematic data instances 420 have been identified (block 1975). In some examples, this is performed utilizing model quality evaluation module 1843. In other examples, another module, e.g. one not shown in FIG. 16, is utilized.

Responsive to a determination of No at block 1975, that problematic data instances have not been identified, the flow proceeds to block 1985. This block is disclosed further herein.

Responsive to a determination of Yes at block 1975, that problematic data instances have been identified, the flow proceeds to block 1980. According to some examples, an action is taken with regard to problematic data instances 420 (block 1980). In some examples, this is performed utilizing model quality evaluation module 1843. In other examples, another module, e.g. one not shown in FIG. 16, is utilized. One example action is the deletion, from the data set 410, the identified problematic data instance(s) 1550, 420. A second example action is marking, for cleaning, the identified problematic data instance(s) 420. In some examples, the cleaning of the marked instances is performed by a human data scientist 490, utilizing either modules (not shown) of system 1800, or utilizing an external system, also referenced here as 490. In some examples, the cleaning is not part of the training and cross-validation process 1700, but rather is external to it.

In some examples, the model 1875 is re-trained and/or cleaning, after deletion, if re-training needed to improve its quality. This can in some examples include recomputing of the relevant selected coresets, which contain the problematic data and are used for the training of the model in this iteration of the process 1700. This re-training action is shown in the figure as part of block 1980, but it can in other examples be a separate block of process 1700, or even can be external to process 1700.

In other implementations, not shown in the figure, blocks 1975 and 1980 are not performed.

According to some examples, the coreset tree 1300 is restored (block 1985). In some examples, this is performed utilizing branch detach/attach module 1834. In some examples, another module, not shown in FIG. 16, is utilized. In some examples, the restoral includes reattaching the detached branch(es) C24. In some examples, the restoral includes restoring the importance measure of the coreset sample(s) whose importance measure values had been re-calculated per block 1955. In implementations in which the coreset tree configuration had been stored per block 1950, this block 1985 includes restoring the stored coreset tree configuration.

In some examples, this restoral block 1985 is not implemented. However, it can be important to facilitate an accurate cross-validation.

According to some examples, a determination is made, whether or not other one or more process-termination criteria are met (block 1990). For example, the criterion can be whether all relevant branches have been detached, and whether they have all been used for validation. For example, the criterion can be “have all groups been cross-validated?”, in the case of a process for full cross-validation. In some examples, this is performed utilizing repetition module 1848 or quality evaluation module 1843.

Responsive to a determination at block 19890 that No, the process-termination criteria are not met, in some examples the flow proceeds to block 1992. According to some examples, one or more other branches are selected for detaching (block 1992). In some examples, this is performed utilizing repetition module 1848 or branch attach/detach module 1834. For example, if in iteration #1 branch C24 was detached, in iteration #2 branch C23 (including sub-nodes C15 and C16) is selected for detachment. The process then, in one example implementation, proceeds K back to FIG. 17A, looping back to e.g. block 1920, in respect of the branch(es) newly selected for detachment.

Responsive to a determination at block 1980 that Yes, the process-termination criteria are met, the flow proceeds to block 1995. According to some examples, a total quality metric is generated (block 1995). In some examples, this is performed utilizing quality evaluation module 1843. In some examples, the total quality metric is indicative of the one or more quality metrics generated in the various iterations of block 1970. In some other examples, no total quality metric for the model 1875 is generated.

In some examples, the metrics of blocks 1970 and/or 1995 are output to an external user or system 490. This output step is not shown in the figure. For example, output module 465 and external interface 480 can be used.

In some examples, not shown in the drawing, blocks 1975 and 1980 are performed again, after block 1990. In some examples, blocks 1975 and 1980 are performed only after block 1990.

The flow proceeds to block 1998, the end of the process. The model training, including evaluation, has been completed.

Attention is drawn to FIGS. 18A-18C, schematically illustrating a generalized flow chart diagram 1802, of a flow of a process or method, for performing prediction for data instances, in accordance with some embodiments of the presently disclosed subject matter. This process 1802, e.g. an edge-case-validation process, is, in some examples, carried out by systems such as those disclosed with reference to FIG. 16. The flow 1802 starts at 2005 of FIG. 18A.

According to some examples, a dataset 100, 410 is received (block 2005). In some examples, the data set is received from an external system 490, e.g. via external interface 480. In some examples, the dataset 473 is stored in datastore 1870.

According to some examples, one or more coresets are computed (block 2010). In some examples, this is performed utilizing coreset computation module 432. As part of the computation, in some examples, importance measures (e.g. importance/sensitivity and/or weight) are computed in this block. In some examples, the coresets are structured in a coreset data structure 300, 400, 600, 1400, 1500, e.g. a coreset tree.

Block 2010 can be skipped in some examples, if the coreset tree 1400, 1500 was previously computed as part of a different process.

According to some examples, the coreset tree 1400, 1500, computed from data set 100, 410, is provided to system 1800 (block 2015). In some examples, e.g. in which the coreset tree was computed external to system 1800, this block is performed utilizing external system 490, interface 480 and input module 460. In some other examples, the coreset tree already resides 1877 in data store 1870, or in memory 1825.

According to some examples, the instance(s) x10, x13, x19 to be removed and predicted are grouped into at least one additional sub-set 1520 (block 2020). This step is optional, and it is performed in implementations such as those disclosed with reference to FIG. 15. In some examples, this is performed by data instance removal/restoral module 1840, or by another module, e.g. one not shown in the figure.

According to some examples, a configuration of all or part of coreset tree 1400, 1500 is stored (block 2023). In some examples, this is performed by data instance removal/restoral module 1840. In other examples, another module, e.g. one not shown in FIG. 16, is utilized. Note that in some examples, block 2023 is instead performed at a stage that is prior to block 2020. Note also that some implementations do not include this step 2023.

According to some examples, at least one data instance x13 is removed from one or more data sub-sets 617 (block 2025). One or more reduced data sub-sets 617′ are thereby generated, from the at least one data sub-set 617. In some examples, this is performed by data instance removal/restoral module 1840.

According to some examples, leaf coreset(s) C4, corresponding to the reduced data sub-set 617′, are set to constitute now invalid leaf coreset(s) C4 (block 2030). In some examples, this is performed by data instance removal/restoral module 1840.

According to some examples, a defined tree level, associated with the training of the machine learning model, is selected or otherwise determined (block 2035). This tree level is referred to herein also as the third tree level. For example, this is the level at which model training will be performed, or the level of the highest representative coreset to be used in the training, e.g. as disclosed with reference to FIGS. 14-15. In some examples, several levels may be used for training (for example, training using C1+C2+C6). In some examples, this step is performed by data instance removal/restoral module 1840, or by training module 452. In other examples, another module, e.g. one not shown in FIG. 16, is utilized. In some examples, the value of the third tree level is configured data, e.g. in memory 1825. In some examples, this block is performed at a different part of the flow, e.g. after step 2015.

The flow proceeds L to block 2040 on FIG. 18B.

According to some examples, at least one coreset C4, C6 that is an ancestor of the reduced data sub-set(s) 617′ is recomputed, to reflect the removal of the data instance(s) x13 (block 2040). This thereby gives rise to a modified coreset tree 1400′, 1500′. In some examples, this is performed by core computation module 432.

In one non-limiting example implementation of this step, the following steps is performed for each invalid leaf coreset C4:
block 2040A (not shown separately)—the invalid leaf coreset is recomputed, thereby giving rise to a corrected leaf coreset C4′; and
block 2040B (not shown separately)—recomputing at least all ancestor coresets C6, C7 of the corrected leaf coreset which (i) are at the defined tree level (e.g. Level 1) or (ii) are lower than is the defined tree level (e.g. are at Level 2). Note that if no ancestors of the corrected leaf coreset(s) are used in the training, e.g. in a case where the training utilizes C1+C2+C4′+C5, block 2040B need not be performed.

For at least one of these ancestor coresets, the recomputing comprises recalculating an importance measure, for at least one coreset sample.

According to some examples, at least one coreset C3, C6′, which is representative of the reduced data set 100′, is selected from the modified coreset tree 1400′, 1500′ (block 2050). At least one of these selected coreset(s) is located at the defined tree level (defined in block 2035). In some examples, this is performed by data instance removal/restoral module 1840. In other examples, another module, e.g. one not shown in FIG. 16, is utilized.

According to some examples the machine learning model 1875 is trained, utilizing the selected coreset(s) (block 2055). This block gives rise to a trained machine learning model 1875. In some examples, this is performed by model training module 452.

According to some examples one or more predictions, for the removed data instance(s) x13, are performed, utilizing the trained machine learning model 1875 (block 2057). The removed data instance(s) x13 is run on the trained model 1875, and a prediction is performed for it. In some examples, this is performed utilizing instance prediction and evaluation module 1843.

According to one or more model predictability metrics, associated with prediction(s) of block 2057, are evaluated (block 2060). These metrics are indicative of an ability of the trained learning model 1875 to correctly predict the removed data instance(s) x13. In some examples, this is performed utilizing instance prediction and evaluation module 1843.

The flow proceeds M to block 2065 on FIG. 18C.

According to some examples, the removed data instance(s) x13 is restored (block 2065). In some examples, this is performed utilizing data instance removal/restoral module 1840.

According to some examples, the coreset tree 1400, 1500 is restored (block 2070). In some examples, this is performed utilizing data instance removal/restoral module 1840. In some examples, another module, not shown in FIG. 16, is utilized.

In some examples, where relevant, the restoral includes restoring the importance measure of the coreset sample(s) whose importance measure values had been re-calculated per block 2040. In implementations in which the coreset tree configuration had been stored per block 2023, this block 2070 includes restoring the stored coreset tree configuration.

In some examples, this restoral block 2070 is not implemented.

According to some examples, a determination is made whether or not an evaluation of metrics has been performed for all relevant data instances (block 2080). In some examples, this is performed utilizing repetition module 1848 or data instance and prediction evaluation module 1835. For example, if there is a desire or need to evaluate the model relative to all of x13, x10 and x19, and evaluation has been performed only in respect of x13, there is a need to perform a repetition of the process.

Responsive to a determination at block 2080 that No, an evaluation of metrics has not been performed for all relevant data instances, in some examples the flow proceeds to block 2085. According to some examples, one or more other data instances x10, x19 are selected for removal and evaluation (block 2085). In some examples, this is performed utilizing repetition module 1848 or data instance removal/restoral module 1840. For example, if in iteration #1 data instance x13 was removed, and evaluation performed for it, in iteration #2 data instances x10 and x19 are selected for removal and evaluation. The process then, in one example implementation, proceeds N back to FIG. 18A, looping back to e.g. block 2025, in respect of the data instance(es) newly selected.

That is, the process is repeated in respect of at least one other data instance. In the repetition, the at least one other data instance is set to constitute the at least one data instance.

Responsive to a determination at block 2080 that Yes, an evaluation of metrics has been performed for all relevant data instances, the flow proceeds to block 2090. According to some examples, one or more overall metrics are generated (block 2090). In some examples, this is performed utilizing data instance prediction and evaluation module 1835. In some implementations, the system generates overall metrics for each group of special cases, based on the prediction success for each special case in the group. The overall metric can, for example, apply to a particular shared feature(s). In some other examples, no overall metrics for the model 1875 are generated, and block 2090 is not performed.

In some examples, the metrics of blocks 2060 and/or 2090 are output to an external user or system 490. This output step is not shown in the figure. For example, output module 465 and external interface 480 can be used.

The flow proceeds to block 2095, the end of the process 1802. The model training, including evaluation of ability to predict the edge or other special cases, has been completed.

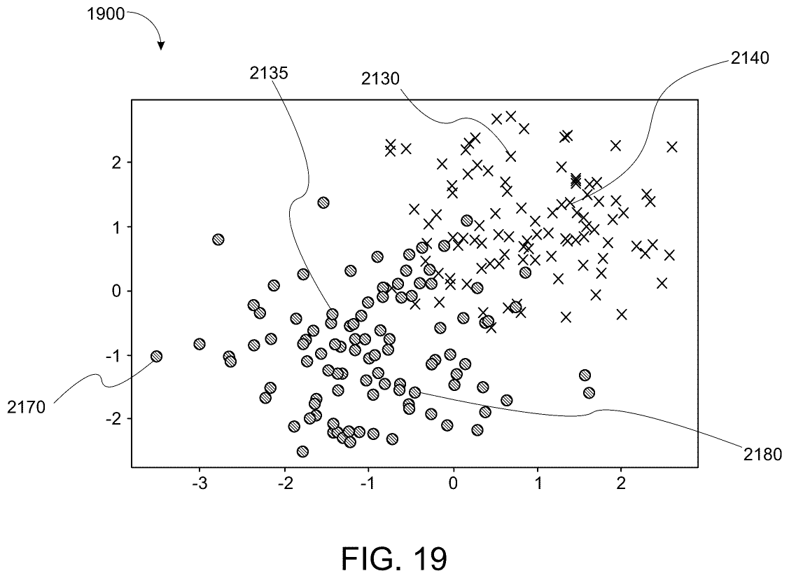

Attention is drawn to FIG. 19, schematically illustrating an example generalized view of a dataset, in accordance with some embodiments of the presently disclosed subject matter. View 1900 depicts a conceptual view of an example data set comprising a plurality of data instances 2130, 2135, 2140, 2170, 2180. The view is presented to illustrate several concepts related to data sets used in the training machine learning (ML) models. As in FIG. 1, these data instances are referred to herein also as samples or data points. Note that the presently disclosed subject matter is relevant for neural networks, as well as for other machine learning models/architectures.

The figure illustrates example cases in which automated cleaning processes can be advantageous.

In the non-limiting example of the figure, the data instances are associated with two classes, e.g. images of dogs and images of cats. In this figure, circles represent data instances with classification “cat”, and they are thus typically labelled “cat” (unless there are labeling errors). Crosses/X's represent data instances with classification “dog”, and they are thus typically labelled “dog”. Point 2130 is a typical example data instance of “cat”, and it is labelled as such. Point 2135 is a typical example data instance of “dog”, and is it labelled as such. In other examples, there are more classes. The figure presents only a simplified case, for ease of exposition. The “border” between the cat and dog points comprises those points, for which the associated image has features similar to both classes, and thus is difficult for the model to distinguish.

By contrast, example point 2170 corresponds to the image of a lion. The ML model, not having a class defined for “lion”, incorrectly labelled the image as a cat. It can be seen, that the point is an outlier, and it is not within the typical distribution of “cat” points. It is referred to herein as an Out of Distribution (OOD) data instance. In an intuitive sense, it can be seen, visually on the graph, that the lion point 2170 is far from the “border” between cat and dog images.

OOD point 2170 is a non-limiting example of an “abnormal” data point. It might be flagged for analysis by a data scientist, or by similar personnel, e.g. by methods such as those of FIGS. 8 and 12, which look for a high importance or low weight. However, in some cases, particularly in the model development stage, such a point is of interest mainly in theoretical ML optimization. Such a point is of relatively low priority for analysis by the human expert, from a practical point of view. Since this point is clearly more cat-like than dog-like (even though it is not a cat), there is comparatively little need to get the label “right” before training a model, the function of which is to distinguish the dog and cat classes. That is, there is little risk that the mislabeling of the lion as a cat will affect the ability of the model to distinguish between dogs and cats. Point 2170 thus contributes comparatively little to the ability of the model to determine the “border” between the dog and cat classes. A prediction by the model, trained without this point, will show that, with very high probability, it is a cat (and not a dog.) It thus has minimal impact on training the model.

Note that the images (in the example) which are of more value for inclusion in the model training set are those closer to the conceptual “border” between the classes, e.g. images of dogs with a cat-like face, or small cat-size dogs such as chihuahuas.

Therefore, at least in the development stage, the system can be configured to automatically mark such a data instance as being unprioritized for review by a data-analysis user, that is as having a lower priority for review as compared to other data items. In some implementations, the data instance is marked as not requiring review by the data-analysis user. At the development stage, at least, there is no need to spend the effort to analyze and correct this data item/instance, since, as a practical matter, its correction will have little impact on the model training. In contrast to e.g. the processes of FIGS. 8 and 12, in this method the system is in this sense automatically filtering the data instances that are sent to the human user for manual evaluation. This can increase the efficiency of the human user, in that they need not spend effort analyzing and cleaning such data points. In terms of the “budget” of the work assigned the human user, it is more efficient to relieve them of the task of analyzing this data instance. Alternatively, marking it as unprioritized for analysis enables sending in its place a more relevant data instance for analysis, within the same work load budget.

Note that if the lion picture instead returned a prediction of 48% dog, 52% cat, it would be a “border case”, and should in fact be sent to the data scientist for analysis and possible cleaning.

On the other hand, in production, other actions can be taken. Consider again the case of an autonomous vehicle capturing an image of a lion, where the system has been trained on cats. If such an OOD instance is identified, the system can instruct the vehicle to behave differently, due to the object in its path not being a “typical cat”—e.g. to take slower actions or movement. More generally, the system can send an alert that there is an Out of Distribution situation.

Another production action can be to send the relevant data instance to the production data scientist, who can decide to look at it or not.

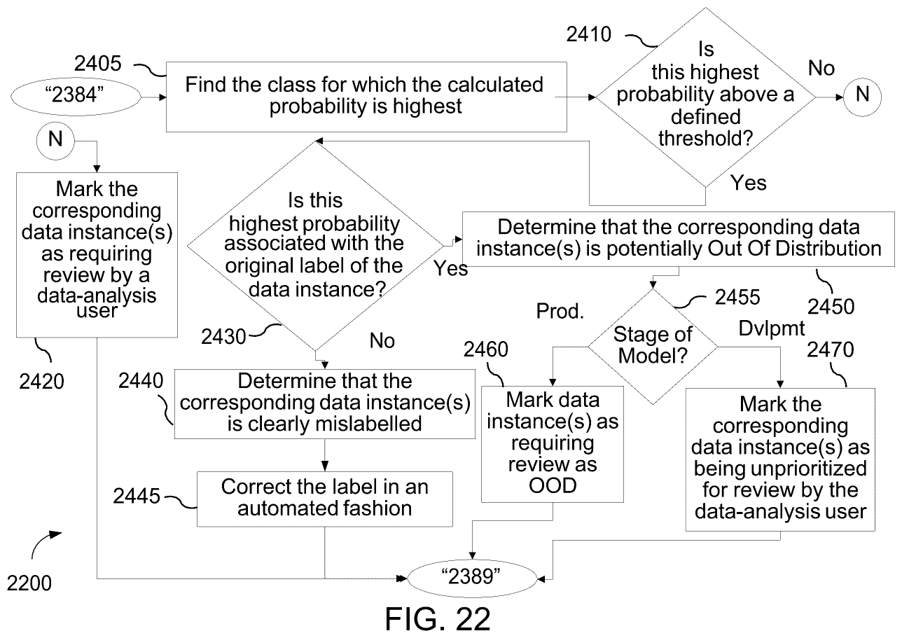

More detail on such actions is disclosed further herein with reference to FIG. 22. (The sending of alerts is not disclosed there, purely for ease of exposition.) Consider now points 2140 and 2180. Point 2140 corresponds to the image of a chihuahua dog. As can be seen intuitively in the distribution, it is very much a dog, in terms of its visual features, as would be determined by a ML model. However, in the example of the figure, the human user, who performed the labeling, worked quickly, saw the picture of a small dog, made a split-second decision, and mislabeled the image as a “cat”, since the user focused on the size rather than on other features of the animal. A prediction by the model, trained without this point, will show that, with very high probability, it is a dog (and not a cat.) Similarly, point 2180 represents the image of a cat, which was classified incorrectly (mislabeled) as a dog. A prediction by the model, trained without this point, will show that, with very high probability, it is a cat (and not a dog.)

Points 2140 and 2180, too, are examples of “abnormal” data points. They, too, might be flagged for analysis by a data scientist, or by similar personnel, e.g. by methods such as those of FIGS. 8 and 12, which notice a high importance or low weight. However, because of the above prediction which would clearly show that the point is mislabeled, that it is not a “border” case, in some examples the system can, with relative safety, autocorrect the label, rather than sending it to a human user 490 for analysis. Thus, better training data is obtained, even without requiring any human effort. The data cleaning is thus performed, at least partly, in an automated fashion, thus saving a certain percentage of the total data-cleaning effort required of the human data analysis user.

More detail on such actions is disclosed further herein with reference to FIG. 22.

Note that in both of the above cases, the system has taken an automated action to help clean the data set, without requiring the involvement and effort of the human data analysis user.

Note that the points mentioned are merely examples of such types of data instances. Similarly, there are other actions which the system can perform, to clean the data.

At least to provide such advantages, there is also disclosed herein a computerized method of cleaning a data set, as well as a computerized machine learning/data cleaning system 2200 and software products to perform such a method. The method comprises, in some examples, the following:
(a) providing the data set 410, 100. The data set is configured for training of a machine learning model 1875, and it comprises multiple data sub-sets. Each data sub-set comprising a plurality of data instances;
(b) providing a coreset tree 600, 1400. The coreset tree is computed from the data set, and it comprises a plurality of coresets C11, C21. Each leaf coreset C11 of the coreset tree is based on a corresponding data sub-set;
(c) selecting a number of data items 546, 1146 from the data set that have a relatively high likelihood of abnormal data, as compared to a second likelihood of abnormal data associated with at least some other data items of the data set. This thereby generates one or more cleaning-candidate identification sets;
(d) removing at least one corresponding data instance x10, corresponding to at least one data item of the selected number of data items, from at least one data sub-set. This thereby generates, from the data sub-set(s) 615, at least one reduced data sub-set 615′;
(e) recomputing at least one coreset C2, C3 that is an ancestor of the at least one reduced data sub-set, to reflect the removal of corresponding data instance(s). This thereby gives rise to a modified coreset tree 1400′, 1500′;
(f) selecting, from the modified coreset tree 1400′, 1500′, coresets C3′, C6 that are representative of the data set exclusive of the removed corresponding data instance(s);
(g) training the machine learning model 1875, giving rise to a trained machine learning model 1875;
(h) performing at least one prediction for the removed corresponding data instance(s) x10, utilizing the trained machine learning model;
(i) evaluating one or more model predictability metrics, associated with the at least one prediction, which are indicative of an ability of the trained learning model 1875 to correctly predict removed corresponding data instance(s) x10;
(j) based on at least the one or more model predictability metrics, perform an action which is configured to bring about an increased-quality data set 100′, as compared to a quality of the original data set 100.

In some cases, this increased-quality data set facilitates at least one of a quicker training of the machine learning model and a higher-accuracy training of the machine learning model, as compared to a second training of the machine learning model performed utilizing the data set.

Note that in some implementations, the above steps (d) through (j) are similar to, or the same as, steps disclosed with reference to FIGS. 14, 15 and 18.

In some examples, the action is to send the data to a human user 490 for further analysis.

In some example situations, the abnormal data is one of mis-labelled data, out of distribution data or strange data. The term “strange data” refers herein to data like, for example, an image of a dog or cat in a costume; or an image captured not in the normal view (e.g. the reflection of a dog in a fish aquarium—since computer vision has problems with such images). That is, these are images of a particular object which are not straightforward images of the object as is. This is of course merely an illustrative example.

Such strange data will typically need a data scientist to evaluate it, and to decide whether or not to use it in the training set. Coresets might be able to identify such data, but the system in some cases might not be able to do any automated action with it. Thus, strange data is an example of the identified data that is sent on to human, without an automated action. In some cases, the probabilities derived by a prediction for a strange data instance may be unclear, that is with probability not above a threshold. That is, in such a case the prediction is not distinctly in favor of any particular class. In some other cases, strange data appears as Out of Distribution.

“Abnormal data” is also referred to herein as “possibly problematic data”, in the sense that it might be possibly problematic to use the particular data instance x10 in the training set (although the system may not be sure that its use is problematic).

In some examples, the selecting, from the data set, the number of data items which have a relatively high likelihood of abnormal data, comprises selecting a number of data items from the data set based on at least one importance-related criterion. The importance-related criteria are indicative of high importance values, and/or low weight values, associated with the plurality of data instances. In some examples, this selection utilizes step 830 of FIG. 8 (“coreset based selection”), and/or the steps 1223, 1229 of FIG. 12 (“cleaning set based selection”). Note that in some examples, instead of selecting based on high importance, the system can select based low weight, since weight (although not always) is often roughly reciprocal/inversely proportional to importance/sensitivity. More details of examples of the selection are disclosed further herein with reference to FIG. 12.

Thus there is also disclosed herein a computerized method of cleaning a data set, as well as a computerized machine learning/data cleaning system 2200 and software products to perform such a method, where the method comprises the following:
(a) providing the data set, where the data set is configured for training of a machine learning model. The data set comprising a plurality of data sub-sets, and each data sub-set comprises a plurality of data instances;

(b) providing a coreset tree, where the coreset tree is computed from the data set. The coreset tree comprises a plurality of coresets. Each leaf coreset of the coreset tree is based on a corresponding data sub-set;
(c) selecting a number of data items from the data set based on at least one importance-related criterion,
thereby generating at least one cleaning-candidate identification set. The importance-related criteria are indicative of at least one of corresponding high importance values and low weight values, associated with the plurality of data instances.

The resulting cleaning-candidate identification set(s) comprise selected data items, which have a high probability of at least one of high importance values and low weight values, as compared to a second probability associated with selecting a corresponding number of data instances from the data set;
(d) removing at least one corresponding data instance x10, corresponding to at least one data item of the selected number of data items, from one or more data sub-sets,
thereby generating, from the at least one data sub-set, at least one reduced data sub-set.

In the case of non-coreset cleaning tree (e.g. per FIGS. 14, 15, 18), the data item is the selected data instance 1144. In the case of cleaning using a coreset tree (e.g. per FIGS. 6, 8), the data item is a coreset sample 1544;
(e) recomputing at least one coreset that is an ancestor of the at least one reduced data sub-set, to reflect the removal of the corresponding data instance(s) x10, thereby giving rise to a modified coreset tree;
(f) selecting, from the modified coreset tree, coresets that are representative of the data set exclusive of the at least one removed corresponding data instance;
(g) training the machine learning model 1875, giving rise to a trained machine learning model 1875;
(h) performing at least one prediction for the removed at least one corresponding data instance, utilizing the trained machine learning model;
(i) evaluating one or more model predictability metrics, associated with the prediction(s). The metric(s) is indicative of an ability of the trained learning model to correctly predict the removed corresponding data instance(s) x10;
(j) based on at least the model predictability metric(s), perform an action which is configured to bring about an increased-quality data set, as compared to a quality of the data set.

The increased-quality data set can facilitate at least one of a quicker training of the machine learning model and a higher-accuracy training of the machine learning model, as compared to a second training of the machine learning model performed utilizing the data set.

Other methods of the selecting, from the data set, the number of data items having a relatively high likelihood of abnormal data, are possible. Some examples of such selection comprise one of or more of:
utilizing an anomaly detection method;
utilizing a kernel-based method; and/or
utilizing confidence learning.

In such an implementation, confidence learning, utilizing cross validation, can be used specifically to identify the number of data items of the cleaning-candidate identification set(s), on which data instance validation methods can be used, to assist in cleaning abnormal or possibly problematic data instances.

Some example technical advantage of the above methods and systems are now presented. Some other data cleaning systems and methods, known in the art, perform confidence learning, that is class cross validation, as a method of analysis data instance quality. For example, the raw data set 410 is divided randomly into e.g. ten groups, with some of each class in all of the groups. Then a model is built based on nine of the groups, and testing is done on the tenth group. This is repeated ten times, each time testing on one of the ten groups. A prediction (e.g. “this image has a probability of 82% being of class cat and 18% of being of class dog”) is thus obtained for each data instance in the data set. In such a method, the lion image (for example) would in fact be tested as part of this cross-validation, and the probability of its classification being correct would be calculated. However, this other method evaluates the prediction success for all of the data. Also, cross-validation is a relatively slow method, is admitted by certain vendors/users of the confidence learning method. This is due at least to the fact that it requires (in the above example) nine different full trainings of the same data.

Unlike the method disclosed herein, in the confidence learning approach there is no focus on suspect data, that is there is no first filtering. It is wasteful to evaluate data quality for 100% of the data, when only a small percent of the data are problematic. This approach may be acceptable in a case of e.g. 50,000 data instances, without too much penalty for the “wasteful” approach. However, it can become particularly slow, and require a very large amount of resources, in a case of e.g. 1 billion data instances.

By comparison, the presently disclosed methods can, for example, focus on much less data, on a far smaller data sample (e.g. 1% of the data set, or a fraction of a percent, or perhaps focusing only the 500 worst instances) which is likely to be most problematic, and they address that smaller portion in (at least partly) an automated fashion. No prediction need be done for the non-suspect data. No cross-validation is needed—prediction is done only on a comparatively small group of data instances. Thus, in some cases, the process can be orders of magnitude faster. Thus, certain prior art methods, utilizing random distributions and groupings, can be less efficient, in their use of their resources, compared to the methods disclosed herein.

In some examples, the presently disclosed methods are so fast, that they can be performed in iterations. The “worst” or most possibly problematic data instances can be selected and cleaned, and then an iteration of selecting the next most (possibly) problematic instances, and so on, until a termination criterion or condition(s) is met. In some cases, the multiple iterations can be performed at a lower cost of resources than doing current methods such as confidence learning one time. Note that in some cases, performing a method such as confidence learning multiple times in iterations would be cost prohibitive in resources.

Also, since (in the example) 1% of the data is being predicted based on a model trained with 99% of the data, the model is more accurate, and the prediction can be more accurate, than in a confidence learning method in which a data instance is predicted based on a model trained with only 90% of the data. In addition, this 99% used for the training, has been determined to have a relatively high likelihood of being clean, as compared to the 90% used in the confidence learning case, which was randomly chosen without regard to quality. The prediction of the data instances in question is thus based on a larger training set, and on a training set with statistically higher quality level. Better quality is thus achieved, with less time/effort/resources.

Similarly, also for cases of auto-correction of mislabeled data, the presently disclosed subject matter can perform this faster than, for example, using confidence learning.

In addition, current methods do not identify data instances specifically as being out of distribution.

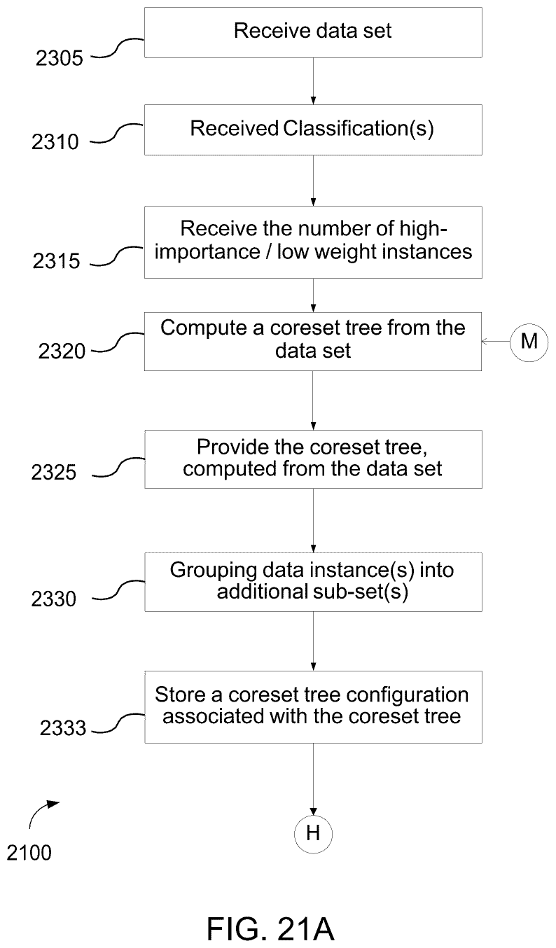

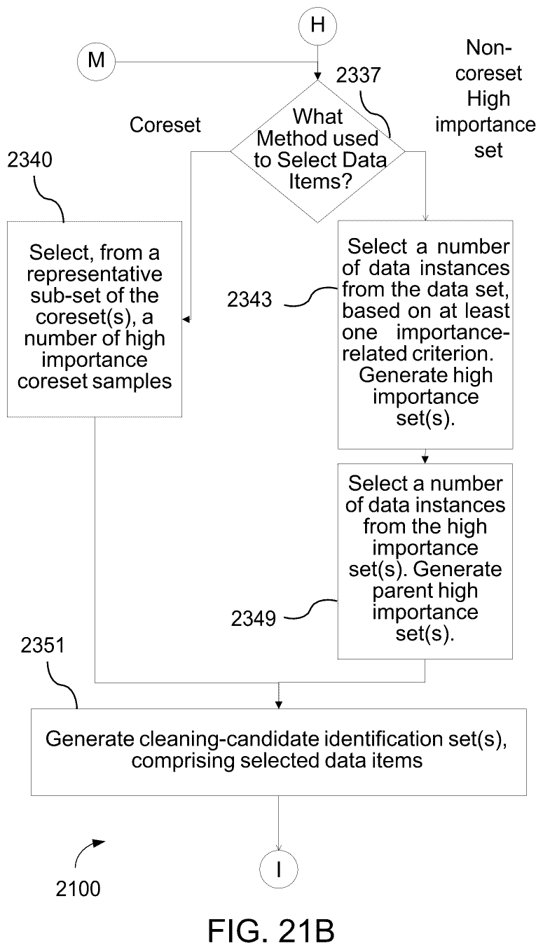

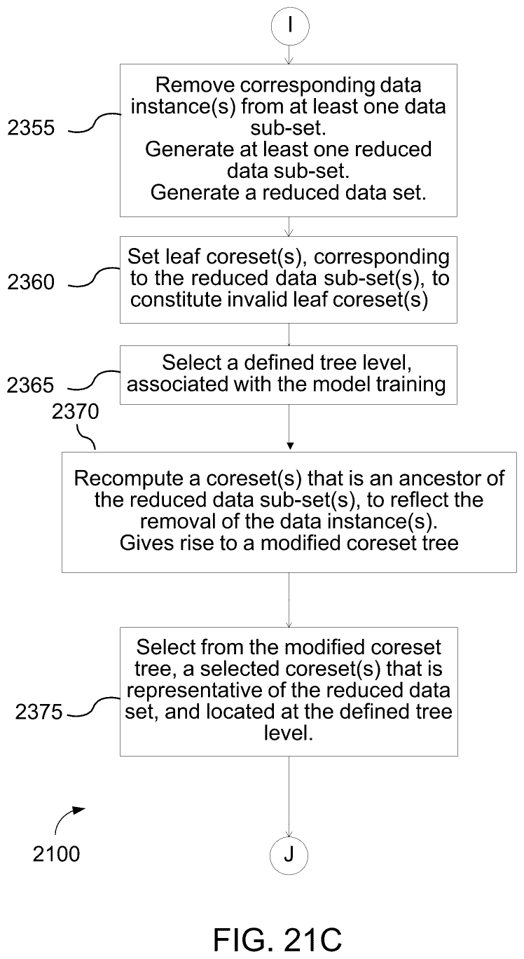

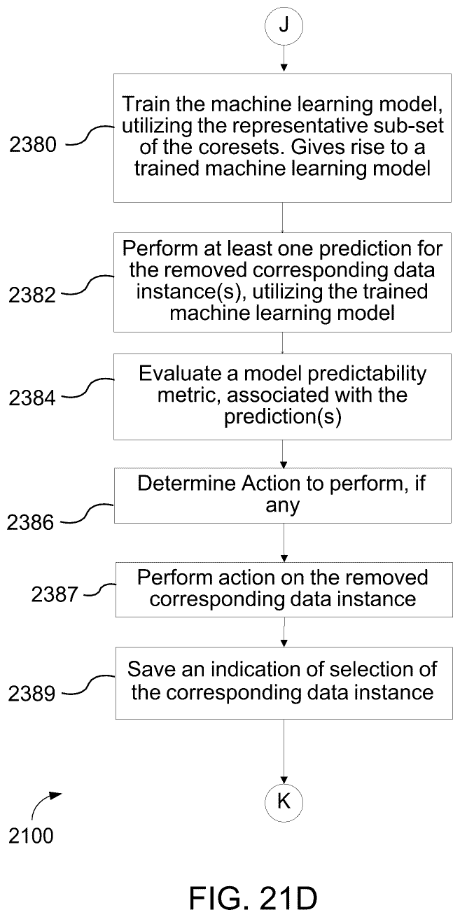

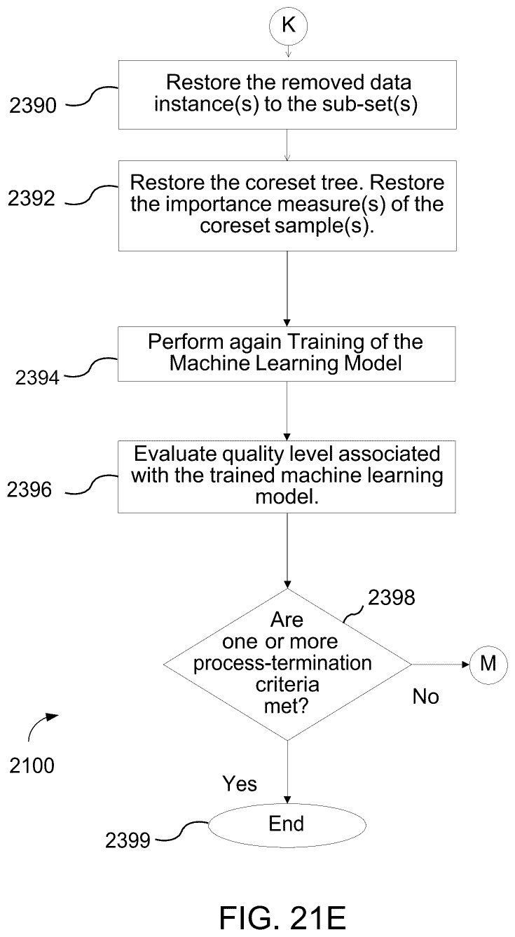

Various figures illustrate the concepts of the above-disclosed methods. Again, FIG. 2 illustrates the concept of a coreset, and FIGS. 3-4 illustrate the example data structure of a coreset tree, and how they are created. FIG. 20 provide schematic diagrams of systems configured for performing the method of the presently disclosed subject matter. FIG. 21 disclose an example flow chart of a method for data cleaning. FIG. 22 discloses an example flow chart of a method of automated actions.

Attention is now drawn to FIG. 20A, schematically illustrating an example generalized schematic diagram of a computerized machine learning system 2200, in accordance with some embodiments of the presently disclosed subject matter. System 2200 is also referred to as a computerized data cleaning system. In some non-limiting examples, computerized system 2200 includes a computer. It may, by way of non-limiting example, comprise a processing circuitry 2220. This processing circuitry may comprise a processor 2230 and a memory 2225.

This processing circuitry 2220 may be, in non-limiting examples, general-purpose computer(s) specially configured for the desired purpose by a computer program stored in a non-transitory computer-readable storage medium. They may be configured to execute several functional modules in accordance with computer-readable instructions. In other non-limiting examples, this processing circuitry 2220 may be a computer(s) specially constructed for the desired purposes.

Example uses of these modules are disclosed further herein, with reference to the flowchart FIGS. 21 and 22.

In some examples, computerized data cleaning system 2200 comprises an external interface 480, enabling communications with external devices/systems 490, and/or providing a user interface to a human user 490, e.g. a data scientist or other domain expert. An example, it can interface to training/learning system 2200, to receive identified problematic selected coreset samples 1544 or data instances 420 for analysis. In some examples, this interface is used by user 490 or external system 490 to perform actions on analyzed coreset samples or data instances which need action, e.g. updating labels, deleting samples etc.

Turning now to processor 2230 of processing circuitry 2220, attention is now drawn to FIG. 20B, disclosing details of an example of the processor. In some examples processor 2230 comprises input module 2260. In some examples, module 2260 is configured to receive input from e.g. human user 490, e.g. using external interface 480—e.g. instructions which models to train, and using how many groups to cross-validate. Another example input to the system 2200, by data scientist 490, is cleaning/corrections to specific problematic data instances 420 residing e.g. in stored data set 410, 473.

In some examples processor 2230 comprises output module 2265. In some examples, module 2265 is configured to provide output to e.g. human user 490 or external system 490, e.g. using external interface 480. Example outputs are various calculated quality metrics, and possibly problematic data instances 420 that require special handling. In some examples processor 2230 comprises coreset computation module 432. In some examples, module 432 is configured to compute one or more coresets 200, e.g. comprised in a coreset data structure 300, 400, 600, 1300, 1400, 1500, e.g. in a coreset tree. The module can also be used to recompute coresets C41′ as needed, including recalculation of importance measures such as importance and weight.

In some examples processor 2230 comprises branch detach/attach module 2234. In some examples, module 2234 is configured to detach one or more branches C18 from coreset tree 1300. In some examples module 2234 is configured to re-attach one or more branches C18 to the tree. In some examples, this module also stores and restores coreset tree configurations. In other examples, a separate module(s), not shown, performs the storing and/or restoring functionalities.

In some examples processor 2230 comprises data instance removal/restoral module 2240. In some examples, module 2240 is configured to remove one or more data instances x13, x19, e.g. for edge cases, from coreset tree 1400, 1500. In some examples module 2240 is configured to restore removed data instance(s) x13, x19 to the tree. In some examples, this module also stores and restores coreset tree configurations. In other examples, a separate module(s), not shown, perform the storing and/or restoring functionality.

In some examples, this module also performs the re-arrangement of data instances to a separate group(s), e.g. as disclosed with reference to FIG. 15. In other examples, a separate module(s), not shown, performs the functionalities disclosed with reference to FIG. 15.

In some examples processor 2230 comprises training module 452. In some examples, module 452 is configured to train, or re-train, the machine learning model(s) 1875, after the branch detachment or data instance removal actions are performed. The training can, in some implementations, utilize the relevant selected coreset(s), as disclosed elsewhere herein.

In examples other than that of the figure, the training is performed on a separate system, which receives the relevant training data from system 2200. An external training system 490 is an example of external system 490, interfacing with system 2200 using the components, 480, 2260, 2265. In such examples, training module 452 is not required.

In some examples processor 2230 comprises model quality evaluation module 2243. In some examples, module 2243 is configured to evaluate quality metric(s) for each iteration of cross-validation, e.g. per FIGS. 13 and 17. In some examples, the module is configured also to determine overall quality metrics for the cross-validation process.

In examples other than that of the figure, the model quality evaluation, is performed on a separate system. External evaluation system 490 is an example of external system 490, interfacing with system 2200 using the components, 480, 460, 465.

In some examples processor 2230 comprises instance prediction and evaluation module 2235. In some examples, module 2235 is configured to perform prediction for removed data instance(s), e.g. for edge cases, e.g. per FIGS. 14, 15, 18 and 21. In some examples, the module is configured also to evaluate model predictability metric(s), associated with the at least one prediction(s). In other examples, separate modules perform the prediction and the evaluation of the model predictability metric(s).

In examples other than that of the figure, the prediction, and/or the evaluation of the model predictability metrics, are performed on a separate system. External evaluation system 490 is an example of external system 490, interfacing with system 2200 using the components, 480, 460, 465.

In some examples processor 2230 comprises repetition module 2248. In some examples, module 2248 is configured to determine whether or not to repeat the process of e.g. data instance removal, training and evaluation actions, based on whether one or more process-termination criteria are met, e.g. based whether cross-validation has been completed, or whether a quality evaluation has been performed for all relevant edge cases. In some examples, repetition module 2248 is the same as, or is similar to, repetition module 448 and/or 1848 of FIGS. 7 and 16, in some cases perhaps utilizing different criteria than those of e.g. the flows of FIGS. 8, 12, 17 and/or 18.

In some examples, processor 2230 comprises high importance set generation module 2258. In some examples, module 2258 is configured to compute one or more high importance sets S11, S41, e.g. comprised in a high importance tree or other data structure 1100. Example functions are disclosed with reference to e.g. FIGS. 11, 12 and 21, and related text.

In some examples processor 2230 comprises samples selection module 2252. In some examples, module 2252 is configured to select at least one selected coreset C41. In some examples, module 2252 is configured to select a number of coreset samples 546, which will be analyzed. Example functions are disclosed with reference to e.g. FIGS. 5, 6, 8 and 21, and related text.

In some other examples, sample selection module 2252 is configured to select a number of data instances 1140, which will be analyzed. Example functions are disclosed with reference to e.g. FIGS. 11 and 12 and related text.

In some examples, this module is referred to also as instances selection module 2252.

In some examples processor 2230 comprises sample analysis module 2254. In some examples, module 2254 is configured to support analysis of the selected coreset samples 546, or data instances 1140, to determine if action should be performed. The data scientist 490 can interface to this module using e.g. external interface 480 and input/output modules 460, 465. In some examples, this module is referred to also as instances analysis module 2254.

In some examples, this module is configured to function automatically. In some other examples, this module is configured to support analysis performed by a human user, instead of or in addition to automated function.

In some examples processor 2230 comprises sample action module 2256. In some examples, module 2256 is configured to support actions on the selected coreset samples 546, or data instances 1140, such as correction, deletion and other cleaning activities. The data scientist 490 can interface to this module using e.g. external interface 480 and input/output modules 2260, 2265. In some examples, this module is referred to also as instances action module 2256.

Reverting now to FIG. 20A, in some examples, memory 2225 of processing circuitry 2220 is configured to store data associated with the training process, e.g. comparatively transitory data. Non-limiting examples of data stored include: selected data instances, cleaning-candidate identification sets, the level(s) at which training should be performed, various criteria parameters, evaluated quality parameters, predictions and metrics etc.

In some examples, memory 2225 is configured to store coreset tree configurations 1828, so that they can be restored after an iteration, or after each iteration. For example, the tree structure can be stored, with pointers to data stored in the data store. In some examples, this information 1828 is instead stored in data store 2270.

In some examples, the machine learning model 1875 that is to be trained, and the model after training, reside in memory 2225.

In some examples, the coreset data structure 2277, the hyperparameters (not shown), and/or machine learning model 1875, is stored in memory 2225. In some other examples, e.g. as shown in this figure, coreset data structure 2277 is instead stored in data store 2270.

In some examples, the memory 425 of data cleaning system 700 of FIG. 7, and/or the memory 1825 of machine learning system 1800 of FIG. 16, is the same as, or is similar to, the memory 2225 of FIG. 20, and system 700 and/or 1800 comprises components 1828, 2277 and/or 1875.

In some examples, data cleaning system 2200 comprises data store 2270. In some examples, more long-term and persistent data is stored in the data store. Non-limiting examples shown include the stored full dataset 473, corresponding to e.g. dataset 100, 410, cleaning set/high importance set data structure 479, corresponding to FIG. 11, and coreset data structure 2277, corresponding to e.g. coreset data structure 300, 400, 600, 1300, 1400, 1500. In some examples, hyperparameters (not shown) associated with the model 1875 are stored in data store 2270.

In some examples, coreset data structure 2277 is the same as, or is similar to, coreset data structure 477 of FIG. 7 and/or the coreset data structure 1877 of FIG. 16.

In some examples, datastore 2270 is the same as, or is similar to, datastore 470 of FIG. 7, /or the datastore 1870 of FIG. 16. In other examples, in which the training occurs externally to system 2200, also the ML model 1875 can be stored externally.

In some examples, system 2200, its processing circuitry, processor, and/or memory etc., is the same as, or is similar to, data cleaning system 700 of FIG. 7, and/or to machine learning system 1800 of FIG. 16, but with the additional functional modules and components described with reference to FIG. 20. Thus, in some examples, modules 2234, 2235, 2243, 2248, 2252, 2254, 2256, 2258 are the same as, or similar to, modules, 434, 435, 437, 440, 442, 443, 448, 1834, 1835, 1840, 1843, 1848, but with the additional functions described with reference to FIGS. 19, 20, 21, 22.

Attention is drawn to FIGS. 21A-21E, schematically illustrating a generalized flow chart diagram 2100, of a flow of a process or method, for data cleaning, in accordance with some embodiments of the presently disclosed subject matter. This cleaning process 2100, e.g. a correction process, which utilizes a data instance validation process (e.g. an edge-case-validation process), is, in some examples, carried out by systems such as those disclosed with reference to FIG. 20.

It should be noted that the flow 2100 utilizes, in some examples, blocks identical to, or similar to, those disclosed herein with FIGS. 8, 12, and 18.

The flow 2100 starts at 2305. According to some examples, a dataset 100, 410 is received (block 2305). In some examples, the data set is received from an external system 490, e.g. via external interface 480. In some examples, the dataset is stored 473 in datastore 2270.

According to some examples, the set of classes to be cleaned/analyzed is received (block 2310). In some examples, the data set is received from a human user 490 or external system 490, e.g. via external interface 480 and input module 2260. For example, system 2200 could be told to clean images classified as dogs, or as cats, or as both.

According to some examples, the number of data items to select is received (block 2315). This is the number of data items from the data set 410 to be selected, which have a relatively high likelihood of abnormal data, as compared to a second likelihood of abnormal data associated with at least some other data items of the data set. In some examples, this is the number of high importance/sensitivity (or, alternatively, low weight) data instances to select. In some such cases, the one or more importance-related criteria to be used is received. Such criteria are indicative of corresponding importance measures of the selected coreset(s) having at least one of high importance values and low weight values. In some examples, this information is received from a human user 490 or from external system 490, e.g. via external interface 480 and input module 2260.

In some examples, in block 2315, and/or in block 2310, other cleaning parameters are received, e. g number of coreset tree levels to use, which data should be used for the models training, process termination criteria, required quality levels, etc.

According to some examples, one or more coresets are computed (block 2320). In some examples, this is performed utilizing coreset computation module 432. As part of the computation, in some examples, importance measures (e.g. importance and/or weight) are computed in this block. In some examples, the coresets are structured in a coreset data structure 300, 400, 600, 1440, 1500.

In some examples, an importance measure is generated for each coreset sample of the at least one coreset. The importance measure is indicative of at least one of an importance value and a weight value.

Block 2320 can be skipped in some examples, if the coreset tree 1400, 1500 was previously computed as part of a different process.

According to some examples, the coreset tree 1400, 1500 (see e.g. FIGS. 14, 15), computed from data set 100, 410, is provided to system 2200 (block 2325). For example, this is the tree computed in block 2320. In some examples, e.g. in which the coreset tree was computed external to system 2200, this block is performed utilizing external system 490, interface 480 and input module 460. (In such a case, the previous block 2320 does not occur in system 2200.) In some other examples, the coreset tree already resides 2277 in data store 2270, or in memory 1825.

According to some examples, the instance(s) x10, x13, x19 (see FIG. 15) to be removed and predicted are grouped into at least one additional sub-set 1520 (block 2330). In this step, a dedicated branch(es) is created for all of the instances to be removed during the process. This step is optional, and it is performed in implementations such as those disclosed with reference to FIG. 15. Thus, for example, the implementation used with reference to FIG. 14 does not utilize block 2330. In some examples, this is performed by data instance removal/restoral module 2240, or by another module, e.g. one not shown in FIG. 20.

According to some examples, a configuration of all or part of coreset tree 1400, 1500 is stored (block 2333). In some examples, this is performed by data instance removal/restoral module 2240. In other examples, another module, e.g. one not shown in FIG. 20, is utilized. Note that in some examples, block 2333 is instead performed at a stage that is prior to block 2330. Note also that some implementations do not include this step 2333 at all.

The flow continues H to FIG. 21B.

According to some examples, a determination is made, which method is used to select data items. That is, the method to identify and to select, from the data set 410, a number of data items from the data set having a relatively high likelihood of abnormal data, as compared to a second likelihood of abnormal data associated with at least some other data items of the same data set, is determined (block 2337). In some examples, this is performed utilizing sample selection module 2252. In some examples, this determination is made utilizing external input (e.g. from a human user 490 or external system 490), whether interactively or not.

Responsive to a determination at block 2337 that a coreset based selection will be used (e.g. as disclosed with reference to FIGS. 6 and 8), the flow proceeds to block 2340. Responsive to a determination at block 2252 that a non-coreset high importance set based selection will be used (e.g. as disclosed with reference to FIGS. 11 and 12), the flow proceeds to block 2343. Note that other methods of selection, not detailed in this example flow, can instead be chosen, e.g. an anomaly detection method, a kernel-based method, and/or a confidence learning method.

According to some examples, at least one selected coreset C41, that is representative of the data set 110, is selected from the coresets(s), e.g. from coreset tree 400 (block 2340). The selected coreset(s) constitute a representative sub-set of the coresets C41. According to some examples, a number of coreset samples are selected, from the representative sub-set (e.g. C41), based on at least one importance-related criterion. The importance-related criteria are indicative of corresponding importance measures of the at selected coreset(s) having at least one of high importance values and low weight values.

For example, a number of high importance coreset samples 540 are selected from the representative sub-set of the one or more coresets 600. In some other examples, a number of low-weight coreset instances 540 are selected. In some examples, this is performed utilizing instances/sample selection module 2252. In some other examples, the two selections are performed in two separate blocks. Non-limiting examples of how the selections are performed are disclosed with reference to FIG. 6.

These selections can give rise to a set of selected coreset samples C41, or C31, C32, having a high probability of at least one of high importance values and low weight values, as compared to a second probability associated with selecting a corresponding number of data instances from the full data set 110 itself.

The set of selected coreset samples constitutes cleaning-candidate identification set(s). The selected coreset samples constitute the selected number of data items.

In some cases, the selecting of the number of coreset samples, based on the at least one importance-related criterion, comprises one of the following:
selecting coreset samples of highest importance;
selecting coreset samples of importance above a defined importance value;
selecting coreset samples of lowest weight;
selecting coreset samples of weight below a defined weight value; and
selecting the representative sub-set of the at least one coreset.

In some cases, the number of coreset samples is a defined number of coreset samples. In some cases, the selection of the number of coreset samples is performed for a particular class comprised in the plurality of data instances. In some cases, the selected representative sub-set comprises all coresets of the at least one coreset.

In some cases, the performing the action in the at least one data item comprises one of the following:
performing the action in the representative sub-set; and
performing the action in all coresets that comprise the each coreset sample.

In some cases, the performing of the action comprises performing the action in a respective instance of the data set. The instance of the data set corresponds to the coreset sample.

As indicated above, responsive to a determination at block 2337 that a non-coreset high-importance set based selection will be used (e.g. as disclosed with reference to FIGS. 11 and 12), the flow proceeds to block 2343.

According to some examples, a number of data instances 1146 are selected from the data set 410, based on at least one importance-related criterion (block 2343). High importance set(s) S11, S12 are generated. These generated sets are high importance non-coreset sets (as distinguished from the process of 2340). The importance-related criteria are indicative of corresponding high importance values associated with the data instances. In some examples, this block includes calculating the importance values of the data instances 420 in the data set 410. In some examples, this is performed utilizing high importance set computation module 2258, and/or sample selection module 2252.

In this method of selection, the selecting the number of data items from the data set, based on the at least one importance-related criterion, comprises selecting the number of data items directly from the data set, based on the at least one importance-related criterion—rather than (as in block 2340) selecting from coresets that are based on the data set.

Thus, the high importance non-coreset set(s) comprise the selected data instances. The high importance non-coreset set(s) constitute the cleaning-candidate identification set(s). The selected data instances constitute the number of selected data items.

According to some examples, a second number of data instances 1144 are selected from the generated high importance sets S11, S12, etc. based on at least one other importance-related criterion (block 2349). The relevant high importance sets are referred to herein as the high importance set(s) S11, and at least one other high importance set S12, which is associated with a same tree level as high importance set(s) S11. High importance parent set(s) S21, S22 etc. are generated. In some examples, this is performed utilizing high importance set computation module 2258.

In some examples, this block 2349 is performed in a loop, repeated at least once. After each iteration, the parent high importance set(s) are set to constitute the high importance set(s), for purposes of the next iteration. In some examples, this block is repeated until the root high importance set S41 is generated. In some examples, in each iteration, the importance value of a particular selected data instance is re-calculated, as that data instance is repeatedly selected 1146, 1144, 1142 in each iteration for the next-highest parent set.

In some examples, the at least one importance-related criterion and the at least one other importance-related criterion are the same. In some examples, the number of data instances and second number of data instances are the same.

In some examples, the selecting of the number of data instances, based on the at least one importance-related criterion, comprises one of the following:
i. selecting data instances of highest importance values;
ii. selecting data instances of importance values above a defined importance value; and
iii. selecting data instances based on a class associated with the plurality of data instances.

In some examples, the selecting of the data instances, based on a class associated with the data instances, comprises selecting, from a particular class, in proportion to a prevalence of the particular class within the data instances. Thus, if 80% of the data instances 410, 420 are labeled cat and 20% are labelled dog, approximately (or in some cases exactly) 80% of the selected data instances 1146 are labeled cat. The method in some cases comprises calculating the corresponding importance values associated with the plurality of data instances.

In some examples, the number of data instances is a defined number of data instances (e.g. set S12 is created by selecting 400 data instances 420).

This block 2349 is optional. In some examples, the block is not performed, only a first layer/level of cleaning sets S11-S18 is generated, without any parent sets. That is, no cleaning tree is generated.

According to some examples, cleaning-candidate identifications sets are generated (block 2351). In some examples, this is performed utilizing sample selection module 2252. In some examples, this is performed utilizing high importance set computation module 2258, and/or sample selection module 2252 (per blocks 2343, 2349). As indicated above, in the example case of block 2340, the cleaning-candidate identification set(s) comprise the set(s) of selected coreset samples, and the selected coreset samples constitute the selected number of data items.

As indicated above, in the example case of blocks 2343, 2349, the cleaning-candidate identification set(s) comprise the high importance non-coreset set(s), the high importance non-coreset set(s) comprise the selected data instances, and the selected data instances constitute the number of selected data items.

The flow continues I to FIG. 21C.

According to some examples, at least one data instance x13 is removed from one or more data sub-sets 617 (block 2355). One or more reduced data sub-sets 617′ are thereby generated, from the at least one data sub-set 617. In some examples, this is performed by data instance removal/restoral module 2240.

In some non-limiting examples, the removing of at least one corresponding data instance comprises removing all of the selected data items from the data set. That is, all selected data items are removed at the same time, and the next several steps are performed with respect to the non-selected data items.

It is in some example implementations easier to remove all of these data instances at once. Even if that is performed, and the model is trained utilizing only the remaining data instances, this still provides better training than e.g. confidence learning, which removes e.g. 30% at a time. Note that in such an implementation, all of the removed selected data items have been identified as possibly problematic data, and thus the training is done on data items that are statistically of a relatively higher quality.

In other example implementations, the selected data items could be removed one a time. However, this is relatively resource-heavy, requiring a lot of retraining, and can thus be inefficient. It could this be overkill, in terms of providing a good prediction of the removed instance(s), in certain cases.

In still other example implementations, the selected data items can be removed a certain number at a time. For example, if 1000 data items are selected for analysis and potential cleaning, in such an implementation 10 groups of 100 items could be removed, in 10 iterations, one group at a time.

Note that in cases of removing groups of items/several items, and/or individual items, a determination would be made, e.g. after block 2392 of FIG. 21E, whether an evaluation of metrics has been performed for all relevant data instances. This would be another block (not shown in the figure). This determination can be performed, in some implementations, utilizing repetition module 2248 or data instance and prediction evaluation module 2235.

If the answer to that question is “no”, in such an example implementation the process can loop back, using an additional block “Select other data instances for removal and evaluation” (not shown in the figure), to e.g. block 2355 “remove corresponding instances from the data sub-set(s)”. The determination and loopback process can be similar to the relevant blocks (e.g. 2080, 2085) disclosed with reference to FIG. 18C.

That is, in such cases the process is repeated in respect of at least one other data instance. In the repetition, the at least one other data instance is set to constitute the at least one data instance.

According to some examples, leaf coreset(s) C4, corresponding to the reduced data sub-set 617′, are set to constitute now-invalid leaf coreset(s) C4 (block 2360). In some examples, this is performed by data instance removal/restoral module 1840. Non-limiting examples of this block are disclosed with reference to FIGS. 14, 15.

According to some examples, a defined tree level, associated with the training of the machine learning model, is selected or otherwise determined (block 2365). This tree level is referred to herein also as the third tree level. For example, this is the level at which model training will be performed, or the level of the highest representative coreset to be used in the training, e.g. as disclosed with reference to FIGS. 14-15. In some examples, several levels may be used for training (for example, training using C1+C2+C6). In some examples, this step is performed by data instance removal/restoral module 2240, or by training module 452. In other examples, another module, e.g. one not shown in FIG. 20, is utilized. In some examples, the value of the third tree level is configured data, e.g. in memory 2225. In some examples, this block is performed at a different part of the flow, e.g. after step 2325.

According to some examples, at least one coreset C4, C6 that is an ancestor of the reduced data sub-set(s) 617′ is recomputed, to reflect the removal of the data instance(s) x13 (block 2370). This thereby gives rise to a modified coreset tree 1400′, 1500′. In some examples, this is performed by core computation module 432. Examples of this block are disclosed with reference to FIGS. 14, 15.

In one non-limiting example implementation of this step, the following steps is performed for each invalid leaf coreset C4:
block 2370A (not shown separately)—the invalid leaf coreset is recomputed, thereby giving rise to a corrected leaf coreset C4′; and
block 2370B (not shown separately)—recomputing at least all ancestor coresets C6, C7 of the corrected leaf coreset which (i) are at the defined tree level (e.g. Level 1) or (ii) are lower than is the defined tree level (e.g. are at Level 2). Note that if no ancestors of the corrected leaf coreset(s) are used in the training, e.g. in a case where the training utilizes C1+C2+C4′+C5, block 2040B need not be performed.

For at least one of these ancestor coresets, the recomputing comprises recalculating an importance measure, for at least one coreset sample.

According to some examples, at least one coreset C3, C6′, which is representative of the reduced data set 100′, is selected from the modified coreset tree 1400′, 1500′ (block 2375). At least one of these selected coreset(s) is located at the defined tree level (defined in block 2365). In some examples, this is performed by data instance removal/restoral module 1840. In other examples, another module, e.g. one not shown in FIG. 20, is utilized. Non-limiting examples of this block are disclosed with reference to FIGS. 14, 15.

The flow proceeds J to block 2380 on FIG. 21D.

According to some examples the machine learning model 1875 is trained (block 2380). This block gives rise to a trained machine learning model 1875. In some examples, this is performed by model training module 452. The training set of course does not consider the data items removed in block 2355.

In some examples, this training utilizes at least one of:
i. the data set 410; and
ii. a representative sub-set C3, C6′ of the coresets. (See e.g. FIG. 14) According to some examples one or more predictions, for the removed data instance(s) x13, are performed, utilizing the trained machine learning model 1875 (block 2382). The removed data instance(s) x13 is run on the trained model 1875, and a prediction is performed for it. In some examples, this is performed utilizing instance prediction and evaluation module 2235. Non-limiting examples of this block are disclosed with reference to FIGS. 14, 15.

According to some examples, one or more model predictability metrics, associated with prediction(s) of block 2382, are evaluated (block 2384). These metrics are indicative of an ability of the trained learning model 1875 to correctly predict the removed data instance(s) x13. Thus, in some examples, a model quality associated with the trained machine learning model is evaluated. In some examples, this is performed utilizing instance prediction and evaluation module 2235. Non-limiting examples of this block are disclosed with reference to FIGS. 14, 15.

According to some examples, a determination is made whether an action should be performed, and if so to determine the specific action (block 2386). In some examples, this is performed utilizing instance prediction and evaluation module 2235, and/or sample action module 2256. Non-limiting examples of this block are disclosed with reference to FIG. 22.

According to some examples, responsive to a determination block 2387 to perform a particular action, the determined action is performed on the removed corresponding data instance (block 2387). In some examples, this is performed utilizing sample action module 2256. Non-limiting examples of this block are disclosed with reference to FIG. 22.

According to some examples, an indication of selection of the coreset sample is saved (block 2389). In some examples, this is performed utilizing sample analysis module 2254, or alternatively using some other module. This block 2389 is an optional step, which is not performed in other examples. It can be performed in response to the analysis of block 2386, which determines whether the particular coreset sample requires an action such as cleaning. Non-limiting examples of possible implementations of this block, and example technical advantages, are disclosed further herein with reference to block 835 of FIG. 8.

The flow proceeds K to block 2390 on FIG. 21E. According to some examples, the removed data instance(s) x13 is restored (block 2390). In some examples, this is performed utilizing data instance removal/restoral module 2240.

According to some examples, the coreset tree 1400, 1500 is restored (block 2392). In some examples, this is performed utilizing data instance removal/restoral module 2240. In some examples, another module, not shown in FIG. 22, is utilized.

In some examples, blocks 2390 and 2392 are similar to blocks 2065 and 2070 of FIG. 18.

In some examples, this restoral block 2392 is not implemented.

According to some examples the machine learning model 1875 is trained again (block 2394). This block gives rise to a trained machine learning model 1875. In some examples, this is performed by model training module 452. In contrast to the other training step, block 2380, the training set for this stage of the training does consider the data items removed in block 2355, and later restored in block 2390. According to some examples, quality level(s) associated with the trained machine learning model (trained in block 2394) are evaluated (block 2396). In some examples, this is performed utilizing quality evaluation module 2243. Examples of quality levels are disclosed further herein with reference to FIGS. 9-10. In other examples, in which the process-termination criteria of block 2398 do not rely on quality levels, it is possible that block 2243 is not performed.

According to some examples, a determination is made, whether or not one or more process-termination criteria are met (block 2398). In some examples, this is performed utilizing repetition module 2248 or quality evaluation module 2243.

In some examples, the process-termination criteria comprise at least one of the following:
I. a defined number of repetitions have been performed; and
II. an improvement of the quality level, over at least one previous iteration, is below a defined improvement level.

Responsive to a determination at block 2398 that No, the process-termination criteria are not met, in some examples the flow proceeds M back to FIG. 21A, looping back to block 2320, in which some or all coreset(s) are computed again. In other examples, there is no re-computation of coresets, and instead the looping back is to block 2337, in which a determination is made which method should be used to select data items.

That is, if the process-termination criteria are not met, the relevant portion of the flow is repeated.

Responsive to a determination at block 2398 that Yes, the process-termination criteria are met, the flow proceeds to block 2399, the end of the process. The model training has been completed, and the relevant data items/data instances have been corrected or otherwise cleaned.

Attention is drawn to FIG. 22, schematically illustrating a generalized flow chart diagram 2200 of a flow of a process or method, for data cleaning, in accordance with some embodiments of the presently disclosed subject matter. This cleaning process 2200, e.g. a correction process, in some examples, carried out by systems such as those disclosed with reference to FIG. 20, for example sample analysis module 2254 and sample action module 2256.

In some implementations, this flow 2200 provides an example detailed implementation of blocks 2386 and 2387 of FIG. 21D, “Determine action to perform, if any” and “Perform action on the removed corresponding data instance”.

Example actions to be performed in block 2387 include:
a. correcting, in an automated fashion, a label associated with the removed corresponding data instance(s);
b. marking the corresponding data instance(s) as requiring review by a data-analysis user;
c. determining that the at least one corresponding data instance is out of distribution;
d. marking the corresponding data instance(s) as being unprioritized for review by the data-analysis user; and
e. marking the corresponding data instance(s) as not requiring review by the data-analysis user.

Non-limiting examples of a human data-analysis user include a data scientist, an analyst, an annotator, a data curator, and another domain expert (e.g. physician, geneticist).

The flow 2100 starts at block 2384 of FIG. 21D, “evaluate a model predictability metric”, for one or more removed data instances x13. Probabilities of the data instance x13 being of this or that class have been calculated. The flow proceeds to block 2405.

According to some examples, the class, for which the probability is highest, is found, identified or determined (block 2405). In one example, detailed herein, an image of a dog is labeled “cat”, e.g. the case of the mislabeled chihuahua image. The evaluated predictability metrics are the probabilities “cat=2%” (i.e. P=0.02) and “dog=98%” (P=0.98). In this example, the class with the highest probability is dog, with P=0.98. In another example, of the image of the lion labelled as “cat”, the metrics the probabilities “cat=100%” and “dog=0%”. The class with the highest probability, in this second example, is cat, with P=1.00.

According to some examples, a determination is made, whether or not the highest probability, found in block 2405, is above a defined threshold (block 2410). In some examples, this is performed utilizing sample analysis module 2254, or alternatively using sample action module 2256 or some other module.

Responsive to a determination at block 2410 that No, the highest probability associated with the one or more removed data instances is below the defined threshold, the flow proceeds N to block 2420.

According to some examples, the corresponding data instances x13 are marked, as requiring review by a data-analysis user (block 2420). In some examples, this is performed utilizing sample analysis module 2254, or alternatively using sample action module 2256 or some other module. For example, the defined threshold is 80%, that is P=0.8. For a particular example image, the highest probability is P=0.6, associated with “cat”, that is there is a 60% probability that the image is a cat. The prediction has not determined with a high enough probability for the system to take automated action. Therefore, the image is marked to be sent to a human for analysis (which will be later done in a step, not shown in the figure, which is similar to, or the same as, block 833 of FIG. 8A). In the example flow, the process then continues to block 2389 of FIG. 21D, and it continues in the flow 2100.

In some other examples, the process could be put on hold until the human user performs analysis and possibly action with reference to the marked data instances x13. In such a case, a step similar to, or the same as, block 833 of FIG. 8A, is performed at this point (although FIG. 22 does not show it).

Reverting to the determination at block 2410, responsive to a determination at block 2410 that Yes, the highest probability associated with the one or more removed data instances is above the defined threshold, the flow proceeds N to block 2430.

According to some examples, a determination is made, whether the highest probability (determined e.g. at step 2405) is associated with the original label of the corresponding data instance(s) x13 (block 2430). In some examples, this is performed utilizing sample analysis module 2254. For example, the highest probability (which is above the defined threshold) is P=0.98 for class “dog”. If the image is in fact labeled “dog”, the answer to the determination of 2405 is “yes”.

Responsive to a determination that No, the highest probability is NOT associated with the original label of the corresponding data instance(s) x13, the process proceeds to block 2440. According to some examples, a determination is made that the corresponding data instance(s) x13 is clearly mislabeled (block 2440). In some examples, this is performed utilizing sample analysis module 2254. In others, it is performed utilizing using sample action module 2256. In the illustrative example of the chihuahua, the probability for class dog is P=0.98, and only P=0.02 for “cat”, and yet the original label is “cat”. In the example, this image is clearly mislabeled, and there is relatively low risk in taking automatic action on this label—because in block 2410 the relevant probability P=0.98 is above the defined threshold (e.g. of P=0.90), and thus the class “dog” is of high likelihood the correct one.

According to some examples, a label, associated with the corresponding data instance(s) x13, is corrected, in an automated fashion (block 2445). In some examples, this is performed utilizing using sample action module 2256. In the chihuahua example, the system auto-corrects the incorrect label, and re-labels instance x13 to be of class “dog”, as disclosed with reference to FIG. 19.

Note that in other implementations, blocks 2440 and 2445 are combined.

This leg of the example flow proceeds to block 2389 of FIG. 21.

Responsive to a determination that Yes, the highest probability is associated with the original label of the corresponding data instance(s) x13, the process proceeds to block 2450. According to some examples, a determination is made, that the corresponding data instance(s) x13 is out of distribution (block 2450). In some examples, this is performed utilizing using sample analysis module 2254, or sample action module 2256.

An example of this is the lion labeled as class “cat”. The prediction evaluated in block 2384 is e.g. P=0.95 for class “cat” and P=0.05 for “dog”. The highest probability, P=0.95, is over the defined threshold of e.g. P=0.90, and it is associated with the class “cat”, which is the current label of the image. Thus, the lion image is out of distribution, as disclosed with reference to FIG. 19.

In some examples, the relevant data instance(s) x13 is marked, in this block, as being out of distribution, for later reference. According to some examples, a determination is made, what is the current stage is the machine learning model 1875 (block 2455). In some examples, this is performed utilizing using sample analysis module 2254, or sample action module 2256. For example, it is determined whether the model is currently in a development stage, or whether the model is deployed and “in production”. In this example implementation, the handling of certain data instances is dependent on the development stage of the model.

Responsive to a determination at block 2455 that the model is still in its development stage, the flow proceeds to block 2470. According to some examples, the corresponding data instance(s) x13 is marked as being unprioritized for review by the data-analysis user (block 2470). In some examples, this is performed utilizing sample action module 2256. For example, in the “Lion labelled as cat” case, the data instance is marked as being unprioritized for review, e.g. as having a lower priority for review, as compared to other data items 410 (e.g. those marked in block 2420). As disclosed with reference to FIG. 19, the mislabeling of the lion as a cat in some cases has little impact on a high-quality training of the model, and thus other data instances might have higher priority in receiving the attention, time and resources of the human data analysis user (who analyzes and cleans data instances). The system is thus in some implementations filtering which data instances should be sent to the human user, based e.g. on a prioritization action.

In some cases, block 2470 comprises marking the corresponding data instance(s) x13 as not requiring review by the data-analysis user. In such a case or implementation, the instance has no priority at all for review, not even low priority. It is not worth the attention of the data analysis user, and it is marked as not to be reviewed.

In some other examples, the action of block 2470 in a model development case can be different than that shown in the flow. Considering an image labeled as cat with P(cat) very high (e.g. 95%), it could be that some of the cat images are not actually cats, or they are instead “strange” pictures, e.g. a humorous picture of a cat in a dress. Such images can be referred to as ““pseudo-cats”. In some implementations, a new class such as “pseudo-cats” is not added automatically. However, the system in some such implementations performs another action—it saves such data instances, in a list, and sends them as a cluster, to the human user, for investigation. For example, if we see many OOD of the class “cats”, that is if we see a repetition of such a phenomenon above some defined threshold (X% of instances seen, for a particular class), the system can perform clustering, and send a list of this cluster for the human user to analyze. The sending of these instances to the user as a cluster or group can in some cases focus the user's attention on the OOD issue.

Responsive to a determination at block 2455 that the model is out of the development stage, and is in production, the example flow proceeds to block 2460. According to some examples, the corresponding data instance(s) x13 is marked as being Out Of Distribution (OOD), and as requiring review, or being prioritized for review, by the production-stage data-analysis user (block 2460). In some examples, this is performed utilizing sample action module 2256. This block is followed by block 2389, or perhaps to block 833 (not shown in the example of the figure).

An example of such prioritization in the production stage is now disclosed. An image detection model is trained to detect motorcycle helmets, for cameras monitoring a convenience store. These helmets, associated with suspicious people such as robbers, are to be distinguished from e.g. the heads of customers/employees etc. The model is developed, and it works well. However, in production, a small number of the stores have gumball machines, which appear similar to the helmets. These are not common in the stores, and the model was not trained with such images. The gumball machines are at the edge of the gaussian distribution of such images, and labeling mistakes may be common for them. Since few of them appear in the giant set of production images, their classification as “helmets” may be suspect. Therefore, an image of a gumball machine may have high importance. In production, there may be value to marking such OOD data instances, and to sending them to the “production” data analysis user with a relatively high priority.

Another example is a model with classes “combustion engine” and “electric vehicle”. In production, the system can be used to help the human user identify a “new” class, not previously used for labeling—that of “hybrid vehicles”.

Note that in this example, the decision to perform an action, based on at least the model predictability metric(s), comprises deciding based on a probability (P) associated with a classification of the data instance(s) x13 by the trained machine learning model 1875. Similarly, in the examples disclosed with reference to flow 2200, the data set 410, 1900 is associated with a plurality of classes (e.g. dog, cat). For the corresponding data instance(s) x13, a plurality of predictions is performed for a corresponding plurality of classes. Each prediction is associated with a corresponding probability. For example, a first prediction of class is performed for at least a first class, and a second prediction of class is performed for at least a second class. As an illustrative example, a first prediction of class is that the image has a probability of P=0.02 of being of class “cat”, and a second prediction of class is that the image has a probability of P=0.98 of being of class “dog”. Also, in the example of the figure, the deciding, based on the probability associated with the classification of the data, comprises deciding based on a highest-probability prediction associated with a highest corresponding probability associated with the plurality of predictions. This is exemplified in block 2430.

Also, in the figure, the selection of the performed action is based at least on a label (e.g. a label of “class=dog”) associated with the corresponding data instance(s) x13.

Note also that the figure shows one illustrative flow. The order can be changed. For example, determination 2430 can be performed before the determination 2410. Also, additional determinations and actions are possible.

The disclosure with reference to FIGS. 19-22 has been of a single defined probability threshold for each class. In other example implementations, there could instead be different thresholds, based on the class. Consider, for example, training a model with hundreds or thousands of data instances, where, for a common Class #1, P=0.90 is the defined threshold. For a very rare Class #2, P=0.20 could be significant, and worthy of automated action or attention of the human user. Therefore, this rare Class #2 has a different threshold defined than for the more common Class #1.

Another example is a cybersecurity ML model. The penalty of certain types of mislabeling is greater than for others. If, for example, the current label is “spam/junk mail”, there is a relatively low penalty for changing that label to something else. So perhaps at a relatively low P=0.6 threshold, the system will automatically re-label a mail which had been previously labelled as spam. But phishing can be a more serious, a more critical, phenomenon than is junk mail. Therefore, if the current label is “phishing”, the data scientists may not want to take responsibility for automatically changing the phishing label to something less “serious”—unless the probability of the class being something else is much higher. Therefore, in this example case, the threshold to re-label a phishing mail as something else may be the relatively high probability of e.g. P=0.95.

Similarly in some example implementations, not show in this flow, if there is a large number of classes associated with the model, e.g. thousands, the chance of predicting e.g. the class “dog” with a “high” probability of e.g. P=0.8 or P=0.9 is relatively lower. There are so many other classes to which the dog image can be assigned (wolf, bear, fox, jackal, coyote, cat etc.). In such a case of numerous classes, a lower threshold, perhaps P=0.5 or P=0.6, may be enough to trigger an automatic action such as auto-re-labelling or marking as Out of Distribution.

Similarly, in some example implementations, not show in this flow, the system could use a different defined probability threshold for different system actions. For example, one threshold can be used for the auto-labeling action, and a different threshold can be used for an OOD decision.

Also, in some other example implementations, an action can be performed based on a difference between probabilities associated with the different classes, by determining if one probability is much higher than the others. This can be done instead of, or in addition to, considering whether a particular prediction quality is above a defined threshold.

In some embodiments, one or more steps of the flowcharts exemplified herein (FIGS. 8, 12, 17, 18, 21, 22) may be performed automatically. The flow and functions illustrated in the flowchart figures may for example be implemented in systems 700, 1800, 2200, and in processing circuitries 423, 1820, 2220, and they may make use of components described with regard to FIGS. 7, 16, 20. It is also noted that whilst the flowchart is described with reference to system elements that realize steps, such as for example systems 700, 1800, 2200, and processing circuitries 423, 1820, 2220, this is by no means binding, and the operations can be carried out by elements other than those described herein.

It is noted that the teachings of the presently disclosed subject matter are not bound by the flowcharts illustrated in the various figures.

For example, some of the operations or steps can be integrated into a consolidated operation, or can be broken down into several operations, and/or other operations may be added. As a non-limiting example, in some cases blocks 805 and 810, and/or 830, 840 and 845, can be combined. As another non-limiting example, in some cases blocks 1965 and 1970, and/or blocks 1930 and 1938, of FIG. 17, and/or blocks 2440 and 2445 of FIG. 22, can be combined. In embodiments of the presently disclosed subject matter, fewer, more and/or different stages than those shown in the figures can be executed. As one non-limiting example, certain implementations may not include blocks 835 and/or 880. Similarly, in some examples repetition is not performed, and block 890 and the related loopback is not performed. In some cases, a single performance of the process of the flow can also provide improvements over prior art methods.

As another non-limiting example, certain implementations do not include one or more of blocks 1910, 1950, 1970 and/or 1995, and/or 1975 and 1980, of FIG. 17, can be combined.

Similarly, in some implementations, the operations can occur out of the illustrated order. One or more stages illustrated in the figures can be executed in a different order and/or one or more groups of stages may be executed simultaneously. As one example, block 810 can be performed before block 805.

As another example, block 1930 of FIG. 17 disclosed further herein, can be performed before or after block 1935. As another example, block 1930, can be performed before or after block 1920. In still another example, block 1920 can be performed before or after block 1935.

In the claims that follow, alphanumeric characters and Roman numerals, used to designate claim elements such as components and steps, are provided for convenience only, and do not imply any particular order of performing the steps.

It should be noted that the word “comprising” as used throughout the appended claims, is to be interpreted to mean “including but not limited to”.

While there has been shown and disclosed examples in accordance with the presently disclosed subject matter, it will be appreciated that many changes may be made therein without departing from the spirit of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be, at least partly, a suitably programmed computer. Likewise, the presently disclosed subject matter contemplates a computer program product being readable by a machine or computer, for executing the method of the presently disclosed subject matter, or any part thereof. The presently disclosed subject matter further contemplates a non-transitory machine-readable or computer-readable memory tangibly embodying a program of instructions executable by the machine or computer for executing the method of the presently disclosed subject matter or any part thereof. The presently disclosed subject matter further contemplates a non-transitory computer readable storage medium having a computer readable program code embodied therein, configured to be executed so as to perform the method of the presently disclosed subject matter.

Those skilled in the art will readily appreciate that various modifications and changes can be applied to the embodiments of the invention as hereinbefore described without departing from its scope, defined in and by the appended claims.

1-22. (canceled)

23. A computerized method of cleaning a data set, the method performed by a processing circuitry of a data cleaning system, the method comprising:
(a) provide the data set, the data set being configured for training of a machine learning model,
the data set comprising a plurality of data instances, each data instance of the plurality of data instances comprising a label;
(b) computing at least one coreset from the data set,
for generating an importance measure for each coreset sample of the at least one coreset, the importance measure being indicative of at least one of an importance value and a weight value;
(c) selecting, from the coresets, at least one selected coreset that is representative of the data set,
the at least one selected coreset constituting a representative sub-set of the coresets; and
(d) selecting, from the representative sub-set, a number of coreset samples, based on at least one importance-related criterion,
the at least one importance-related criterion being indicative of corresponding importance measures of the at least one selected coreset having at least one of high importance values and low weight values,
giving rise to a set of selected coreset samples having a high probability of at least one of high importance values and low weight values, as compared to a second probability associated with selecting a corresponding number of data instances from the data set,
the set of selected coreset samples facilitating determining, for each coreset sample of the set of selected coreset samples whether the each coreset sample requires an action,
thereby facilitating performing the action, which brings about an increased-quality representative sub-set of coresets, as compared to a quality of the representative sub-set,
the increased-quality representative sub-set of coresets facilitating at least one of a quicker training of the machine learning model and a higher-accuracy training of the machine learning model, as compared to a second training of the machine learning model performed utilizing the data set.

24. The computerized method of claim 23,
wherein the at least one coreset is comprised in a coreset data structure,
the coreset data structure having at least the following properties:
I. an ability to add a coreset sample to the at least one coreset;
II. an ability to delete a coreset sample to the at least one coreset;
III. an ability to modify a coreset sample; and
IV. an ability to find a coreset sample within the coreset data structure.

25. The computerized method of claim 23, wherein the selecting of the number of coreset samples, based on the at least one importance-related criterion, comprises one of the following:
selecting coreset samples of highest importance;
selecting coreset samples of importance above a defined importance value;
selecting coreset samples of lowest weight;
selecting coreset samples of weight below a defined weight value; and
selecting the representative sub-set of the at least one coreset.

26. The computerized method of claim 23, wherein the number of coreset samples is a defined number of coreset samples.

27. The computerized method of claim 23, wherein the selection of the number of coreset samples is performed for a particular class comprised in the plurality of data instances.

28. The computerized method of claim 23, wherein the selected representative sub-set comprises all coresets of the at least one coreset.

29. The computerized method of any claim 23, wherein the action comprises at least one of:
a. correcting a sample label associated with the each coreset sample;
b. deleting the each coreset sample;
c. creating a new class, and assigning, to the each coreset sample, a new sample label, associated with the new class;
d. adding additional coreset samples to the representative sub-set of the at least one coreset; and
e. adding additional data instances to the data set.

30. The computerized method of claim 23, wherein the performing the action in the each coreset sample comprises performing the action in the dataset.

31. The computerized method of claim 23, wherein the performing the action in the each coreset sample comprises one of the following:
performing the action in the representative sub-set; and
performing the action in all coresets, of the at least one coreset, that comprise the each coreset sample.

32. The computerized method of claim 23, wherein the performing the action comprises updating the importance measure.

33. The computerized method of claim 24, wherein the coreset data structure further having at least the following property:
V. an ability to update the data structure with Log-N time complexity, or with better than in Log-N time complexity.

34. The computerized method of claim 33, wherein the data structure comprises a coreset tree.

35. The computerized method of claim 23, wherein the performing of the action comprises performing the action in the each coreset sample of the representative sub-set.

36. The computerized method of claim 23, wherein the performing of the action comprises performing the action in a respective instance of the data set,
the respective instance of the data set corresponding to the each coreset sample.

37. The computerized method of claim 23, the method further comprising:
(e) responsive to the determining whether the each coreset sample requires the action, and responsive to the performing of the action, performing the training of the machine learning model.

38. The computerized method of claim 37, wherein the performing of the training utilizes one of:
a. the selected representative sub-set of the at least one coreset; and
b. the data set.

39. The computerized method of claim 37, the method further comprising:
(f) evaluating a model quality associated with the trained machine learning model.

40. The computerized method of claim 39, the method further comprising:
(g) repeating said steps (c) through (f) until meeting a process-termination criterion.

41. The computerized method of claim 40, wherein the process-termination criterion comprises at least one of the following:
I. a defined number of repetitions have been performed; and
II. an improvement of the quality level over at least one previous iteration is below a defined improvement level.

42. The computerized method of claim 40, wherein,
said step (g) comprises repeating said step (b).

43. A computerized data cleaning system, comprising a processing circuitry, configured to perform the method of claim 23.

44. A non-transitory computer readable storage medium tangibly embodying a program of instructions that, when executed by a processing circuitry of a data cleaning system, cause the processing circuitry to perform the method of claim 23.
